(19) United States
(12) Patent Application Publication
(10) Pub. No.: US 2022/0399734 A1
(43) Pub. Date: Dec. 15, 2022

(54) ELECTRIC STORAGE SYSTEM

(71) Applicant: NExT-e Solutions Inc., Tokyo (JP)

(72) Inventors: Fumiaki NAKAO, Shizuoka (JP); Kazuo TAKEHARA, Saitama (JP)

(21) Appl. No.: 17/772,137

(22) PCT Filed: Oct. 30, 2020
(86) PCT No.: PCT/JP2020/040990

§ 371 Date: Apr. 27, 2022

(30) Foreign Application Priority Data
Nov. 1, 2019 (JP) 2019-200304

(51) Int. Cl. H02J 7/00

(52) U.S. Cl. CPC H02J 7/00302; H02J 7/0019; H02J 7/00712

(57) ABSTRACT

A first electric storage device includes a first switching unit disposed between a wiring and the first electric storage unit and configured to switch an electrical connection relationship between the wiring and the first electric storage unit based on a voltage difference between the wiring and the first electric storage unit. A second electric storage device includes a second switching unit disposed between the wiring and the second electric storage unit and configured to switch an electrical connection relationship between the wiring and the second electric storage unit based on a voltage difference between the wiring and the second electric storage unit. A charge end voltage of the first electric storage unit is equal to or less than a full charging voltage of the first electric storage unit, and is greater than a charge end voltage of the second electric storage unit.

### BACKGROUND

### 1. Technical Field

The present invention relates to an electric storage system.

### 2. Related Art

In an electric storage system including a plurality of electric storage modules, the electric storage modules may be connected in parallel (see, for example, PTL 1). PTLs 2 to 4 disclose an electric storage system that enables hot-swapping of electric storage modules.

### CITATION LIST

### Patent Literature

[PTL 1] JP H11-98708 A

[PTL 2] WO 2017/086349 A

[PTL 3] WO 2017/086349 A

[PTL 4] JP 2019-092257 A

### Technical Problem

When a plurality of different types of electric storage modules are connected in parallel, at least one type of the electric storage module may not sufficiently exhibit its performance depending on a combination of the types of the plurality of electric storage modules.

### GENERAL DISCLOSURE

In a first aspect of the present invention, an electric storage system is provided. The electric storage system includes, for example, a first electric storage device including a first electric storage unit. The electric storage system includes, for example, a second electric storage device including a second electric storage unit. The electric storage system includes, for example, wiring for connecting the first electric storage device and the second electric storage device in parallel. In the electric storage system, the first electric storage device includes, for example, a first switching unit that is disposed between the wiring and the first electric storage unit and switches the electrical connection relationship between the wiring and the first electric storage unit based on the voltage difference between the wiring and the first electric storage unit. In the electric storage system, the second electric storage device includes, for example, a second switching unit that is disposed between the wiring and the second electric storage unit and switches the electrical connection relationship between the wiring and the second electric storage unit based on the voltage difference between the wiring and the second electric storage unit. In the electric storage system, the first electric storage unit includes, for example, a first type of secondary battery. The second electric storage unit includes, for example, a second type of secondary battery. The battery system of the secondary battery of the first type is expressed by, for example, a reaction formula in which an irreversible change does not occur in the battery system in principle even when the overcharge state continues. The battery system of the second type secondary battery is expressed by, for example, a reaction formula in which an irreversible change occurs in the battery system in principle when the overcharge state continues. In the electric storage system, the charge end voltage of the first electric storage unit is, for example, equal to or less than the full charging voltage of the first electric storage unit, and is greater than the charge end voltage of the second electric storage unit.

A second aspect of the present invention provides an electric storage system. The electric storage system described above includes, for example, a wiring for connecting a first electric storage device having a first electric storage unit and a second electric storage device having a second electric storage unit in parallel. In the electric storage system, the first electric storage device includes, for example, a first switching unit that is disposed between the wiring and the first electric storage unit and switches the electrical connection relationship between the wiring and the first electric storage unit based on the voltage difference between the wiring and the first electric storage unit. In the electric storage system, the second electric storage device includes, for example, a second switching unit that is disposed between the wiring and the second electric storage unit and switches the electrical connection relationship between the wiring and the second electric storage unit based on the voltage difference between the wiring and the second electric storage unit. In the electric storage system, the first electric storage unit includes, for example, a first type of secondary battery. The second electric storage unit includes, for example, a second type of secondary battery. The battery system of the secondary battery of the first type is expressed by, for example, a reaction formula in which an irreversible change does not occur in the battery system in principle even when the overcharge state continues. The battery system of the second type secondary battery is expressed by, for example, a reaction formula in which an irreversible change occurs in the battery system in principle when the overcharge state continues. In the electric storage system, the charge end voltage of the first electric storage unit is, for example, equal to or less than the full charging voltage of the first electric storage unit, and is greater than the charge end voltage of the second electric storage unit.

In the electric storage system according to the first aspect or the second aspect, the full charging voltage of the first electric storage unit may be less than the charging voltage of the charging device that charges the first electric storage device and the second electric storage device connected in parallel. The electric storage system according to the first aspect or the second aspect may include a charging voltage control unit that controls a set value of a charging voltage of the charging device. In the electric storage system, the charging device may charge the first electric storage device and the second electric storage device by a constant current method in at least a part of a charging period of the first electric storage device and the second electric storage device. In the electric storage system described above, when the voltage of the first electric storage unit is equal to or less than the charge end voltage, the charging device may charge the first electric storage device by a constant current method. In the electric storage system, the charging device may charge the first electric storage device by the trickle charging method when the voltage of the first electric storage unit is greater than the charge end voltage.

In the electric storage system according to the first aspect or the second aspect, the first electric storage device may include a limiting unit that is connected in parallel with the first switching unit between the wiring and the first electric storage unit, has a larger resistance than the first switching unit, allows a current to pass in a direction from the wiring toward the first electric storage unit, and suppresses the current from passing in a direction from the first electric storage unit toward the wiring. In the electric storage system, the limiting unit may include a current amount limiting unit that limits the amount of current flowing through the limiting unit. In the electric storage system, the limiting unit may include a current direction limiting unit that is connected in series with the current amount limiting unit, allows a current to pass in a direction from the wiring toward the first electric storage unit, and does not allow a current to pass in a direction from the first electric storage unit toward the wiring.

In the electric storage system according to the first aspect or the second aspect, the first electric storage device may include a short-circuiting unit disposed between the wiring and the first electric storage unit, connected in parallel with the first switching unit between the wiring and the first electric storage unit, and configured to short-circuit the first switching unit. In the electric storage system, the short-circuiting unit may include a short-circuiting state switching unit that shifts a state of the short-circuiting unit to a state where the short-circuiting unit short-circuits the first switching unit. In the above electric storage system, the short-circuiting state switching unit may short-circuit the first switching unit when it is detected that the output current of the electric storage system is greater than the charge current of the electric storage system, or when it is predicted that the output current of the electric storage system is greater than the charge current of the electric storage system.

In the above electric storage system, the short-circuiting state switching unit may switch a state of the short-circuiting unit from a state in which the short-circuiting unit short-circuits the first switching unit to a state in which the short-circuiting unit does not short-circuit the first switching unit in at least one of (i) a case where a predetermined period has elapsed after the short-circuiting state switching unit short-circuits the first switching unit, and (ii) a case where it is detected that an output current of the electric storage system is less than a charging current of the electric storage system, or a case where it is predicted that the output current of the electric storage system is less than the charging current of the electric storage system. In the electric storage system, the short-circuiting state switching unit may short-circuit the first switching unit when the electric storage system acquires information indicating that the load device using the power supplied from the electric storage system starts using the power. In the electric storage system, the short-circuiting state switching unit may short-circuit the first switching unit before the electric storage system outputs the current.

The electric storage system according to the first aspect or the second aspect may include a fluctuation suppressing unit for suppressing fluctuation of the output voltage of the electric storage system. In the electric storage system, the short-circuiting state switching unit may short-circuit the first switching unit after the electric storage system outputs the current. In the electric storage system, the fluctuation suppressing unit may be disposed such that the fluctuation suppressing unit and the load device are connected in parallel when the load device that uses the power supplied from the electric storage system is electrically connected to the electric storage system.

The electric storage system according to the first aspect or the second aspect may include a detecting unit that detects that the electric storage system has supplied power to the load device. In the electric storage system, the short-circuiting state switching unit may short-circuit the first switching unit when the detecting unit detects that the electric storage system has supplied power to the load device. In the electric storage system, the current consumption of the load device may increase continuously or stepwise after the electric storage system supplies power to the load device. The electric storage system may receive a request signal indicating the magnitude of the current to be supplied to the load device from the load device. The electric storage system may output a current having a magnitude indicated by the request signal. In the electric storage system, the load device may include a current consumption control unit that controls an amount of current consumption of the load device.

The electric storage system according to the first aspect or the second aspect may include a plurality of first electric storage devices connected in parallel. In the electric storage system, at least two of the plurality of first electric storage devices may include the short-circuiting unit.

The summary clause does not necessarily describe all necessary features of the embodiments of the present invention. The present invention may also be a sub-combination of the features described above.

### BRIEF DESCRIPTION OF THE DRAWINGS

FIG. 1 schematically shows an example of a system configuration of a power supply system 10.

FIG. 2 schematically shows an example of a system configuration of an electric storage module 110.

FIG. 3 schematically shows an example of a system configuration of an electric storage module 130.

FIG. 4 schematically shows an example of a system configuration of a module control unit 240.

FIG. 5 schematically shows an example of a circuit configuration of an electric storage module 110.

FIG. 6 schematically shows an example of a system configuration of a system control unit 140.

FIG. 7 schematically shows an example of voltage fluctuation and current fluctuation of each electric storage module.

FIG. 8 schematically shows an example of fluctuation of a charging voltage applied to the electric storage system 100.

FIG. 9 schematically shows an example of output characteristics of the charging device 14.

FIG. 10 schematically shows an example of a system configuration of an electric storage module 1010.

FIG. 11 schematically shows an example of a system configuration of a module control unit 1040.

FIG. 12 schematically shows an example of a circuit configuration of a module control unit 1040.

FIG. 13 schematically shows an example of a system configuration of an electric storage module 1330.

FIG. 14 schematically shows an example of a system configuration of an electric storage module 1430.

FIG. 15 schematically shows an example of a system configuration of the power supply system 10.

FIG. 16 schematically shows an example of a system configuration of an electric storage module 1630.

FIG. 17 schematically shows an example of control by a module control unit 1640.

FIG. 18 schematically shows an example of current fluctuation in the power supply system 10.

FIG. 19 schematically shows an example of a system configuration of a power supply system 1910.

FIG. 20 schematically shows an example of control by the module control unit 1640.

FIG. 21 schematically shows an example of current fluctuation in the power supply system 1910.

FIG. 22 schematically shows an example of a system configuration of a power supply system 2210.

FIG. 23 schematically shows an example of control by the module control unit 1640.

FIG. 24 schematically shows an example of current fluctuation in the power supply system 2210.

### DESCRIPTION OF EXEMPLARY EMBODIMENTS

Hereinafter, (some) embodiment(s) of the present invention will be described, but the embodiment(s) do(es) not limit the invention according to the claims. All the combinations of the features described in the embodiment(s) are not necessarily essential to means provided by aspects of the invention. In addition, the embodiment(s) will be described with reference to the drawings. The identical or similar parts in the drawings may be given the same reference numerals to omit the description that could otherwise overlap.

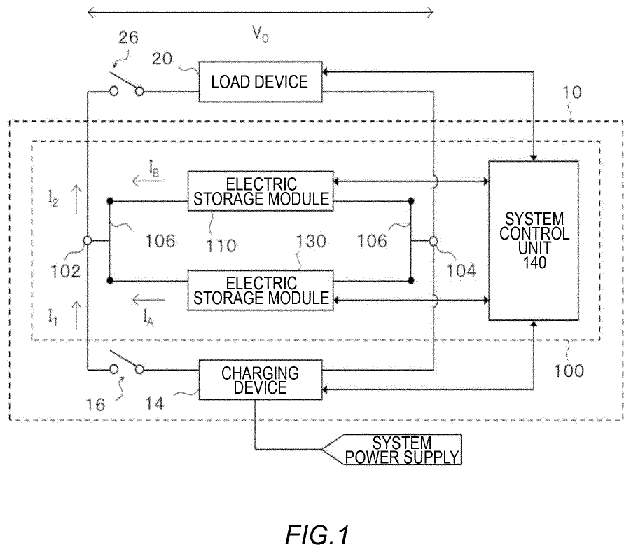

FIG. 1 schematically shows an example of a system configuration of a power supply system 10. In the present embodiment, the power supply system 10 includes a charging device 14, a charge switching unit 16, and an electric storage system 100. The power supply system 10 may further include a load device 20 and a load switching unit 26. In the present embodiment, the electric storage system 100 includes a connection terminal 102, a connection terminal 104, a wiring 106 that electrically connects the connection terminal 102 and the connection terminal 104, an electric storage module 110, an electric storage module 130, and a system control unit 140.

For the purpose of simplifying the description, in the present embodiment, details of the power supply system 10 and the electric storage system 100 will be described by exemplifying a case where the electric storage system 100 includes a single electric storage module 110 and a single electric storage module 130. However, the power supply system 10 and the electric storage system 100 are not limited to the present embodiment. In another embodiment, the electric storage system 100 may include a plurality of electric storage modules 110. Further, the electric storage system 100 may include a plurality of electric storage modules 130.

In the present embodiment, the power supply system 10 supplies power to the load device 20. In the present embodiment, the power supply system 10 includes an electric storage device (for example, the electric storage system 100), and supplies the power stored in the electric storage device to the load device 20. However, the power supply system 10 is not limited to the present embodiment. In another embodiment, the power supply system 10 may include a power generation device and supply the power generated by the power generation device to the load device 20. The power supply system 10 may include an electric storage device and a power generation device.

The power supply system 10 is used for, for example, electric storage devices, electrical apparatuses, and transport devices. Examples of the transport devices may include electric vehicles, hybrid cars, electric two-wheeled vehicles, railway vehicles, airplanes, elevators, and cranes. The power supply system 10 may be a stationary electric storage device. The power supply system 10 may be a stationary electric storage system manufactured or assembled by reusing a used electric storage device taken out of the transport device.

In the present embodiment, the charging device 14 supplies power to the electric storage system 100. For example, the charging device 14 receives power from a system power supply and supplies the power to the electric storage system 100. Accordingly, the electric storage module 110 and the electric storage module 130 are charged.

In one embodiment, during the period in which the power supply system 10 is supplying power to the load device 20 or at least part of the above period, the power received by the charging device 14 from the system power supply is less than the power output by the power supply system 10. For example, the rated power of the output facility of the power supply system 10 is less than the rated power of the power receiving facility of the charging device 14.

When the power supply system 10 includes a plurality of output facilities, the rated power of the single output facility may be less than the rated power of the power receiving facility of the charging device 14. When the power supply system 10 can simultaneously supply power to the plurality of load devices 20, the rated value of the power that can be supplied to the single load device 20 may be less than the rated power of the power receiving facility of the charging device 14. In addition, when the power supply system 10 includes a plurality of power receiving facilities, the total value of the rated power of one or more output facilities arranged in the power supply system 10 may be less than the rated power of the single power receiving facility, and the rated power of the single output facility arranged in the power supply system 10 may be less than the rated power of the single power receiving facility.

According to the above embodiment, most of the power consumption of the load device 20 can be covered by the power stored in the electric storage system 100. Therefore, even when the power received from the system power supply by the charging device 14 is less than the power output by the power supply system 10, the power supply system 10 can continue the supply of power to the load device 20. As a result, the power receiving facility of the charging device 14 can be downsized or simplified. In addition, the unit price of power received from the system power supply can be reduced.

In another embodiment, the power received by the charging device 14 from the system power source is greater than the power output by the power supply system 10. As a result, even when the residual amount of the power stored in the electric storage system 100 is small, the power supply system 10 can continue the supply of power to the load device 20.

In the present embodiment, the charge switching unit 16 switches an electrical connection relationship between the charging device 14 and the electric storage system 100. For example, the charge switching unit 16 switches between a state in which the charging device 14 and the electric storage system 100 are electrically connected and a state in which the charging device 14 and the electric storage system 100 are electrically disconnected. In one embodiment, the charge switching unit 16 switches an electrical connection relationship between the charging device 14 and the electric storage system 100 based on a control signal from the charging device 14. In another embodiment, the charge switching unit 16 switches an electrical connection relationship between the charging device 14 and the electric storage system 100 based on a control signal from the system control unit 140.

The charge switching unit 16 may be realized by hardware, realized by software, or realized by a combination of hardware and software. The charge switching unit 16 may be realized by an analog circuit, a digital circuit, or a combination of an analog circuit and a digital circuit.

The charge switching unit 16 may have one or more elements. The charge switching unit 16 may have one or more switching elements. Each of the one or more switching elements may be disposed between the connection terminal 102 and the charging device 14 or between the connection terminal 104 and the charging device 14. Examples of the switching element may include a relay, a thyristor, and a transistor. The thyristor may be a bidirectional thyristor (may be referred to as a triac). The transistor may be a semiconductor transistor. The semiconductor transistor may be a bipolar transistor or a field effect transistor. The field effect transistor may be a MOSFET.

The charge switching unit 16 may include one or more DC-DC converters instead of or together with the switching element. The DC-DC converter may be an isolated DC-DC converter. The DC-DC converter may be a unidirectional DC-DC converter or a bidirectional DC-DC converter. The charge switching unit 16 may include a transformer instead of or together with the switching element.

In the present embodiment, the charge switching unit 16 constitutes a part of the charging device 14. However, the charge switching unit 16 is not limited to the present embodiment. In another embodiment, the charge switching unit 16 may constitute a part of the electric storage system 100.

In the present embodiment, the load device 20 is electrically connected to the connection terminal 102 and the connection terminal 104, and receives power supplied by the power supply system 10. The load device 20 may be an electrical apparatus that consumes power or an electric storage apparatus that stores power. When the load device 20 is an electric storage apparatus, the power supply system 10 functions as a charging apparatus that charges the load device 20.

In the present embodiment, the load switching unit 26 switches an electrical connection relationship between the load device 20 and the electric storage system 100. For example, the load switching unit 26 switches between a state in which the load device 20 and the electric storage system 100 are electrically connected and a state in which the load device 20 and the electric storage system 100 are electrically disconnected. In one embodiment, the load switching unit 26 switches an electrical connection relationship between the load device 20 and the electric storage system 100 based on a control signal from the load device 20. In another embodiment, the load switching unit 26 switches an electrical connection relationship between the load device 20 and the electric storage system 100 based on a control signal from the system control unit 140.

The load switching unit 26 may be realized by hardware, realized by software, or realized by a combination of hardware and software. The load switching unit 26 may be realized by an analog circuit, a digital circuit, or a combination of an analog circuit and a digital circuit.

The load switching unit 26 may have one or more elements. The load switching unit 26 may have one or more switching elements. Each of the one or more switching elements may be disposed between the connection terminal 102 and the load device 20 or between the connection terminal 104 and the load device 20. Examples of the switching element may include a relay, a thyristor, and a transistor. The thyristor may be a bidirectional thyristor (may be referred to as a triac). The transistor may be a semiconductor transistor. The semiconductor transistor may be a bipolar transistor or a field effect transistor. The field effect transistor may be a MOSFET.

The load switching unit 26 may include one or more DC-DC converters instead of or together with the switching element. The DC-DC converter may be an isolated DC-DC converter. The DC-DC converter may be a unidirectional DC-DC converter or a bidirectional DC-DC converter. The load switching unit 26 may include a transformer instead of or together with the switching element.

In the present embodiment, the load switching unit 26 constitutes a part of the load device 20. However, the load switching unit 26 is not limited to the present embodiment. In another embodiment, the load switching unit 26 may constitute a part of the power supply system 10.

In the present embodiment, the electric storage system 100 stores power. In addition, the electric storage system 100 supplies power to an external apparatus in response to a request from the apparatus. More specifically, the electric storage system 100 is electrically connected to the charging device 14 to store electrical energy (in some cases, this is referred to as charging of the electric storage system). In addition, the electric storage system 100 is electrically connected to the load device 20 and supplies power to the load device 20 (may be referred to as discharging of the electric storage system 100).

In the present embodiment, the electric storage system 100 is electrically connected to the charging device 14 via the connection terminal 102 and the connection terminal 104. The electric storage system 100 is electrically connected to the load device 20 through the connection terminal 102 and the connection terminal 104. The connection terminals 102 and 104 may function as interfaces between the power supply system 10 and external apparatuses of the power supply system 10.

In the present embodiment, each of the electric storage module 110 and the electric storage module 130 includes an electric storage unit (not shown) that stores power. In the present embodiment, the electric storage module 110 and the electric storage module 130 are connected in parallel using the wiring 106. That is, the positive terminal of the electric storage module 110 and the positive terminal of the electric storage module 130 are electrically connected to each other by a part of the wiring 106, and the negative terminal of the electric storage module 110 and the negative terminal of the electric storage module 130 are electrically connected to each other by another part of the wiring 106.

Each of the electric storage module 110 and the electric storage module 130 may be detachably held in a housing (not shown) of the electric storage system 100. With such a configuration, each of the electric storage module 110 and the electric storage module 130 can be individually replaced.

In the present embodiment, each of the electric storage module 110 and the electric storage module 130 can switch the connection relationship between the electric storage unit of each electric storage module and the wiring 106 based on a control signal from the system control unit 140 or a user's operation. For example, each of the electric storage module 110 and the electric storage module 130 can electrically connect the electric storage unit of each electric storage module to the wiring 106 or electrically disconnect the electric storage unit of each electric storage module from the wiring 106 based on a control signal from the system control unit 140 or an operation of a user.

As a result, even when the voltage of the electric storage module newly mounted on the electric storage system 100 is different from the voltage of the electric storage module already mounted on the electric storage system 100, each of the plurality of electric storage modules included in the electric storage system 100 can be individually replaced without concerning about damage or deterioration of the electric storage module. The reasons for this are, for example, as described below.

Owing to improvements in the performance of lithium-ion batteries in recent years, the impedance of the lithium-ion battery has dropped to approximately 10 ma Because of this, for example, even if the voltage difference between two electric storage modules is only 0.4 V, a large current as much as 40 A flows from the electric storage module having a higher voltage toward an electric storage module having a lower voltage when the two electric storage modules are connected in parallel. As a result, the electric storage module(s) deteriorate or are damaged. Note that the voltage of the electric storage module may be the voltage between the positive terminal and the negative terminal of the electric storage module (in some cases, the voltage is referred to as the inter-terminal voltage of the electric storage module).

If one of the plurality of electric storage modules connected in parallel is individually replaced, in order to prevent the deterioration or damage of the electric storage modules associated with replacing the electric storage module, the voltage of the electric storage module to be newly mounted and the voltage of the already mounted electric storage module may be adjusted, prior to replacing the electric storage module, over some time until the voltage difference between the electric storage modules becomes very small. By making the voltage difference between the electric storage module to be newly mounted and the already mounted electric storage module very small, a large current can be prevented from flowing into each electric storage module when the electric storage module is replaced. As a result, the deterioration or damage of the electric storage modules can be suppressed. However, as the impedance of the lithium-ion battery decreases, the tolerance of the voltage difference between the electric storage module to be newly mounted and the already mounted electric storage module also decreases, so that it may take a great amount of time to adjust the voltage difference.

In contrast, according to the electric storage system 100 of the present embodiment, each of the electric storage module 110 and the electric storage module 130 can switch the connection relationship between the electric storage unit of each electric storage module and the wiring 106 based on the control signal from the system control unit 140 or the operation of the user. Then, for example, the electric storage module 110 can be replaced in accordance with the following procedure.

First, a user removes an old electric storage module 110 from the electric storage system 100. Next, before mounting the new electric storage module 110 on the electric storage system 100, the user performs an operation for electrically disconnecting the electric storage unit of the new electric storage module 110 and the wiring 106. For example, the user manually operates a switching element disposed between the positive terminal of the electric storage module 110 and the electric storage unit to electrically disconnect the positive terminal of the electric storage module 110 and the electric storage unit.

Subsequently, the user mounts the electric storage module 110 in a state where the positive terminal and the electric storage unit are electrically disconnected from each other on the electric storage system 100. At this time, since the positive terminal and the electric storage unit are electrically disconnected, even if the voltage difference between the electric storage module 110 and the electric storage module 130 is relatively large, no current flows between the electric storage module 110 and the electric storage module 130. Subsequently, when the voltage difference between the electric storage module 110 and the electric storage module 130 becomes an appropriate value, the system control unit 140 executes an operation for electrically connecting the electric storage module 110 and the wiring 106. Note that details of the system control unit 140 will be described later.

As described above, according to the electric storage system 100 of the present embodiment, when the electric storage module is replaced or mounted, it is not necessary to strictly adjust the voltage of the electric storage module newly mounted on the electric storage system 100 and the voltage of the electric storage module already mounted on the electric storage system 100. Therefore, the electric storage module can be easily and quickly replaced or mounted.

(Difference Between Electric Storage Module 110 and Electric Storage Module 130)

In the present embodiment, the specifications of the electric storage unit of the electric storage module 110 are different from the specifications of the electric storage unit of the electric storage module 130. In one embodiment, the type of the secondary battery constituting the electric storage unit of the electric storage module 110 is different from the type of the secondary battery constituting the electric storage unit of the electric storage module 130. In another embodiment, the battery system of the electric storage module 110 is different from the battery system of the electric storage module 130. In still another embodiment, the inter-terminal voltage of the electric storage module 110 is different from the inter-terminal voltage of the electric storage module 130. Details of the electric storage module 110 and the electric storage module 130 will be described later.

(Outline of System Control Unit 140)

In the present embodiment, the system control unit 140 controls each unit of the electric storage system 100. For example, the system control unit 140 (i) determines the state of each unit of the electric storage system 100, (ii) monitors the state of each unit of the electric storage system 100, and (iii) controls the operation of each unit of the electric storage system 100.

(Determination of System State)

In one embodiment, the system control unit 140 determines the state of the electric storage system 100. Examples of the state of the electric storage system 100 may include a charge state, a discharge state, a standby state, a stop state, and the like. For example, the system control unit 140 receives information related to a charge/discharge event. The system control unit 140 determines the state of the electric storage system 100 based on the information related to the charge/discharge event.

The information related to the charge/discharge event may be information indicating that discharge or charging of the electric storage system 100 has already been performed, or may be information indicating that discharge or charging of the electric storage system 100 is to be performed. Examples of the information related to the charge/discharge event may include (i) a charge request or a discharge request from an external apparatus such as the charging device 14 or the load device 20, (ii) information indicating that the external apparatus has been connected to the electric storage system 100, (iii) information indicating the type of the external apparatus, (iv) information indicating the content of the operation of the external apparatus, (v) information indicating the state of the external apparatus, (vi) information indicating a user's instruction or operation on the external apparatus, (vii) information indicating a user's instruction or operation on the power supply system 10 or the electric storage system 100, and (viii) a combination thereof.

For example, the system control unit 140 determines that the electric storage system 100 is in the charge state when detecting the connection of the charging device 14 or when receiving a signal indicating the type of the charging device 14. The system control unit 140 may determine that the electric storage system 100 is in the charge state when receiving a signal indicating that charging will start from the charging device 14. The system control unit 140 may determine that the electric storage system 100 is in the charge state when receiving a signal indicating that the regenerative current is generated or that there is a possibility that the regenerative current is generated from the load device 20.

For example, the system control unit 140 determines that the electric storage system 100 is in the discharge state when detecting the connection of the load device 20 or receiving a signal indicating the type of the load device 20. The system control unit 140 may determine that the electric storage system 100 is in the discharge state when receiving a signal indicating that power will be used from the load device 20. Examples of the signal indicating that the power will be used may include a signal indicating that the power supply of the load device 20 will be turned on, a signal indicating that the power supply of the load device 20 has been turned on, a signal indicating that the load device 20 will be shifted to the operation mode, and a signal indicating that the load device 20 has been shifted to the operation mode.

(Monitoring of State of System)

In another embodiment, the system control unit 140 monitors the state of the electric storage system 100. For example, the system control unit 140 monitors a state of at least one of the electric storage module 110 and the electric storage module 130. The system control unit 140 may monitor the state of each of the electric storage module 110 and the electric storage module 130. The system control unit 140 may collect information related to the battery characteristic of the electric storage unit included in each of the electric storage module 110 and the electric storage module 130. The information related to the battery characteristic of the electric storage unit may be at least one selected from: the voltage value of the electric storage unit; the current value of the current flowing through the electric storage unit; the battery capacity of the electric storage unit; the temperature of the electric storage unit; the deterioration state of the electric storage unit; and SOC (State Of Charge) of the electric storage unit.

The information related to the battery characteristic (may be referred to as the battery characteristic of an electric storage module. The battery characteristic of the electric storage unit may be a battery characteristic of one of a plurality of single batteries constituting the electric storage module or may be the battery characteristic of a combination of the plurality of single batteries.) of the electric storage unit may include at least one of information related to the specification of the electric storage unit and information related to the deterioration state of the electric storage unit. Examples of the information related to the specification of the electric storage unit may include information related to: the type or model of the electric storage unit; the connection state of the electric storage unit; the type of charging method that can charge the electric storage unit; the type of charging method that cannot charge the electric storage unit; the rated battery capacity (may be referred to as the rated capacity); the rated voltage; the rated current; the energy density; the maximum charge and discharge current; the charge characteristic; the charge temperature characteristic; the discharge characteristic; the discharge temperature characteristic; the self-discharge characteristic; the charge and discharge cycle characteristic; the equivalent series resistance in the initial state; the battery capacity in the initial state; the SOC [%] in the initial state; and the electric storage voltage [V]. Examples of the charging methods may include the CCCV charging method, the CC charging method, and the trickle charging method.

Examples of the connection states of the electric storage unit may include the types, the number, and the connection forms of the unit cells constituting the electric storage unit. Examples of the connection forms of the unit cells may include the number of the unit cells connected in series and the number of the unit cells connected in parallel. The energy density may be a volume energy density [Wh/m³] or weight energy density [Wh/kg].

Examples of the information related to the deterioration state of the electric storage unit may include information of the electric storage unit taken at an optional time, which include information related to: (i) the battery capacity in the state of full charge; (ii) SOC in a predetermined temperature condition; (iii) SOH (State Of Health); (iv) equivalent series resistance (in some cases, also referred to as DCR or internal resistance); and (v) at least one of the use time, the number of charging, the charge amount, the discharge amount, the number of charge and discharge cycles, a thermal stress factor, and an overcurrent stress factor that have been integrated since the initial state or a predetermined timing. The information related to the battery characteristic of the electric storage unit may also associate information related to the deterioration state of the electric storage unit with information related to the time of day that the information was acquired, and store the associated information. The information related to the battery characteristic of the electric storage unit may store information related to the deterioration state of the electric storage unit at a plurality of times of day.

SOH [%] is expressed, for example, as the full charge capacity (for example, the present full charge capacity) in the deterioration state [Ah]÷the initial full charge capacity [Ah]×100. Although the calculation methods or the estimation methods of SOH are not particularly limited, SOH of the electric storage unit is, for example, calculated or estimated based on at least one of the direct current resistance value and the open circuit voltage value of the electric storage unit. SOH may be a value in a predetermined temperature condition obtained from conversion using an optional conversion formula or the like.

The methods of determining the deterioration state of the electric storage unit are not particularly limited, and determination methods that are currently known or will be developed in the future may be used. In general, as the electric storage unit further deteriorates, the available battery capacity decreases while the equivalent series resistance increases. Because of this, for example, the deterioration state of a battery can be determined by comparing the present battery capacity, SOC, or the equivalent series resistance, with the battery capacity, SOC, or the equivalent series resistance of the initial state.

SOC [%] is expressed as, for example, the remaining capacity [Ah]÷the full charge capacity [Ah]×100. Although the calculation methods or the estimation methods of SOC are not particularly limited, SOC is, for example, calculated or estimated based on at least one of: (i) a measurement result of the voltage of the electric storage unit; (ii) IN characteristic data of the voltage of the electric storage unit; and (iii) an integrated value of the current value of the electric storage unit. SOC may be a value in a predetermined temperature condition obtained from conversion using an optional conversion formula or the like.

The information related to the battery characteristic of the electric storage unit may be information related to at least one of the charge time and the discharge time of the electric storage unit. The charge time and the discharge time of the electric storage unit may respectively be the charge time and the discharge time of the electric storage module including the electric storage unit. In general, as the electric storage unit further deteriorates, the available battery capacity decreases and at least one of the charge time and the discharge time shortens.

Information related to the charge time of the electric storage unit may include information indicating the ratio of the charge time of the electric storage unit to the charge time of the electric storage system 100. The information related to the charge time of the electric storage unit may include information indicating the charge time of the electric storage system 100 and information indicating the charge time of the electric storage unit. The above described charge time may be: (i) time during which current or voltage has been applied to the electric storage system 100 or the electric storage unit in a single charging operation; or (ii) the sum of time during which current or voltage has been applied to the electric storage system 100 or the electric storage unit in one or more charging operations in a predetermined period.

The information related to the charge time of the electric storage unit may include information indicating the ratio of the number of charging of the electric storage unit in a predetermined period to the number of charging of the electric storage system 100 in the period. The information related to the charge time of the electric storage unit may include information indicating the number of charging of the electric storage system 100 in a predetermined period and information indicating the number of charging of the electric storage unit in the period.

The information related to the discharge time of the electric storage unit may include information indicating the ratio of the discharge time of the electric storage unit to the discharge time of the electric storage system 100. The information related to the discharge time of the electric storage unit may include the discharge time of the electric storage system 100 and the discharge time of the electric storage unit. The above described discharge time may be: (i) time during which the electric storage system 100 or the electric storage unit has supplied current or voltage in a single discharging operation; or (ii) the sum of time during which the electric storage system 100 or the electric storage unit has supplied current or voltage in one or more discharging operations in a predetermined period.

The information related to the discharge time of the electric storage unit may include information indicating the ratio of the number of discharging of the electric storage unit in a predetermined period to the number of discharging of the electric storage system 100 in the period. The information related to the discharge time of the electric storage unit may include the number of discharging of the electric storage system 100 in a predetermined period and the number of discharging of the electric storage unit in the period.

The system control unit 140 may transmit, to an external apparatus, at least one of the information related to the battery characteristic of the electric storage unit included in the electric storage module 110 and the information related to the battery characteristic of the electric storage unit included in the electric storage module 130. The external apparatus can thereby use the information related to the battery characteristic of an electric storage unit. Examples of the external apparatuses may include the charging device 14 and the load device 20. The external apparatus may be an output device that outputs information to a user. Examples of the output devices may include a display device and a voice output device such as a microphone.

The system control unit 140 may determine the performance of the electric storage module based on the information related to the battery characteristic of the electric storage module. The system control unit 140 may also output information indicating that the performance of the electric storage module is insufficient if the battery characteristic of the electric storage module does not satisfy a predetermined determination condition. The system control unit 140 may also determine the determination condition based on the application of the electric storage system 100.

As described above, in the present embodiment, the system control unit 140 collects at least one of the information related to the battery characteristic of the electric storage unit included in the electric storage module 110 and the information related to the battery characteristic of the electric storage unit included in the electric storage module 130 and transmits the collected information to the external apparatus. However, the electric storage system 100 is not limited to the present embodiment. In another embodiment, each of the electric storage module 110 and the electric storage module 130 may also collect the information related to the battery characteristic of the electric storage unit included in the electric storage module and transmit the collected information to the external apparatus.

(Control of Operation of System)

In another embodiment, the system control unit 140 controls an operation of each unit of the electric storage system 100. For example, the system control unit 140 controls an operation of at least one of the electric storage module 110 and the electric storage module 130. The system control unit 140 may switch a connection relationship between the electric storage unit of the electric storage module 110 and the wiring 106. The system control unit 140 may switch a connection relationship between the electric storage unit of the electric storage module 130 and the wiring 106.

The system control unit 140 may control the operation of at least one of the charging device 14 and the charge switching unit 16. The system control unit 140 may control the start and stop of a power supply from the charging device 14 to the electric storage system 100. The system control unit 140 may adjust a set value of at least one of the charging voltage and the charging current. The system control unit 140 may control an increase rate or a decrease rate of at least one of the charging voltage and the charging current.

The system control unit 140 may control the operation of at least one of the load device 20 and the load switching unit 26. The system control unit 140 may control the start and stop of a power supply from the electric storage system 100 to the load device 20. The system control unit 140 may adjust a set value of at least one of the output voltage and the output current. The system control unit 140 may control an increase rate or a decrease rate of at least one of the output voltage and the output current.

Based on the voltage of the electric storage unit of each electric storage module, the system control unit 140 may determine the order in which the electric storage unit of each electric storage module is electrically connected to the wiring 106. For example, when the operation of the electric storage system 100 is started and the state of the electric storage system 100 starts from the charge state, the system control unit 140 electrically connects the electric storage units of the electric storage modules having the lower voltages to the wiring 106. On the other hand, when the operation of the electric storage system 100 is started and the state of the electric storage system 100 starts from the discharge state, the system control unit 140 electrically connects the electric storage units of the electric storage modules having the higher voltages to the wiring 106. Note that the system control unit 140 may determine the order of electrically connecting the electric storage units of the respective electric storage modules to the wiring 106 based on the inter-terminal voltage of the respective electric storage modules.

In one embodiment, the system control unit 140 may transmit a signal for connecting the electric storage unit to the wiring 106 to each electric storage module in the determined order. In another embodiment, the system control unit 140 may select the electric storage module having the lowest voltage or SOC or the electric storage module having the highest voltage or SOC, and transmit a signal for connecting the electric storage unit to the wiring 106 only to the selected electric storage module.

The system control unit 140 may be realized by hardware or software. Furthermore, it may be realized by a combination of hardware and software. In one embodiment, the system control unit 140 may be realized by an analog circuit, a digital circuit, or a combination of an analog circuit and a digital circuit. In another embodiment, in a general information processing device provided with a data processing device and the like having a CPU, a ROM, a RAM, a communication interface, and the like, the system control unit 140 may be realized by executing programs for controlling the respective units of the system control unit 140.

The programs installed in a computer to cause the computer to function as part of the system control unit 140 according to the present embodiment may include modules that define operations of the respective units of the system control unit 140. These programs or modules cooperate with CPU and the like to cause the computer to function as the respective units of the system control unit 140.

By being read by the computer, the information processing described in these programs functions as specific means as a result of the software and the above-described various types of hardware resources cooperating with each other. By realizing computation or processing of information to meet the intended use of the computer in the present embodiment by these specific means, a specific device to meet the intended use can be constructed. The programs may be stored on a computer-readable medium or a storage device connected to a network.

Note that the reference to “electrically connected” is not limited to direct connection between a particular component and another component. A third component may also be present between the particular component and another component. In addition, the reference to “electrically connected” is not limited to physical connection between a particular component and another component. For example, input winding and output winding in a transformer are not physically connected but are electrically connected. Furthermore, the reference to “electrically connected” means not only that a particular component is actually and electrically connected to another component but also that the particular component is electrically connected to the other component when an electric storage cell and a balance correcting unit are electrically connected. In addition, the reference to “connected in series” indicates that a particular component and another component are electrically connected in series, and the reference to “connected in parallel” indicates that a particular component and another component are electrically connected in parallel.

(Parallel Connection of Electric Storage Module 110 and Electric Storage Module 130)

As described above, in the electric storage system 100, the electric storage module 110 and the electric storage module 130 having different specifications are connected in parallel. Therefore, in the present embodiment, the power supply system 10 or the electric storage system 100 is constructed in consideration of a difference in specification between the electric storage module 110 and the electric storage module 130.

In recent years, there is an urgent need to establish a method for reusing storage batteries used in transport apparatuses such as electric vehicles and hybrid vehicles. However, for example, a rated value and a deterioration state of a specification are greatly different between a storage battery for electric vehicles and a storage battery for hybrid vehicles. For example, in general, an inter-terminal voltage of a storage battery for electric vehicles is greater than an inter-terminal voltage of a storage battery for hybrid vehicles. In addition, the capacity of the storage battery for electric vehicles is greater than the capacity of the storage battery for hybrid vehicles.

Therefore, for example, in a case where the electric storage module 110 is manufactured using a secondhand product (in some cases, also referred to as a used product, a recycled product, or the like) of a storage battery for electric vehicles, the electric storage module 130 is manufactured using a secondhand product of a storage battery for hybrid vehicles, and the electric storage system 100 is manufactured by connecting the two electric storage modules in parallel, the inter-terminal voltage of the electric storage module 110 is different from the inter-terminal voltage of the electric storage module 130. When the storage battery for electric vehicles is a lithium ion battery or the like, the electric storage module 110 does not support a trickle charging method. On the other hand, when the storage battery for hybrid vehicles is a nickel-metal hydride battery or the like, the electric storage module 130 corresponds to a trickle charging method.

Depending on the relationship between the number of storage batteries included in the electric storage module 110 and the inter-terminal voltage and the number of storage batteries included in the electric storage module 130 and the inter-terminal voltage, the inter-terminal voltage of the electric storage module 130 is greater than the inter-terminal voltage of the electric storage module 110. In this case, the set value of the charge end voltage of the electric storage module 110 is adjusted to a value equal to or less than the charge end voltage of the electric storage module 130 or a value less than the charge end voltage.

In this case, when the electric storage module 110 supports the trickle charging method and the electric storage module 130 does not support the trickle charging method, the trickle charging of the electric storage module 110 can be continued until the electric storage module 110 reaches the full charging voltage after the charging of the electric storage module 110 is completed. However, depending on the relationship between the type of the storage battery included in the electric storage module 110 and the type of the storage battery included in the electric storage module 130, there may be a case where the electric storage module 110 does not support the trickle charging method and the electric storage module 130 supports the trickle charging method. In this case, the operation and setting of the charging device 14 are determined in consideration of trickle charging of the electric storage module 130.

When the electric storage module 130 supports the trickle charging method, the charge end voltage of the electric storage module 130 is equal to or less than the full charging voltage of the electric storage module 130. As described above, in the present embodiment, the charge end voltage of the electric storage module 130 is greater than the charge end voltage of the electric storage module 110 that does not support the trickle charging method. Therefore, according to the present embodiment, the charging voltage of the charging device 14 is set to a value greater than the charge end voltage of the electric storage module 130.

As a result, trickle charging of the electric storage module 130 can be continued until the electric storage module 130 reaches the full charging voltage after the charging of the electric storage module 130 is completed. The charge end voltage of the electric storage module 130 is determined by, for example, the number of storage batteries included in the electric storage module 130 and the inter-terminal voltage. The charge end voltage of the electric storage module 110 is determined by, for example, the number of storage batteries included in the electric storage module 110 and the inter-terminal voltage.

The charge end voltage of the electric storage module may be a voltage that allows the electric storage module to be charged in a constant current region. The set value of the charge end voltage is designated by, for example, a manufacturer or a seller of the electric storage module or a designer of the electric storage system 100. The full charging voltage of the electric storage module may be a voltage in a state in which the rate of increase in the charge rate is less than a predetermined value after the charge rate of the electric storage module is increased by trickle charging. The value of the full charging voltage of the electric storage module is greater than the value of the charge end voltage of the electric storage module.

For example, the charging device 14 charges the electric storage module by a relatively high-speed charging method such as a constant current charging method, a constant voltage charging method, or a constant current and constant voltage charging method until the voltage or the charging rate (may be referred to as SOC) of the electric storage module reaches a first value after starting charging of the electric storage module. Subsequently, the charging device 14 decreases the charging current and starts charging by the trickle charging method. While the electric storage module is charged by the trickle charging method, the voltage of the electric storage module slowly increases until the voltage of the electric storage module reaches a second value. When the voltage of the electric storage module reaches the second value, the voltage of the electric storage module hardly increases. For example, when the electric storage module includes a plurality of electric storage cells and an equalizing circuit that equalizes the voltages of the plurality of electric storage cells, the voltages of the plurality of electric storage cells included in the electric storage module are equalized while the electric storage module is charged by the trickle charging method. As a result, the voltage of the electric storage module hardly increases. In this case, the first value may be an example of the charge end voltage. The second value may be an example of the full charging voltage.

As described above, by combining different types of secondary batteries in parallel to construct the electric storage system 100, it is possible to construct a power supply system excellent in at least one of the life, the reliability, the charging performance, the discharging performance, the energy efficiency, the temperature characteristic, and the economy as compared with the electric storage system 100 including a single type of secondary battery. For example, lead-acid batteries operate in a relatively wide temperature range but have relatively low energy efficiency in charging and discharging. On the other hand, lithium ion batteries have high energy efficiency in charging and discharging but have a problem in operating in low and high temperature regions. Therefore, by combining an electric storage module including an electric storage unit made of a lead battery and an electric storage module including an electric storage unit made of a lithium ion battery in parallel, a power supply system having a high energy efficiency and operating in a wide temperature range can be constructed.

In addition, a nickel-metal hydride battery (for example, a NiMH battery) has characteristics that it is strong in operating at a low temperature and power that can be instantaneously taken out is large as compared with a lithium ion battery. Therefore, by combining an electric storage module including an electric storage unit made of a nickel-metal hydride battery and an electric storage module including an electric storage unit made of a lithium ion battery in parallel, a power supply system that operates in a wide temperature range, can instantaneously take out a large amount of power, and has a large battery capacity can be constructed.

The power supply system 10 may be an example of an electric storage system. The electric storage system 100 may be an example of the electric storage system. The electric storage module 110 may be an example of a second electric storage device. The electric storage unit of the electric storage module 110 may be an example of the second electric storage unit. The electric storage module 130 may be an example of a first electric storage device. The electric storage unit of the electric storage module 130 may be an example of the second electric storage unit. The system control unit 140 may be an example of a charging voltage control unit. The system control unit 140 may be an example of a current consumption control unit.

In the present embodiment, the case where the electric storage system 100 includes two electric storage modules connected in parallel has been described. However, the electric storage system 100 is not limited to the present embodiment. In another embodiment, the electric storage system 100 may include three or more electric storage modules connected in parallel.

In the present embodiment, the case where a user performs the operation for electrically connecting the electric storage unit of a new electric storage module 110 and the wiring 106 before mounting the electric storage module 110 on the electric storage system 100 has been described. However, a mounting method or a replacement method of the electric storage module 110 is not limited to the present embodiment. In another embodiment, for example, the user operates an input unit (not shown) of the electric storage system 100 to input an instruction to start replacing the electric storage module 110. Examples of the input unit may include a keyboard, a pointing device, a touch panel, a microphone, a voice recognition system, and a gesture input system.

The system control unit 140 may perform operation for electrically disconnecting the wiring 106 and the electric storage unit of the electric storage module (the electric storage module 130 in the present embodiment) connected in parallel with the electric storage module 110 upon accepting an instruction to start replacing the electric storage module 110. At this time, the system control unit 140 may also perform operation for electrically disconnecting the electric storage unit of the electric storage module 110 and the wiring 106. For example, the system control unit 140 transmits, to the switching element, a signal for turning off a switching element arranged between a positive terminal and the electric storage unit of each electric storage module.

The system control unit 140 acquires the voltage of the electric storage unit of each electric storage module upon detecting that the old electric storage module 110 has been detached and the new electric storage module 110 has been mounted. If the electric storage unit of the new electric storage module 110 and the wiring 106 are electrically connected, the system control unit 140 operates the electric storage system 100 by using only the electric storage module 110 until the voltage difference between the electric storage module 110 and the electric storage module 130 becomes an appropriate value, for example. Then, when the voltage difference between the electric storage module 110 and the electric storage module 130 has become the appropriate value, the system control unit 140 executes operation for electrically connecting the electric storage module 130 and the wiring 106.

On the other hand, if the electric storage unit of the new electric storage module 110 and the wiring 106 are not electrically connected, the system control unit 140 determines the order in which the electric storage unit of each electric storage module is to be electrically connected to the wiring 106, based on the voltage of the electric storage unit of each electric storage module. Subsequently, the system control unit 140 electrically connects the electric storage unit of each electric storage module to the wiring 106 in accordance with the determined order. Note that, if the electric storage unit of the new electric storage module 110 and the wiring 106 are electrically connected, the system control unit 140 may also first electrically disconnect the electric storage unit of the new electric storage module 110 and the wiring 106. Subsequently, the system control unit 140 may also determine the order in which the electric storage unit of each electric storage module is to be electrically connected to the wiring 106, based on the voltage of the electric storage unit of each electric storage module and then electrically connect the electric storage unit of each electric storage module to the wiring 106 in accordance with the determined order.

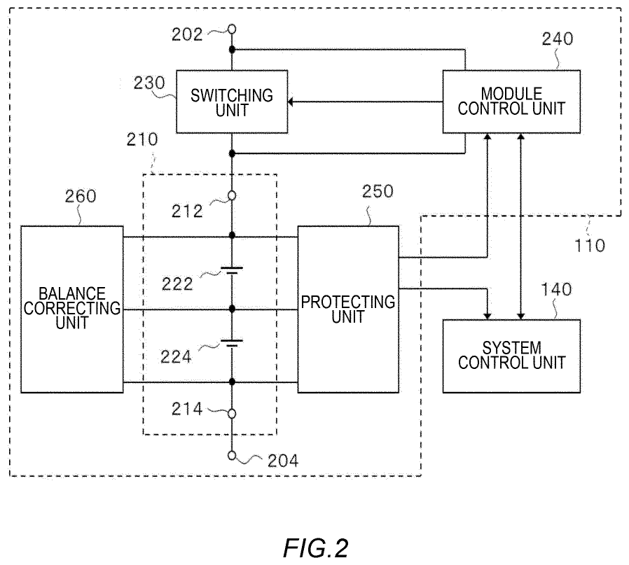

FIG. 2 schematically shows an example of a system configuration of the electric storage module 110. In the present embodiment, the electric storage module 110 includes a positive terminal 202 and a negative terminal 204. Further, the electric storage module 110 includes an electric storage unit 210 having a positive terminal 212 and a negative terminal 214, and a switching unit 230. In the present embodiment, the electric storage unit 210 includes an electric storage cell 222 and an electric storage cell 224. In the present embodiment, the electric storage module 110 further includes a module control unit 240, a protecting unit 250, and a balance correcting unit 260.

The impedance of the electric storage unit 210 may be 1Ω or less, or may be 100 mΩ or less. The impedance of the electric storage unit 210 may be 10 mΩ or less, 1 mΩ or less, 0.8 mΩ or less, or 0.5 mΩ or less. The impedance of the electric storage unit 210 may be 0.1 mΩ or more. The impedance of the electric storage unit 210 may be 0.1 mΩ or more and 1Ω or less, 0.1 mΩ or more and 100 mΩ or less, 0.1 mΩ or more and 10 mΩ or less, or 0.1 mΩ or more and 1 mΩ or less.

According to the electric storage system 100 of the present embodiment, for example, if one of the plurality of electric storage modules connected in parallel is replaced, the voltage of the electric storage module to be newly added to the electric storage system and the voltage of the remaining electric storage module may not match each other with high precision. Because of this, the electric storage module 110 can be easily and quickly replaced even if the impedance of the electric storage unit 210 is small.

In the present embodiment, the electric storage cell 222 and the electric storage cell 224 are connected in series. The electric storage cell 222 and the electric storage cell 224 may be secondary batteries or capacitors. At least one of the electric storage cell 222 and the electric storage cell 224 may further include a plurality of electric storage cells connected in series, in parallel, or in a matrix inside the electric storage cell.

In the present embodiment, each of the electric storage cell 222 and the electric storage cell 224 is constituted by a type of secondary battery that cannot support trickle charging. At least one of the electric storage cell 222 and the electric storage cell 224 may be a lithium ion battery.

In general, when no irreversible change occurs in the battery system of the secondary battery under an environment where charging is continued in a full charge state (that is, when the chemical reaction of the battery system of the secondary battery in the overcharge state is expressed by a reaction formula that does not involve an irreversible change), the secondary battery can support trickle charging. Examples of the secondary battery capable of supporting trickle charging include a lead battery, a nickel-metal hydride battery, and a nickel-cadmium battery. Chemical reactions during normal charging and discharging of a battery system of a lead battery, a nickel-metal hydride battery, and a nickel-cadmium battery are expressed by the following formulas (1) to (3), respectively.

PbO₂+Pb+2H₂SO₄↔PbSO₄+PbSO₄+2H₂O (1)

NiOOH+MH↔Ni(OH)₂+M (2)

2NiOOH+Cd+2H₂O↔2Ni(OH)₂+Cd(OH)₂ (3)

On the other hand, when an irreversible change occurs in the battery system of the secondary battery in an environment where charging is continued in a full charge state (that is, when the chemical reaction of the battery system of the secondary battery in the overcharge state is expressed by a reaction formula involving an irreversible change), the secondary battery cannot support trickle charging. Examples of the secondary battery incapable of supporting trickle charging include a lithium battery and a lithium ion battery (a lithium ion polymer battery and an all-solid-state battery). Among the above secondary batteries, a chemical reaction of a battery system particularly of a lithium ion battery during normal charging and discharging is expressed by the following formula (4).

Li₍₁₋ₓ₎CoO₂+LiₓC₆↔LiCoO₂+C₆ (4)

Here, in the chemical reaction in the overcharge state of the lithium ion battery, the crystal structure of lithium cobalt oxide, which is a positive electrode active material, collapses due to the overcharge, and oxygen is generated. The generation of oxygen due to the overcharge causes an imbalance between lithium cobalt oxide (Li₍₁₋ₓ₎CoO₂) and cobalt dioxide (CoO₂) in the positive electrode and causes a decrease in the positive electrode capacity without returning to the original crystal structure, and thus is positioned as an irreversible change.

The trickle charging can be defined as a charging method for continuing continuous or intermittent charging of a minute current with respect to a secondary battery in a full charge state or in a state close to the full charge state. In the present embodiment, trickle charging is embodied as a charging method in which, after completion of charging of an electric storage module capable of supporting trickle charging, charging of the electric storage module with a current less than a charging current at the time of normal charging is continued to bring the electric storage module close to a full charge state. Therefore, in the present embodiment, the minute current for trickle charging is a current capable of increasing the charge amount of the target electric storage module, but when the charge state at the end of charge is closer to full charge, the minute current for trickle charging may be a current that can compensate for the decrease in the charge amount due to the natural discharging of the target electric storage module.

In the present embodiment, the positive terminal 212 of the electric storage unit 210 is electrically connected to the wiring 106 via the positive terminal 202 and the switching unit 230 of the electric storage module 110. On the other hand, the negative terminal 214 of the electric storage unit 210 is electrically connected to the wiring 106 via the negative terminal 204 of the electric storage module 110. However, the electric storage module 110 is not limited to the present embodiment. In another embodiment, the negative terminal 214 of the electric storage unit 210 is electrically connected to the wiring 106 via the negative terminal 204 and the switching unit 230 of the electric storage module 110. On the other hand, the positive terminal 212 of the electric storage unit 210 is electrically connected to the wiring 106 via the positive terminal 202 of the electric storage module 110.

In the present embodiment, the switching unit 230 is disposed between the wiring 106 and the electric storage unit 210. In the present embodiment, the switching unit 230 switches the electrical connection relationship between the wiring 106 and the electric storage unit 210 based on the voltage difference between the wiring 106 and the electric storage unit 210. For example, the switching unit 230 switches the connection state of the wiring 106 and the electric storage unit 210 based on the signal generated by the module control unit 240. Accordingly, the electric storage unit 210 can be electrically connected to the wiring 106, and the electric storage unit 210 can be electrically disconnected from the wiring 106.

When the electric storage module 110 is mounted on the electric storage system 100, the electric storage module 110 may be mounted on the electric storage system 100 in a state where the electric storage unit 210 and the wiring 106 are electrically disconnected from each other by the switching unit 230. With such a configuration, it is possible to prevent damage or deterioration of the electric storage module 110.

The switching unit 230 may be realized by hardware, realized by software, or realized by a combination of hardware and software. The switching unit 230 may be realized by an analog circuit, a digital circuit, or a combination of an analog circuit and a digital circuit.

The switching unit 230 may have one or more elements. The switching unit 230 may include one or more switching elements. Each of the one or more switching elements may be disposed between the positive terminal 202 and the positive terminal 212 or between the negative terminal 204 and the negative terminal 214. Examples of the switching element may include a relay, a thyristor, and a transistor. The thyristor may be a bidirectional thyristor (may be referred to as a triac). The transistor may be a semiconductor transistor. The semiconductor transistor may be a bipolar transistor or a field effect transistor. The field effect transistor may be a MOSFET.

The switching unit 230 may include one or more DC-DC converters instead of or together with the switching element. The DC-DC converter may be an isolated DC-DC converter. The DC-DC converter may be a unidirectional DC-DC converter or a bidirectional DC-DC converter. The switching unit 230 may include a transformer instead of or together with the switching element.

The module control unit 240 controls a current flowing between the electric storage unit 210 of the electric storage module 110 and the wiring 106. In the present embodiment, the module control unit 240 controls the switching unit 230 such that the switching unit 230 electrically connects the electric storage unit 210 and the wiring 106 when the inter-terminal voltage of the switching unit 230 (in the present embodiment, the voltage is a voltage between the positive terminal 202 and the positive terminal 212) satisfies a predetermined condition. The switching unit 230 may electrically connect the electric storage unit 210 and the wiring 106 by electrically connecting the electric storage unit 210 and the positive terminal 202.

On the other hand, when the inter-terminal voltage of the switching unit 230 does not satisfy the predetermined condition, the switching unit 230 is controlled such that the switching unit 230 electrically disconnects the electric storage unit 210 and the wiring 106 or the positive terminal 202. The switching unit 230 may electrically disconnect the electric storage unit 210 and the wiring 106 by electrically disconnecting the electric storage unit 210 and the positive terminal 202.

The predetermined condition may be a condition that the absolute value of the inter-terminal voltage of the switching unit 230 is within a predetermined range. The predetermined range may be 3 V or less, 1 V or less, 0.1 V or less, 10 mV or less, or 1 mV or less. The predetermined range may be 0.5 mV or more or 1 mV or more. The predetermined range may be 0.5 mV or more and 3 V or less. The predetermined range may be 1 mV or more and 3 V or less, 1 mV or more and 1 V or less, 1 mV or more and 0.1 V or less, 1 mV or more and 10 mV or less, 10 mV or more and 1 V or less, 10 mV or more and 0.1 V or less, or 0.1 V or more and 1 V or less. The inter-terminal voltage of the switching unit 230 may be a voltage between the positive terminal 202 and the positive terminal 212, or may be a voltage between the wiring 106 and the electric storage unit 210.

The predetermined range may be set based on the impedance of the electric storage unit 210. The predetermined range may be set based on the rated current or the allowable current of the electric storage unit 210. The predetermined range may be set based on the impedance of the electric storage unit 210 and the rated current or the allowable current of the electric storage unit 210. The predetermined range may be set based on the rated current or the allowable current of the element having the smallest rated current or allowable current among the elements constituting the electric storage module 110. The predetermined range may be set based on the impedance of the electric storage module 110 and the rated current or the allowable current of the element having the smallest rated current or allowable current among the elements constituting the electric storage module 110.

If the electric storage module is replaced, the wiring 106 and the electric storage unit 210 of the newly mounted electric storage module can thereby be maintained electrically disconnected until the voltage difference between the newly mounted electric storage module and the already mounted electric storage module falls within the predetermined range. Then, when the voltage difference between the newly mounted electric storage module and the already mounted electric storage module have fallen within the predetermined range by charging or discharging the already mounted electric storage module, the electric storage unit of the newly mounted electric storage module is electrically connected to the wiring 106. In this way, according to the present embodiment, the newly mounted electric storage module and the other electric storage module can be automatically connected.

In the present embodiment, the module control unit 240 receives, from the system control unit 140, a signal indicating that the inter-terminal voltage of the electric storage module 110 is less than the inter-terminal voltage of the other electric storage module. If the module control unit 240 receives the above described signal when the electric storage system 100 shifts to the state of charge, the module control unit 240 controls the switching unit 230 such that the switching unit 230 electrically connects the electric storage unit 210 and the wiring 106. The plurality of electric storage modules 110 connected in parallel can thereby be efficiently charged.

In the present embodiment, the module control unit 240 receives, from the system control unit 140, a signal indicating that the inter-terminal voltage of the electric storage module 110 is greater than the inter-terminal voltage of the other electric storage module. If the module control unit 240 receives the above described signal when the electric storage system 100 shifts to the state of discharge, the module control unit 240 controls the switching unit 230 such that the switching unit 230 electrically connects the electric storage unit 210 and the wiring 106. The plurality of electric storage modules 110 connected in parallel can thereby be efficiently discharged.

In the present embodiment, the module control unit 240 receives, from the protecting unit 250, a signal indicating that the inter-terminal voltage of the electric storage cell 222 or the inter-terminal voltage of the electric storage cell 224 is not in the predetermined range. When the module control unit 240 has received the signal, the module control unit 240 controls the switching unit 230 such that the switching unit 230 electrically disconnects the electric storage unit 210 and the wiring 106. The deterioration or damage of the electric storage unit 210 due to overcharge or over discharge can thereby be suppressed.

In the present embodiment, the module control unit 240 accepts user operation and receives an instruction to turn on or turn off the switching unit 230 from the user. When the module control unit 240 has received the instruction from the user, the module control unit 240 controls the switching unit 230 in accordance with the instruction.

In the present embodiment, the module control unit 240 may acquire information related to the battery characteristic of the electric storage unit 210. The module control unit 240 may output, to an external apparatus, the information related to the battery characteristic of the electric storage unit 210. The external apparatus can thereby use the information related to the battery characteristic of the electric storage unit 210. Examples of the external apparatus may include the load device 20 and the charging device 14. The external apparatus may be an output device that outputs information to a user.

The module control unit 240 may be realized by hardware or software. Furthermore, it may be realized by a combination of hardware and software. In one embodiment, the module control unit 240 may be realized by an analog circuit, a digital circuit, or a combination of an analog circuit and a digital circuit. In another embodiment, in a general information processing device provided with a data processing device and the like having a CPU, a ROM, a RAM, a communication interface, and the like, the module control unit 240 may be realized by executing a program for controlling the module control unit 240.

The programs installed into a computer to cause the computer to function as part of the module control unit 240 according to the present embodiment may include modules that define operations of the respective units of the module control unit 240. These programs or modules cooperate with CPU or the like to cause the computer to function as the respective units of the module control unit 240.

By being read by the computer, the information processing described in these programs functions as specific means as a result of the software and the above-described various types of hardware resources cooperating with each other. By realizing computation or processing of information to meet the intended use of the computer in the present embodiment by these specific means, a specific device to meet the intended use can be constructed. The programs may be stored on a computer-readable medium or a storage device connected to a network. The computer-readable medium may be a non-transitory computer-readable medium.

The protecting unit 250 protects the electric storage unit 210. In the present embodiment, the protecting unit 250 protects the electric storage unit 210 from overcharge and over discharge. When the protecting unit 250 has detected that the inter-terminal voltage of the electric storage cell 222 or the inter-terminal voltage of the electric storage cell 224 is not in the predetermined range, the protecting unit 250 transmits, to the module control unit 240, a signal indicating the content of the detection. The protecting unit 250 may transmit, to the system control unit 140, the information related to the inter-terminal voltage of the electric storage unit 210. The protecting unit 250 may be realized by hardware, realized by software, or realized by a combination of hardware and software. The protecting unit 250 may be realized by an analog circuit, a digital circuit, or a combination of an analog circuit and a digital circuit.

The balance correcting unit 260 equalizes the voltage of the plurality of electric storage cells. The operating principle of the balance correcting unit 260 is not particularly limited, and an optional balance correcting device can be used. If the electric storage unit 210 has three or more electric storage cells, the electric storage module 110 may have a plurality of balance correcting units 260. For example, if the electric storage unit 210 has n (n is an integer equal to or greater than 2) electric storage cells, the electric storage module 110 has n−1 balance correcting unit(s) 260.

The balance correcting unit 260 may be realized by hardware, realized by software, or realized by a combination of hardware and software. The balance correcting unit 260 may be realized by an analog circuit, a digital circuit, or a combination of an analog circuit and a digital circuit. In an embodiment, the balance correcting unit 260 is an active-type balance correcting device. The active-type balance correcting unit may be a balance correcting unit that transfers electric charges between two electric storage cells via an inductor as described in JP 2006-067742 A. In addition, the active-type balance correcting unit may be a balance correcting unit that transfers electric charges via a capacitor as described in JP 2012-210109 A. In another embodiment, the balance correcting unit 260 may be a passive-type balance correcting device. The passive-type balance correcting device releases extra electric charges by using an external resistor, for example.

As described above, in the present embodiment, the electric storage unit 210 has the two electric storage cells connected in series. However, the electric storage unit 210 is not limited to the present embodiment. In another embodiment, the electric storage unit 210 may also have three or more electric storage cells connected in series. In addition, the electric storage unit 210 may have a plurality of electric storage cells connected in parallel or a plurality of electric storage cells connected in a matrix.

The electric storage unit 210 of the electric storage module 110 may be an example of the second electric storage unit. The switching unit 230 of the electric storage module 110 may be an example of the second switching unit. The electric storage cell 222 and the electric storage cell 224 of the electric storage module 110 may be an example of the second type of secondary battery.

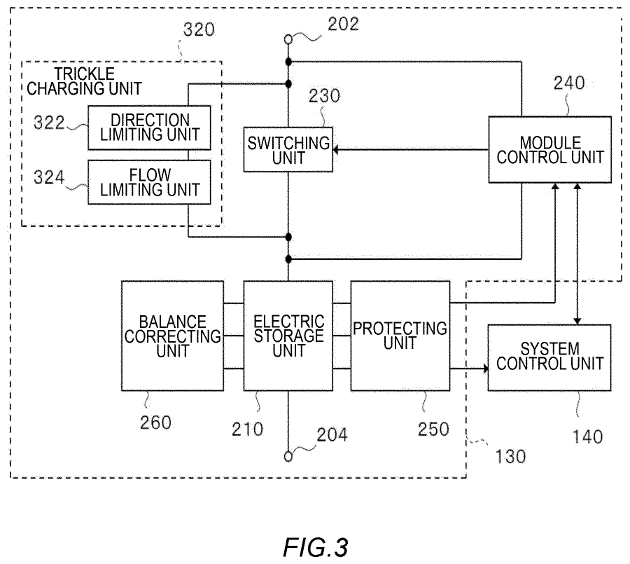

FIG. 3 schematically shows an example of a system configuration of the electric storage module 130. In the present embodiment, the electric storage module 130 is different from the electric storage module 110 in that each of a plurality of energy storage cells constituting the electric storage unit 210 is formed of a secondary battery of a type capable of supporting trickle charging, and the electric storage module 130 includes a trickle charging unit 320. The electric storage module 130 may have the same feature as the corresponding configuration of the electric storage module 110 with respect to the configuration other than the above-mentioned difference.

In the present embodiment, the trickle charging unit 320 includes a direction limiting unit 322 and a flow limiting unit 324. The trickle charging unit 320 is connected in parallel with the switching unit 230 between the wiring 106 of the electric storage system 100 and the electric storage unit 210 of the electric storage module 130. The trickle charging unit 320 may have a larger resistance than the switching unit 230. That is, the resistance value when the current flows through the trickle charging unit 320 between the wiring 106 and the electric storage unit 210 is greater than the resistance value when the current flows through the switching unit 230.

In the present embodiment, the trickle charging unit 320 allows a current to pass in a direction from the wiring 106 toward the electric storage unit 210. On the other hand, the trickle charging unit 320 suppresses a current from passing in a direction from the electric storage unit 210 toward the wiring 106. For example, the trickle charging unit 320 does not allow a current to pass in a direction from the electric storage unit 210 toward the wiring 106.

In the present embodiment, the flow limiting unit 324 limits the amount of current flowing through the trickle charging unit 320. The flow limiting unit 324 may have a larger resistance than the switching unit 230. The flow limiting unit 324 may have at least one of a fixed resistor, a variable resistor, a constant current circuit, and a constant power circuit. The flow limiting unit 324 may include a PTC thermistor. When a current flows through the flow limiting unit 324 while the trickle charging of the electric storage unit 210 is performed, the flow limiting unit 324 may generate heat. Even in this case, according to the present embodiment, since the flow limiting unit 324 includes the PTC thermistor, when the temperature of the flow limiting unit 324 increases, the amount of current flowing through the flow limiting unit 324 decreases. As a result, while trickle charging of the electric storage unit 210 is performed, the temperature of the flow limiting unit 324 can be maintained within a predetermined numerical range.

In the present embodiment, the direction limiting unit 322 is connected in series with the flow limiting unit 324. The direction limiting unit 322 allows a current to pass in a direction from the wiring 106 toward the electric storage unit 210. On the other hand, the direction limiting unit 322 does not allow a current to pass in a direction from the electric storage unit 210 toward the wiring 106. The direction limiting unit 322 may have a diode. The diode may be disposed such that the direction from the wiring 106 toward the electric storage unit 210 is the forward direction.

The electric storage unit 210 of the electric storage module 130 may be an example of the first electric storage unit. The switching unit 230 of the electric storage module 130 may be an example of the first switching unit. The electric storage cell 222 and the electric storage cell 224 of the electric storage module 130 may be an example of the first type of secondary battery. The trickle charging unit 320 may be an example of a limiting unit. The direction limiting unit 322 may be an example of a current direction limiting unit. The flow limiting unit 324 may be an example of a current amount limiting unit.

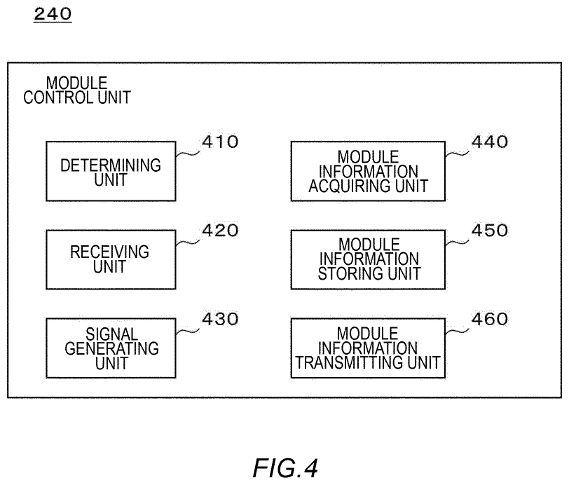

FIG. 4 schematically shows an example of a system configuration of the module control unit 240. In the present embodiment, the module control unit 240 includes a determining unit 410, a receiving unit 420, and a signal generating unit 430. The module control unit 240 may include a module information acquiring unit 440, a module information storing unit 450, and a module information transmitting unit 460. The receiving unit 420 may be an example of a first signal receiving unit, a second signal receiving unit, and a third signal receiving unit. The module information acquiring unit 440 may be an example of a battery characteristic acquiring unit.

In the present embodiment, a case where the module control unit 240 includes the module information acquiring unit 440, the module information storing unit 450, and the module information transmitting unit 460 will be described. However, the electric storage system 100 is not limited to the present embodiment. In another embodiment, the system control unit 140 may include at least one of the module information acquiring unit 440, the module information storing unit 450, and the module information transmitting unit 460.

The determining unit 410 determines whether the inter-terminal voltage of the switching unit 230 is within a predetermined range. The determining unit 410 transmits a signal indicating the determination result to the signal generating unit 430. The determining unit 410 may be an optional comparator or a comparator circuit. The determining unit 410 may be a window comparator.

The receiving unit 420 receives at least one of a signal from the system control unit 140, a signal from the protecting unit 250, and an instruction from the user. The receiving unit 420 transmits a signal corresponding to the received information to the signal generating unit 430.

The signal generating unit 430 receives a signal from at least one of the determining unit 410 and the receiving unit 420. The signal generating unit 430 generates a signal for controlling the switching unit 230 based on the received information. The signal generating unit 430 transmits the generated signal to the switching unit 230.

In one embodiment, when the determining unit 410 determines that the inter-terminal voltage of the switching unit 230 is within a predetermined range, the signal generating unit 430 generates a signal for turning on the switching element of the switching unit 230. In another embodiment, when the determining unit 410 determines that the inter-terminal voltage of the switching unit 230 is not within the predetermined range, the signal generating unit 430 generates a signal for turning off the switching element of the switching unit 230.

The signal generating unit 430 may generate or transmit a signal after a predetermined time has elapsed since the determining unit 410 determines whether the inter-terminal voltage of the switching unit 230 is within a predetermined range. Accordingly, malfunction due to noise or the like can be prevented. In addition, it is possible to prevent the electric storage unit 210 and the wiring 106 from being electrically connected immediately after the electric storage module 110 is mounted on the electric storage system 100.

In the present embodiment, the signal generating unit 430 generates a signal for controlling the switching element of the switching unit 230 based on the signal received by the receiving unit 420. In one embodiment, when the receiving unit 420 receives a signal for turning on the switching element of the switching unit 230 from the system control unit 140, the signal generating unit 430 generates a signal for turning on the switching element of the switching unit 230.

In another embodiment, when the receiving unit 420 receives a signal for turning off the switching element of the switching unit 230 from the protecting unit 250, the signal generating unit 430 generates a signal for turning off the switching element of the switching unit 230. In still another embodiment, when the receiving unit 420 receives a user's instruction, the signal generating unit 430 generates a signal for operating the switching element of the switching unit 230 according to the user's instruction.

In the present embodiment, the module information acquiring unit 440 acquires information related to the battery characteristics of the electric storage unit 210. The module information acquiring unit 440 may acquire information on the battery characteristics of the electric storage unit 210 by measuring the battery characteristics of the electric storage unit 210. The module information acquiring unit 440 may acquire information related to the battery characteristics of the electric storage unit 210 input by a manufacturer, a seller, or the like at the time of shipment, inspection, or sales.

The module information acquiring unit 440 may store information related to the battery characteristics of the electric storage unit 210 in the module information storing unit 450. A specific configuration of the module information acquiring unit 440 is not particularly limited, but the module information acquiring unit 440 may be a controller that controls reading and writing of data in the module information storing unit 450. In the present embodiment, the module information storing unit 450 stores information related to the battery characteristics of the electric storage unit 210 acquired by the module information acquiring unit 440.

In the present embodiment, the module information transmitting unit 460 transmits the information related to the battery characteristics of the electric storage unit 210 acquired by the module information acquiring unit 440 to the system control unit 140. The module information transmitting unit 460 may transmit the information related to the battery characteristics of the electric storage unit 210 acquired by the module information acquiring unit 440 to an external apparatus. The module information transmitting unit 460 may transmit the information related to the battery characteristics of the electric storage unit 210 in response to a request from an external apparatus, or may transmit the information related to the battery characteristics of the electric storage unit 210 at a predetermined timing. The module information transmitting unit 460 may refer to the module information storing unit 450 to transmit the information related to the battery characteristics of the electric storage unit 210 to the system control unit 140 or an external apparatus.

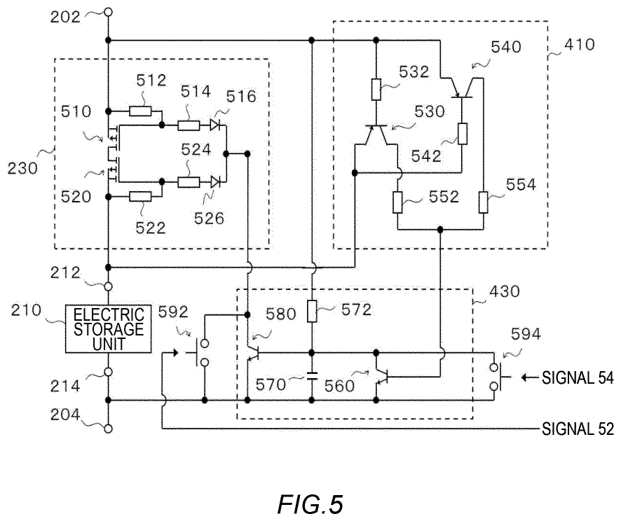

FIG. 5 schematically shows an example of a circuit configuration of the electric storage module 110. Note that, for the purpose of simplifying the description, the protecting unit 250 and the wiring related to the protecting unit 250 are not shown in FIG. 5.

In the present embodiment, the switching unit 230 includes a transistor 510, a resistor 512, a resistor 514, a diode 516, a transistor 520, a resistor 522, a resistor 524, and a diode 526. The transistor 510 and the transistor 520 may be examples of the switching element. As described in the present embodiment, the transistor 510 and the transistor 520 are used as the switching elements of the switching unit 230. However, the switching element of the switching unit 230 is not limited to the present embodiment. In another embodiment, a single switching element may be used as the switching element of the switching unit 230.

In the present embodiment, the module control unit 240 includes a determining unit 410, a signal generating unit 430, a switch 592, and a switch 594. In the present embodiment, the determining unit 410 includes a transistor 530, a resistor 532, a transistor 540, a resistor 542, a resistor 552, and a resistor 554. The signal generating unit 430 includes a transistor 560, a capacitor 570, a resistor 572, and a transistor 580. The switch 592 and the switch 594 may be an example of the receiving unit 420.

Then, the detail of each unit of the switching unit 230 and the module control unit 240 will be described. In the switching unit 230 of the present embodiment, the transistor 510 is a MOSFET, and even if the transistor 510 is in the OFF state, the current may flow from the positive terminal 212 to the positive terminal 202 due to a parasitic diode (not shown in the drawing) equivalently formed between the source and drain of the transistor 510. Similarly, the transistor 520 is a MOSFET, and even if the transistor 520 is in the OFF state, the current may flow from the positive terminal 202 to the positive terminal 212 due to a parasitic diode (not shown in the drawing) equivalently formed between the source and drain of the transistor 520.

In the present embodiment, the transistor 510 and the transistor 520 are set to the OFF state at the initial setting. If the transistor 580 is turned on when the electric storage system 100 is charged, the current flows from the positive terminal 202 to the negative terminal 204 via the resistor 512, the resistor 514, and the transistor 580. As a result, the voltage is applied to the gate of the transistor 510, and the transistor 510 is turned on. The current is thereby allowed to flow from the positive terminal 202 to the positive terminal 212 via the parasitic diode equivalently formed between the source and drain of the transistor 520.

On the other hand, if the transistor 580 is turned on when the electric storage system 100 is discharged, the current flows from the positive terminal 212 to the negative terminal 214 via the resistor 522, the resistor 524, and the transistor 580. As a result, the voltage is applied to the gate of the transistor 520, and the transistor 520 is turned on. The current is thereby allowed to flow from the positive terminal 212 to the positive terminal 202 via the parasitic diode equivalently formed between the source and drain of the transistor 510.

The voltage that is applied to the gate of the transistor 510 or the gate of the transistor 520, with the transistor 580 turned on, may be an example of a signal for turning on the switching element of the switching unit 230. Similarly, the voltage that is applied to the gate of the transistor 510 or the gate of the transistor 520, with the transistor 580 turned off, may be an example of a signal for turning off the switching element of the switching unit 230.

In the present embodiment, the values of the resistor 512 and the resistor 514 are set such that the transistor 510 can certainly be turned on and off in a power saving manner. In addition, the values of the resistor 522 and the resistor 524 are set such that the transistor 520 can certainly be turned on and off in a power saving manner.

In the present embodiment, the diode 516 is arranged between the resistor 514 and the resistor 524. The diode 516 allows the current to flow in a direction from the resistor 514 toward the resistor 524 but does not allow the current to flow in a direction from the resistor 524 toward the resistor 514. By providing the diode 516, the current can be prevented from leaking from the positive terminal 212 to the positive terminal 202 through the route of the resistor 522, the resistor 524, the resistor 514, and the resistor 512 when the switching unit 230 electrically disconnects the positive terminal 202 and the positive terminal 212.

In the present embodiment, the diode 526 is arranged between the resistor 514 and the resistor 524. The diode 526 allows the current to flow in the direction from the resistor 524 toward the resistor 514 but does not allow the current to flow in the direction from the resistor 514 toward the resistor 524. By providing the diode 526, the current can be prevented from leaking from the positive terminal 202 to the positive terminal 212 through the route of the resistor 512, the resistor 514, the resistor 524, and the resistor 522 when the switching unit 230 electrically disconnects the positive terminal 202 and the positive terminal 212.

In the module control unit 240 of the present embodiment, the transistor 530 and the transistor 540 of the determining unit 410 are set to OFF in the initial setting. In addition, the transistor 560 and the transistor 580 of the signal generating unit 430 are set to OFF in the initial setting.

According to the present embodiment, if the inter-terminal voltage of the switching unit 230 is less than a first value, which is predetermined such that the positive terminal 202 side is set positive, the value of the resistor 532 is set such that the transistor 530 is turned on. The value of the resistor 532 is preferably set such that the current that leaks when the switching unit 230 is in the OFF state becomes very small. In addition, the value of the resistor 542 is set such that the transistor 540 is turned on if the inter-terminal voltage of the switching unit 230 is greater than a predetermined second value. The value of the resistor 542 is preferably set such that the current that leaks when the switching unit 230 is in the OFF state becomes very small. Note that, according to the present embodiment, the inter-terminal voltage of the switching unit 230 is equal to the voltage difference between the positive terminal 202 and the positive terminal 212.

If the inter-terminal voltage of the switching unit 230 is less than the predetermined first value, the transistor 530 is turned on, and the voltage is applied from the electric storage unit 210 to the base of the transistor 560 via the positive terminal 212, transistor 530, and the resistor 552. Accordingly, the transistor 560 is turned on. Although the voltage from the positive terminal 202 is applied to the base of the transistor 580, the transistor 580 is prevented from being turned on while the transistor 560 is turned on. As a result, the transistor 580 is turned off.

On the other hand, if the inter-terminal voltage of the switching unit 230 is greater than the predetermined the second value, the transistor 540 is turned on, and the voltage is applied from the positive terminal 202 to the base of the transistor 560 via the transistor 540 and the resistor 554. Accordingly, the transistor 560 is turned on. As a result, the transistor 580 is turned off.

In the present embodiment, the value of the resistor 552 is set such that the power consumption can be reduced to the extent that the transistor 560 can be turned on when the transistor 530 is in the ON state. The value of the resistor 554 is set such that the power consumption can be reduced to the extent that the transistor 560 can be turned on when the transistor 540 is in the ON state.

The capacity of the capacitor 570 is set such that the transistor 560 is turned on before the voltage from the positive terminal 202 is applied to the base of the transistor 580 and the transistor 580 is turned on. The signal generating unit 430 can thereby generate a signal subsequent to the passage of a predetermined amount of time after the determining unit 410 determines whether or not the inter-terminal voltage of the switching element is within the predetermined range.

In contrast, if the inter-terminal voltage of the switching unit 230 is in the range defined by the first value and the second value, the transistor 530 and the transistor 540 remain the OFF state, and the transistor 560 also remains the OFF state. Because of this, the voltage is applied from the positive terminal 202 to the base of the transistor 580 via the resistor 572, so that the transistor 580 is turned on.

The switch 592 and the switch 594 may be manual switches or switching elements such as relays, thyristors, and transistors. A signal 52 indicating that the switching unit 230 will be turned on may be input to the switch 592. A signal 54 indicating that the switching unit 230 will be turned off may be input to the switch 594.

If the switch 592 is turned on, the switching unit 230 can be turned on regardless of whether the transistor 580 is turned on or turned off. If the switch 594 is turned on, the transistor 580 can be turned off regardless of whether the transistor 560 is turned on or turned off. As a result, the switching unit 230 can be turned off.

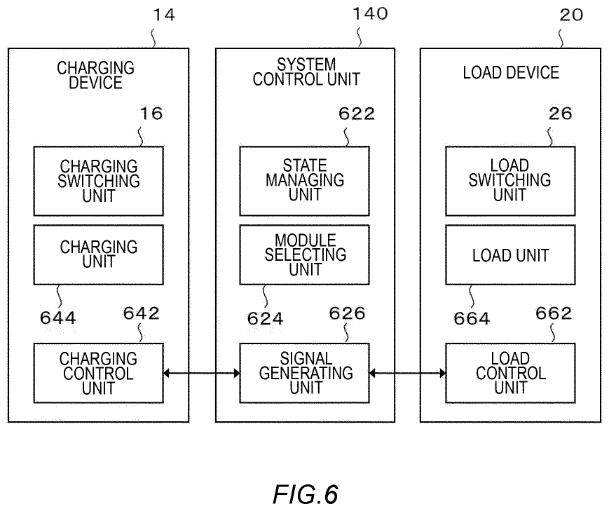

FIG. 6 schematically shows an example of a system configuration of the system control unit 140. An outline of information processing between the charging device 14, the load device 20, and the system control unit 140 will be described with reference to FIG. 6. In the present embodiment, the system control unit 140 includes a state managing unit 622, a module selecting unit 624, and a signal generating unit 626. In the present embodiment, the charging device 14 includes a charge switching unit 16, a charge control unit 642, and a charging unit 644. In the present embodiment, the load device 20 includes a load switching unit 26, a load control unit 662, and a load unit 664.

(Outline of Each Unit of System Control Unit 140)

In the present embodiment, the state managing unit 622 manages the state of the electric storage system 100. The state managing unit 622 may manage the states of the electric storage module 110 and the electric storage module 130. The state managing unit 622 may monitor the state of each of the electric storage module 110 and the electric storage module 130. The state managing unit 622 may monitor the electric storage module 110 and the electric storage module 130 to acquire the information on the battery characteristics of the electric storage module 110 and the electric storage module 130. The state managing unit 622 may transmit information obtained by monitoring the electric storage module 110 and the electric storage module 130 to an external apparatus.

The state managing unit 622 may measure the battery characteristics of each electric storage module while operating the electric storage system 100. When the battery characteristics of the electric storage module do not satisfy the predetermined condition, the state managing unit 622 may output information indicating that the performance of the electric storage module is insufficient to the output device that outputs the information to the user. The state managing unit 622 may output identification information of the electric storage module and information indicating that performance of the electric storage module is insufficient.

As a result, the user can easily determine the electric storage module having insufficient performance and replace the electric storage module. According to the present embodiment, for example, when the electric storage system 100 is constructed using the reused product of the electric storage module, at least a part of the inspection of the reused electric storage module can be omitted.

In one embodiment, when the electric storage system 100 shifts to the charge state, the module selecting unit 624 selects the electric storage module having the smallest inter-terminal voltage among the plurality of electric storage modules included in the electric storage system 100. For example, the module selecting unit 624 compares the inter-terminal voltage of the electric storage module 110 and the inter-terminal voltage of the electric storage module 130, and selects the electric storage module having the lower inter-terminal voltage. The module selecting unit 624 transmits a signal indicating the selected electric storage module to the signal generating unit 626.

In another embodiment, when the electric storage system 100 shifts to the discharge state, the module selecting unit 624 selects the electric storage module having the highest inter-terminal voltage from among the plurality of electric storage modules included in the electric storage system 100. For example, the module selecting unit 624 compares the inter-terminal voltage of the electric storage module 110 and the inter-terminal voltage of the electric storage module 130, and selects the electric storage module having the higher inter-terminal voltage. The module selecting unit 624 transmits a signal indicating the selected electric storage module to the signal generating unit 626.

In the present embodiment, the signal generating unit 626 generates a signal for turning on the switching element of the switching unit 230 of the electric storage module with respect to the electric storage module selected by the module selecting unit 624. The signal generating unit 626 transmits the generated signal to the module control unit 240. In another embodiment, the signal generating unit 626 may generate a signal for turning off the switching element of the switching unit 230 of the electric storage module with respect to the electric storage module selected by the module selecting unit 624.

In the present embodiment, the signal generating unit 626 may generate a signal for controlling the charging device 14. For example, the signal generating unit 626 generates a signal for adjusting a set value of at least one of the charging voltage and the charging current of the charging device 14. The signal generating unit 626 may transmit a signal for controlling the charging device 14 to the charging device 14. As a result, charging of the electric storage system 100 is controlled.

In the present embodiment, the signal generating unit 626 generates a signal for setting the charging voltage of the charging device 14. For example, the signal generating unit 626 acquires, from the state managing unit 622, information on the battery characteristics of each electric storage module mounted on the electric storage system 100. The signal generating unit 626 specifies the electric storage module having the largest charge end voltage among the electric storage modules mounted on the electric storage system 100 based on the information on the battery characteristics. The signal generating unit 626 determines whether or not the electric storage module having the largest charge end voltage supports trickle charging based on the information related to the battery characteristics.

When the electric storage module having the largest charge end voltage supports trickle charging, the signal generating unit 626 may generate a signal for setting the charging voltage of the charging device 14 to a value equal to or greater than the full charging voltage of the electric storage module or a value greater than the full charging voltage. On the other hand, when the electric storage module having the largest charge end voltage does not support trickle charging, the signal generating unit 626 may generate a signal for setting the charging voltage of the charging device 14 to a value equal to or greater than the charge end voltage of the electric storage module or a value greater than the charge end voltage.

As described above, even when the electric storage module capable of supporting trickle charging is included in the electric storage modules mounted on the electric storage system 100, whether or not trickle charging can be performed may depend on specifications of other electric storage modules. However, according to the present embodiment, when the electric storage module capable of supporting trickle charging is included in the electric storage modules mounted on the electric storage system 100, the trickle charging of the electric storage module can be reliably performed.

In the present embodiment, the signal generating unit 626 may generate a signal for controlling the operation of the charge switching unit 16. The signal generating unit 626 may transmit a signal for controlling the operation of the charge switching unit 16 to the charging device 14 or the charge switching unit 16. For example, the signal generating unit 626 generates a signal for controlling ON/OFF operation of the charge switching unit 16. As a result, for example, the electrical connection relationship between the charging device 14 and the electric storage system 100 is switched. In a case where the charge switching unit 16 has a function of adjusting the current amount, the signal generating unit 626 may generate a signal for controlling the current amount of the charging current. As a result, the current amount of the charging current can be controlled. Details of the control of the operation of the charge switching unit 16 will be described later.

In the present embodiment, the signal generating unit 626 may generate a signal for controlling the load device 20. For example, the signal generating unit 626 may generate a signal for adjusting the set value of the current consumption of the load device 20. As a result, discharging of the electric storage system 100 is controlled.

For example, the signal generating unit 626 generates a signal for controlling the load device 20 so that the current consumption of the load device 20 increases continuously or stepwise after the electric storage system 100 supplies power to the load device 20. As a result, the increase rate of the output current supplied from the power supply system 10 to the load device 20 can be controlled.

In the electric storage system 100 according to the present embodiment, when the decrease rate of the voltage (may be referred to as a line voltage, an output voltage, or the like) of the wiring 106 is greater than the operating speed of the switching unit 230, there is a possibility that the electric storage module mounted on the electric storage system 100 and the wiring 106 cannot be connected, and the power supply of the power supply system 10 becomes unstable. However, by controlling the increase rate of the output current supplied from the power supply system 10 to the load device 20 to a range that can be handled by the switching unit 230, the power supply system 10 can stably supply power.

In the present embodiment, the signal generating unit 626 may generate a signal for controlling the operation of the load switching unit 26. The signal generating unit 626 may transmit a signal for controlling the operation of the load switching unit 26 to the load device 20 or the load switching unit 26. For example, the signal generating unit 626 generates a signal for controlling ON/OFF operation of the load switching unit 26. As a result, the electrical connection relationship between the load device 20 and the electric storage system 100 is switched. In a case where the load switching unit 26 has a function of adjusting the current amount, the signal generating unit 626 may generate a signal for controlling the current amount of the load switching unit 26. As a result, the amount of discharge current (in some cases, also referred to as an output current) can be controlled. Details of the control of the operation of the load switching unit 26 will be described later.

In the present embodiment, the signal generating unit 626 may generate a signal for controlling the operation of an element or a circuit (not shown) for controlling at least one of the output voltage and the output current provided in the electric storage system 100. The signal generating unit 626 may transmit the above signal to the above element or circuit. For example, the signal generating unit 626 generates a signal for controlling the magnitude of at least one of the output voltage and the output current supplied from the power supply system 10 to the load device 20.

In one embodiment, the signal generating unit 626 receives a signal (may be referred to as a request signal) indicating the magnitude of the current to be supplied to the load device 20 from the load device 20. The signal generating unit 626 generates a signal for controlling the operation of the element or circuit so that a current having a magnitude indicated by the request signal is output. As a result, the output current supplied from the power supply system 10 to the load device 20 can be controlled. In another embodiment, the signal generating unit 626 may generate a signal for controlling the magnitude of the output current so that the output current increases continuously or stepwise after the electric storage system 100 starts power supply. As a result, the output current supplied from the power supply system 10 to the load device 20 can be controlled.

In the present embodiment, the signal generating unit 626 may generate a signal for controlling each electric storage module of the electric storage system 100. The signal generating unit 626 may transmit the signal to an electric storage module to be controlled by the signal. For example, the signal generating unit 626 generates a signal for giving notice of operation of the load device 20. A signal for notifying that the load device 20 is already in operation may be generated.

(Outline of Each Unit of Charging Device 14)

In the present embodiment, the charge control unit 642 controls the charging unit 644. Specifically, the charge control unit 642 controls the magnitude of at least one of the voltage (may be referred to as a charging voltage) and the current (may be referred to as a charging current) output from the charging unit 644. The charge control unit 642 may control a fluctuation rate of at least one of the charging voltage and the charging current.

The charge control unit 642 may receive a signal from the signal generating unit 626 of the system control unit 140 and control the charging unit 644 based on the signal. The charge control unit 642 may control the charging unit 644 according to an instruction input to an input device (not shown) by the user.

The charge control unit 642 may control a set value of the charging voltage of the charging unit 644. For example, the charge control unit 642 adjusts the set value of the charging voltage so that the charging voltage of the charging device 14 becomes greater than the full charging voltage of the electric storage module 130. As a result, the full charging voltage of the electric storage module 130 becomes less than the charging voltage of the charging device 14. As described above, in the present embodiment, the electric storage unit 210 of the electric storage module 130 supports trickle charging. The charge end voltage of the electric storage module 130 is the largest among the plurality of electric storage modules mounted on the electric storage system 100. Even in such a case, by setting the charging voltage of the charging device 14 as described above, the full charging voltage of the electric storage module 130 can be maintained by trickle charging after the voltage of the electric storage module 130 reaches the charge end voltage.

The charge control unit 642 may control a charging method of the charging unit 644. Examples of the charging method include a constant voltage charging method, a constant current charging method, a constant voltage constant current charging method, and a trickle charging method.

For example, the charge control unit 642 controls the charging unit 644 such that both the electric storage modules 110 and 130 are charged by the constant current charging method in at least a part of the charging period of the electric storage module 110 and the electric storage module 130. Subsequently, the charge control unit 642 may control the charging unit 644 so that the electric storage module 130 is charged by the constant voltage charging method. For example, the charge control unit 642 may control the charging unit 644 so that the electric storage module 110 is charged by the constant voltage charging method after the charging of the electric storage module 130 is completed. Further, after the voltage of the electric storage module 130 reaches the charge end voltage of the electric storage module 130, the charge control unit 642 may control the charging unit 644 so that the electric storage module 130 is charged by the trickle charging method.

Accordingly, when the voltage of the electric storage module 130 is equal to or less than the charge end voltage, the charging device 14 charges the electric storage module 130 by the constant current charging method or the constant voltage charging method. When the voltage of the electric storage module 130 is greater than the charge end voltage, the charging device 14 charges the electric storage module 130 by the trickle charging method.

In the present embodiment, the charging unit 644 receives power from a system power supply. In addition, the charging unit 644 supplies power to the electric storage system 100 via the charge switching unit 16. The charging unit 644 may output power with a current of a magnitude set by the charge control unit 642. The charging unit 644 may output power with a voltage of a magnitude set by the charge control unit 642.

(Outline of Each Unit of Load Device 20)

In the present embodiment, the load control unit 662 controls the load unit 664. Specifically, the load control unit 662 controls the magnitude of at least one of the voltage (may be referred to as a consumed voltage) and the current (may be referred to as current consumption) of the power consumed by the load unit 664. The load control unit 662 may control a fluctuation rate of at least one of the consumption voltage and the current consumption. For example, the load control unit 662 controls the load unit 664 so that the current consumption of the load device 20 increases continuously or stepwise after the electric storage system 100 supplies power to the load device 20.

The load control unit 662 may receive a signal from the signal generating unit 626 of the system control unit 140 and control the load unit 664 based on the signal. The load control unit 662 may control the load unit 664 in accordance with an instruction input to an input device (not shown) by the user.

The charge control unit 642 may be an example of a charging voltage control unit. The load control unit 662 may be an example of a current consumption control unit.

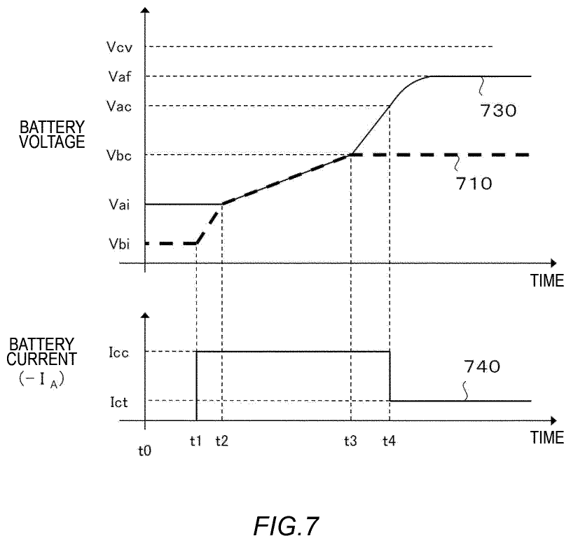

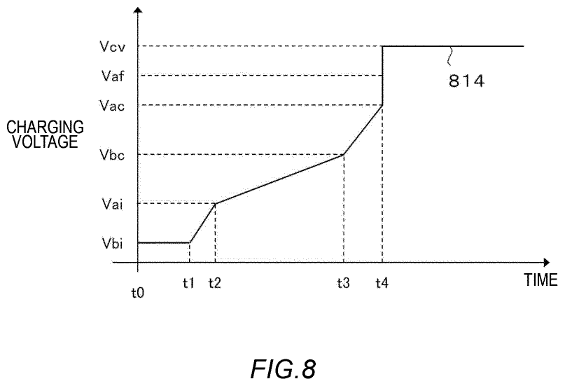

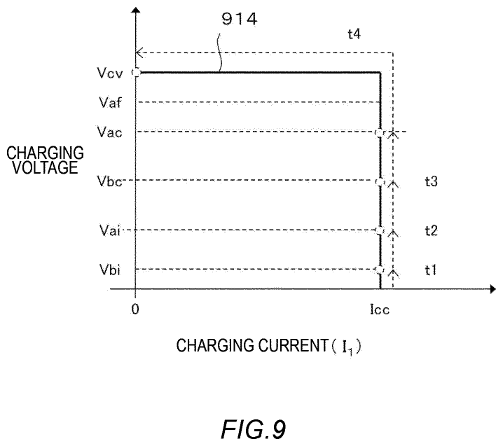

An outline of a charging operation of the electric storage system 100 will be described with reference to FIGS. 7, 8, and 9. FIG. 7 schematically shows an example of fluctuation 730 of the inter-terminal voltage of the electric storage module 110 and an example of fluctuation 710 of the inter-terminal voltage of the electric storage module 130 during the charging period of the electric storage module 130 and the electric storage module 110. FIG. 7 schematically shows an example of fluctuation 740 of the current passing through the electric storage unit 210 of the electric storage module 130. FIG. 8 schematically shows an example of fluctuation 814 of the charging voltage of the charging device 14. FIG. 9 schematically shows an example of the output characteristic 914 of the charging device 14.

As shown in FIG. 7, according to the present embodiment, charging of the electric storage system 100 is started at time t1. The maximum value of the charging voltage of the charging device 14 is set to Vcv. At the time when the charging of the electric storage system 100 is started at time t1, the inter-terminal voltages of the electric storage module 110 and the electric storage module 130 are Vai and Vbi, respectively. At this time, it is assumed that the electric storage unit 210 and the wiring 106 of the electric storage module 110 are electrically connected, and the electric storage unit 210 and the wiring 106 of the electric storage module 130 are electrically disconnected.

Subsequently, when the charging of the electric storage module 110 progresses and the inter-terminal voltage of the electric storage module 110 reaches Vai at time t2, the switching unit 230 of the electric storage module 130 is turned on, and the electric storage unit 210 of the electric storage module 130 and the wiring 106 are electrically connected.

Subsequently, when the charging of the electric storage module 110 and the electric storage module 130 progresses and the inter-terminal voltage of the electric storage module 110 reaches the charge end voltage Vbc of the electric storage module 110 at time t3, the protecting unit 250 of the electric storage module 110 detects overcharge and controls the switching unit 230, whereby the electric storage unit 210 and the wiring 106 of the electric storage module 110 are electrically disconnected.

Subsequently, when the charging of the electric storage module 130 progresses and the inter-terminal voltage of the electric storage module 130 reaches the charge end voltage Vac of the electric storage module 130 at time t4, the protecting unit 250 of the electric storage module 110 detects overcharge and controls the switching unit 230. Accordingly, the electric storage unit 210 and the wiring 106 of the electric storage module 130 are electrically disconnected.

At this time, as shown in FIG. 8, by electrically disconnecting the electric storage unit 210 and the wiring 106 of the electric storage module 130, the voltage of the wiring 106 becomes equal to the output voltage Vcv of the charging device 14. Further, as shown in FIG. 9, the charging current rapidly decreases due to the electrical disconnection of the electric storage unit 210 and the wiring 106 of the electric storage module 130.

Subsequently, trickle charging of the electric storage module 130 is performed. Accordingly, the inter-terminal voltage of the electric storage module 130 reaches full charging voltage Vaf of the electric storage module 130. In addition, the full charge state of the electric storage module 130 is maintained by trickle charging.

The charging operation described with reference to FIGS. 7, 8, and 9 may be controlled by the charge control unit 642. The charging operation described with reference to FIGS. 7, 8, and 9 may be performed by the system control unit 140 controlling the charge control unit 642.

(Electric Storage Module Having Interlock Mechanism)

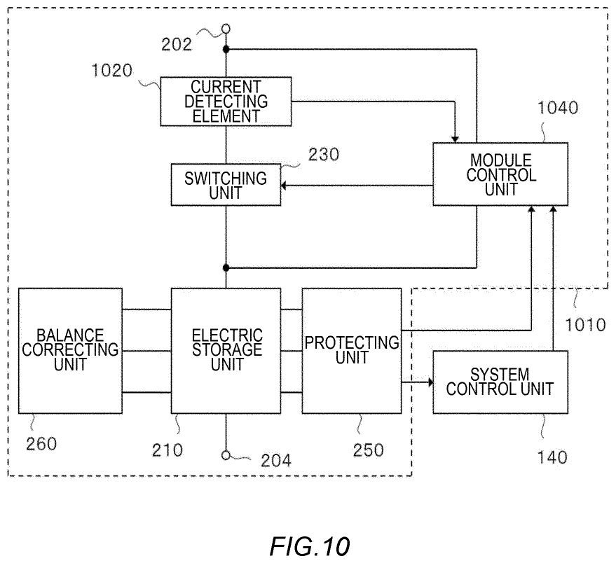

Next, another example of the electric storage module 110 will be described with reference to FIGS. 10, 11, and 12. The matters described for the electric storage module 110 and each unit thereof may be applied to other examples of the electric storage module 110 and each unit thereof unless a technical contradiction occurs. In addition, the matters described for other examples of the electric storage module 110 and each unit thereof may be applied to the electric storage module 110 and each unit thereof. In the description of FIGS. 10 to 12, the description of the matters described for each unit of the electric storage module 110 may be omitted.

FIG. 10 schematically shows an example of a system configuration of the electric storage module 1010. In the present embodiment, the electric storage module 1010 includes a positive terminal 202, a negative terminal 204, and an electric storage unit 210. The electric storage module 1010 may include the switching unit 230. The electric storage module 1010 may include the protecting unit 250. The electric storage module 1010 may include the balance correcting unit 260. In the present embodiment, the electric storage module 1010 includes a current detecting element 1020 and a module control unit 1040.

In the present embodiment, the switching unit 230 adjusts the current flowing between the wire 106 and the electric storage unit 210. In an embodiment, the switching unit 230 electrically connects the wire 106 and the electric storage unit 210 or electrically disconnects the wire 106 and the electric storage unit 210. In another embodiment, the switching unit 230 increases or decreases the above described current by varying the resistance value of the path between the wire 106 and the electric storage unit 210, for example.

In the present embodiment, one end of the switching unit 230 is electrically connected to the wiring 106 via the positive terminal 202 and the current detecting element 1020. The other end of the switching unit 230 is electrically connected to the positive terminal 212 of the electric storage unit 210. The information indicating the inter-terminal voltage of the switching unit 230 may be used as the information indicating the difference between the potential of the wiring 106 or the voltage applied to the wiring 106 (may be simply referred to as voltage of the wiring 106) and potential of a terminal of the electric storage unit 210 (for example, the positive terminal 212) or voltage applied to the terminal (may be simply referred to as voltage of the electric storage unit 210, voltage of the terminal, or the like).

In an embodiment, the switching unit 230 adjusts at least the magnitude of the current flowing between the wiring 106 and the electric storage unit 210 in a direction from the positive terminal 212 of the electric storage unit 210 toward the positive terminal 202 (may be referred to as discharge direction). In another embodiment, the switching unit 230 adjusts at least the magnitude of the current flowing between the wiring 106 and the electric storage unit 210 in a direction from the positive terminal 202 toward the positive terminal 212 of the electric storage unit 210 (may be referred to as charge direction). In still another embodiment, the switching unit 230 adjusts the magnitude of the current flowing between the wiring 106 and the electric storage unit 210 in the discharge direction and the magnitude of the current flowing between the wiring 106 and the electric storage unit 210 in the charge direction.

In the present embodiment, the electric storage module 1010 differs from the electric storage module 110 in that the electric storage module 1010 includes the current detecting element 1020. The electric storage module 1010 differs from the electric storage module 110 in that the electric storage module 1010 includes the module control unit 1040 instead of the module control unit 240. With respect to the configuration other than the above described differences, the electric storage module 1010 may have the features similar to those of the corresponding configuration of the electric storage module 110.

In the present embodiment, the current detecting element 1020 is used for acquiring information indicating the current flowing between the wire 106 and the electric storage unit 210. Examples of the information indicating the current may include the presence or absence of the current, the magnitude of the current, and the direction of the current. In the present embodiment, the electric storage module 1010 acquires the information related to the current flowing between the wire 106 and the electric storage unit 210 by measuring the inter-terminal voltage of the current detecting element 1020.

In the present embodiment, the current detecting element 1020 is disposed between the positive terminal 202 and the switching unit 230. More specifically, one end of the current detecting element 1020 is electrically connected to the switching unit 230. The other end of the current detecting element 1020 is electrically connected to the wiring 106 via the positive terminal 202. The current detecting element 1020 may be disposed between the switching unit 230 and the positive terminal 212 of the electric storage unit 210. In addition, the switching unit 230 or a part of the elements constituting the switching unit 230 may be used as the current detecting element 1020.

The current detecting element 1020 may be an element having an optional resistance value, and its types are not particularly limited. For example, the current detecting element 1020 has an appropriate resistance value corresponding to the maximum allowable current of the electric storage unit 210. Examples of the current detecting element 1020 may include a resistor and a Hall sensor. A passive element or an active element having an appropriate resistance value may be used as the above described resistor.

In the present embodiment, the module control unit 1040 differs from the module control unit 240 in that the module control unit 1040 detects the current flowing between the wire 106 and the electric storage unit 210. In the present embodiment, the module control unit 1040 differs from the module control unit 240 in that the module control unit 1040 controls the operation of the switching unit 230 based on (i) the voltage or SOC of the electric storage unit 210 and (ii) the current flowing between the wire 106 and the electric storage unit 210. The module control unit 1040 may control the operation of the switching unit 230 based on (i) the voltage or SOC of the electric storage unit 210, (ii) the current flowing between the wire 106 and the electric storage unit 210, and (iii) the inter-terminal voltage of the switching unit 230. With respect to the configuration other than the above described differences, the module control unit 1040 may have the features similar to those of the corresponding configuration of the module control unit 240.

The methods by which the module control unit 1040 detects the current flowing between the wiring 106 and the electric storage unit 210 are not particularly limited. In the present embodiment, the module control unit 1040 acquires the information indicating the inter-terminal voltage of the current detecting element 1020 arranged between the positive terminal 202 and the positive terminal 212 and based on the information, detects the current flowing between the wiring 106 and the electric storage unit 210. The module control unit 1040 can thereby monitor the current flowing between the wiring 106 and the electric storage unit 210. The module control unit 1040 may determine the magnitude of the current flowing between the wiring 106 and the electric storage unit 210 and also determine the direction of the above described current.

In an embodiment, if the switching unit 230 adjusts or controls at least the magnitude of the current flowing between the wire 106 and the electric storage unit 210 in the discharge direction, the module control unit 1040 monitors or detects the current flowing between the wire 106 and the electric storage unit 210 in the charge direction. The module control unit 1040 may monitor or detect the current flowing between the wire 106 and the electric storage unit 210 if the switching unit 230 disconnects the electrical connection between the wire 106 and the electric storage unit 210 in the discharge direction (may be referred to as electrically disconnected in the discharge direction). Note that, in this case, the current detected by the module control unit 1040 is consequently the current flowing between the wire 106 and the electric storage unit 210 in the charge direction.

In another embodiment, if the switching unit 230 adjusts or controls at least the magnitude of the current flowing between the wire 106 and the electric storage unit 210 in the charge direction, the module control unit 1040 monitors or detects the current flowing between the wire 106 and the electric storage unit 210 in the discharge direction. The module control unit 1040 may monitor or detect the current flowing between the wire 106 and the electric storage unit 210 if the switching unit 230 disconnects the electrical connection between the wire 106 and the electric storage unit 210 in the charge direction (may be referred to as electrically disconnected in the charge direction). Note that, in this case, the current detected by the module control unit 1040 is consequently the current flowing between the wire 106 and the electric storage unit 210 in the discharge direction.

The methods by which the module control unit 1040 controls the operation of the switching unit 230 are not particularly limited. As described above, the module control unit 1040 detects the current flowing between the wire 106 and the electric storage unit 210. The module control unit 1040 may control the operation of the switching unit 230 based on the information indicating the current flowing between the wire 106 and the electric storage unit 210. The interlock of the switching unit 230 can thereby be safely released when the electric storage module 1010 is hot-swapped.

Similarly to the module control unit 240, the module control unit 1040 may acquire the information indicating the inter-terminal voltage of the switching unit 230. The module control unit 1040 may control the operation of the switching unit 230 based on the information indicating the inter-terminal voltage of the switching unit 230. The time required to hot-swap the electric storage module 1010 is thereby shortened.

Similarly to the module control unit 240, the module control unit 1040 may acquire from the protecting unit 250 the information acquired or generated by the protecting unit 250. For example, the module control unit 1040 acquires from the protecting unit 250 information such as information indicating that the function of protection against overcharge is enabled, information indicating that the function of protection against overcharge is not enabled, information indicating that function of protection against over discharge is enabled, and information indicating that the function of protection against over discharge is not enabled. The module control unit 1040 may control the operation of the switching unit 230 based on the information acquired or generated by the protecting unit 250. The switching unit 230 can thereby be appropriately controlled depending on the state of the electric storage unit 210.

For example, if the voltage or SOC of the electric storage unit 210 is less than the threshold for the protection against over discharge or equal to or less than the threshold, the function of protection against over discharge becomes enabled. If the voltage or SOC of the electric storage unit 210 is greater than the threshold for the protection against over discharge or equal to or greater than the threshold, the function of protection against over discharge becomes disabled. Also, for example, when the voltage or SOC of the electric storage unit 210 is greater than the threshold for the protection against overcharge or equal to or greater than the threshold, the function of protection against overcharge becomes enabled. If the voltage or SOC of the electric storage unit 210 is less than the threshold for the protection against overcharge or equal to or less than the threshold, the function of protection against overcharge becomes disabled.

Similarly to the module control unit 240, the module control unit 1040 may acquire from the system control unit 140 the information acquired or generated by the system control unit 140. For example, the module control unit 1040 acquires from the system control unit 140 the information indicating the battery characteristic of the electric storage unit 210. The module control unit 1040 may control the operation of the switching unit 230 based on the information acquired or generated by the system control unit 140. The switching unit 230 can thereby be appropriately controlled depending on the state of the electric storage unit 210.

Specific Examples of the Procedure for Controlling the Operation of the Switching Unit 230

In an embodiment, the module control unit 1040 controls the operation of the switching unit 230 based on the state of charge of the electric storage unit 210. In another embodiment, the module control unit 1040 controls the operation of the switching unit 230 based on the inter-terminal voltage of the switching unit 230. In still another embodiment, the module control unit 1040 controls the operation of the switching unit 230 based on the current flowing between the wire 106 and the electric storage unit 210. The module control unit 1040 may control the operation of the switching unit 230 based on at least one of the magnitude and the direction of the above described current.

More specifically, the module control unit 1040 controls the operation of the switching unit 230 based on (i) the voltage or SOC of the electric storage unit 210 and (ii) the current flowing between the wire 106 and the electric storage unit 210. The module control unit 1040 may control the operation of the switching unit 230 based on (i) the voltage or SOC of the electric storage unit 210, (ii) the current flowing between the wire 106 and the electric storage unit 210, and (iii) the inter-terminal voltage of the switching unit 230.

For example, if the voltage or SOC of the electric storage unit 210 satisfies the predetermined condition, the module control unit 1040 controls the switching unit 230 such that the switching unit 230 electrically connects the wire 106 and the electric storage unit 210. The voltage or SOC of the electric storage unit 210 may be an example of the battery characteristic of the electric storage unit 210. The predetermined condition may be a condition using a predetermined numerical range or threshold or may be a condition using a numerical range or threshold calculated in accordance with a predetermined procedure. The deterioration or damage of the electric storage unit 210 due to the overcharge or over discharge can thereby be prevented, for example.

The predetermined condition may be a condition for protecting the electric storage unit 210. Examples of the predetermined condition may include (i) a condition indicating that the voltage or SOC of the electric storage unit 210 is within a particular numerical range, (ii) a condition indicating that the voltage or SOC of the electric storage unit 210 is greater than a particular threshold or is equal to or greater than the particular threshold, (iii) a condition indicating that the voltage or SOC of the electric storage unit 210 is less than a particular threshold or is equal to or less than the particular threshold, and (v) a condition formed by a combination of these conditions.

The condition indicating that the voltage or SOC of the electric storage unit 210 is within the particular numerical range may be a condition indicating that at least one of a function of protection against overvoltage and the function of protection against over discharge of the electric storage module 1010 is not enabled. The condition indicating that the voltage or SOC of the electric storage unit 210 is within the particular numerical range may be a condition indicating that the function of protection against overvoltage and the function of protection against over discharge of the electric storage module 1010 is not enabled. The condition indicating that the voltage or SOC of the electric storage unit 210 is greater than the particular threshold or is equal to or greater than the particular threshold may be a condition indicating that the function of protection against over discharge of the electric storage module 1010 is not enabled. The condition indicating that the voltage or SOC of the electric storage unit 210 is less than the particular threshold or is equal to or less than the particular threshold may be a condition indicating that the function of protection against overcharge of the electric storage module 1010 is not enabled.

According to the present embodiment, the module control unit 1040 controls the switching unit 230 such that the switching unit 230 electrically connects the electric storage unit 210 and the wire 106 if the inter-terminal voltage of the switching unit 230 satisfies a predetermined condition. More specifically, if the difference between the voltage of the wire 106 and the voltage of the electric storage unit 210 is relatively large, the electric storage unit 210 and the wire 106 are electrically disconnected. On the other hand, if the above described difference is relatively small, the electric storage unit 210 and the wire 106 are electrically connected. The rapid hot-swap thereby becomes possible.

The predetermined condition may be a condition for realizing the rapid hot-swap. Examples of the predetermined condition may include (i) a condition indicating that the inter-terminal voltage of the switching unit 230 is within a particular numerical range, (ii) a condition indicating that the inter-terminal voltage of the switching unit 230 is greater than a particular threshold or is equal to or greater than the particular threshold, (iii) a condition indicating that the inter-terminal voltage of the switching unit 230 is less than a particular threshold or is equal to or less than the particular threshold, and (v) a condition formed by a combination of these conditions.

Specific Examples of the Procedure for Releasing the Interlock of the Protection Against Over Discharge

If the voltage or SOC of the electric storage unit 210, for example, becomes less than the threshold for the protection against over discharge when the electric storage system 100 is discharged, with the electric storage unit 210 of the electric storage module 1010 electrically connected to the wire 106 of the electric storage system 100, the protecting unit 250 transmits to the module control unit 1040 a signal for enabling the function of protection against over discharge. At this time, the current flows between the wire 106 and the electric storage unit 210 in the discharge direction. In this case, the discharge direction may be an example of a first direction. Also, the charge direction may be an example of a second direction. Note that, in the present embodiment, the discharge direction and the charge direction are opposite to each other.

The case in which the voltage or SOC of the electric storage unit 210 is less than the threshold for the protection against over discharge may be an example of the case in which the condition for protecting the electric storage unit 210 is not satisfied. In another embodiment, the protecting unit 250 may transmit to the module control unit 1040 the signal for enabling the function of protection against over discharge if the voltage or SOC of the electric storage unit 210 is equal to or less than the threshold for the protection against over discharge.

Upon receiving the above described signal, the module control unit 1040 controls the switching unit 230 and electrically disconnects the wire 106 and the electric storage unit 210. If the electric storage system 100 continues being discharged also after the wire 106 and the electric storage unit 210 are electrically disconnected, the voltage difference will be caused between the wire 106 and the electric storage unit 210.

After the discharge of the electric storage system 100 ends, and then, when the charge of the electric storage system 100 is started, a voltage difference is caused between the wire 106 and the electric storage unit 210. In this case, when an absolute value of the above described voltage difference is greater than the threshold for realizing the rapid hot-swap, the module control unit 1040 judges that the inter-terminal voltage of the switching unit 230 does not satisfy the condition for realizing the rapid hot-swap. As a result, the charge of the electric storage system 100 proceeds, with the electric storage unit 210 of the electric storage module 1010 and the wire 106 of the electric storage system 100 electrically disconnected.

On the other hand, (i) when the absolute value of the above described voltage difference at the time of starting the charge of the electric storage system 100 is less than the threshold for realizing the rapid hot-swap or equal to or less than the threshold, or (ii) when the charge of the electric storage system 100 proceeds, and the absolute value of the above described voltage difference has become less than the threshold for realizing the rapid hot-swap or becomes equal to or less than the threshold, the module control unit 1040 controls the switching unit 230 in an attempt to electrically connect the wire 106 and the electric storage unit 210. However, at this stage, the voltage or SOC of the electric storage unit 210 is less than the threshold for the protection against over discharge. Because of this, the interlock mechanism of the module control unit 1040 is actuated. As a result, the module control unit 1040 is unable to control the switching unit 230 and to electrically connect the wire 106 and the electric storage unit 210.

In order for the module control unit 1040 to control the switching unit 230 and electrically connect the wire 106 and the electric storage unit 210, the above described interlock needs to be released by some logic. Although the method for releasing the above described interlock is not particularly limited, in the present embodiment, the module control unit 1040 decides whether or not to release the above described interlock, based on the current flowing between the wire 106 and the electric storage unit 210 or based on the information related to the current, and controls the operation of the switching unit 230.

Here, as described in association with FIG. 5, the switching unit 230 includes the transistor 520 that adjusts or controls the magnitude of the current flowing between the wire 106 and the electric storage unit 210 in the discharge direction. Examples of the transistor 520 may include a Si-MOSFET, an insulated gate bipolar transistor (IGBT), a SiC-MOSFET, and a GaN-MOSFET.

If the rated voltage of the electric storage unit 210 is relatively high, the transistor 520 is preferably a SiC-MOSFET. For example, if the maximum value of the rated voltage of the electric storage unit 210 is equal to or greater than 100 V, preferably equal to or greater than 200 V, more preferably equal to or greater than 300 V, and is further more preferably equal to or greater than 500 V, and still more preferably equal to or greater than 800 V, and is even further more preferably 1000 V, a SiC-MOSFET is used as the transistor 520. The advantage of the SiC-MOSFET, namely having the superior breakdown voltage characteristics but allowing little loss, can thereby be sufficiently demonstrated. If the maximum value of the rated voltage of the electric storage unit 210 is equal to or greater than 300 V or equal to or greater than 500 V, the effect of using the SiC-MOSFET as the transistor 520 may become significant.

Also, a parasitic diode is formed between the source and drain of the transistor 520. The above described parasitic diode allows the passage of the current flowing between the wire 106 and the electric storage unit 210 in the charge direction. On the other hand, the above described parasitic diode suppresses the flow of the current between the wire 106 and the electric storage unit 210 in the discharge direction via the parasitic diode.

The transistor 520 may be an example of the first current adjusting unit or the second current adjusting unit. The parasitic diode of the transistor 520 may be an example of a first bypass unit or a second bypass unit. Note that, apart from the parasitic diode of the transistor 520, the switching unit 230 may include a rectifier that has a function similar to that of the parasitic diode and is connected in parallel with the transistor 520 between the wire 106 and the electric storage unit 210. Examples of the above described rectifier may include (i) a rectifying element such as a diode and (ii) a rectifying circuit configured with a plurality of elements.

As described above, according to the present embodiment, the switching unit 230 includes (i) the transistor 520 that adjusts the current in the discharge direction and (ii) the parasitic diode that is arranged in parallel with the transistor 520 and that allows the passage of the current in the charge direction but does not allow the passage of the current in the discharge direction. Because of this, when the charge of the electric storage system 100 further proceeds, and the voltage of the wire 106 becomes greater than the voltage of the positive terminal 212 of the electric storage unit 210, the current starts flowing between the wire 106 and the electric storage unit 210 in the charge direction via the parasitic diode of the transistor 520.

If the deterioration or damage of the electric storage unit 210 due to over discharge is to be prevented, the module control unit 1040 needs to prevent the flow of the current in the discharge direction but may not need to prevent the flow of the current in the charge direction. Here, according to the present embodiment, the module control unit 1040 monitors the current flowing between the wire 106 and the electric storage unit 210.

In an embodiment, the module control unit 1040 detects the current flowing between the wire 106 and the electric storage unit 210 in the charge direction. In another embodiment, the module control unit 1040 may detect the current flowing between the wire 106 and the electric storage unit 210 when the switching unit 230 electrically disconnects the wire 106 and the electric storage unit 210 in the discharge direction.

After the charge of the electric storage system 100 is started and until the above described current is detected, the module control unit 1040 maintains the interlock for the protection against over discharge. On the other hand, if the above described current has been detected, the module control unit 1040 releases the interlock for the protection against over discharge.

In an embodiment, the module control unit 1040 controls the switching unit 230 and electrically connects the wire 106 and the electric storage unit 210. In general, because the value of the ON-resistance of the transistor 520 is less than the resistance value of the parasitic diode, according to the present embodiment, the charge and discharge efficiency of the electric storage unit 210 is improved.

If the above described current has been detected in the state that the above described voltage difference does not satisfy the condition for realizing the rapid hot-swap, the module control unit 1040 may control the switching unit 230 such that the switching unit 230 electrically connects the wire 106 and the electric storage unit 210 at least until the above described voltage difference satisfies the condition for realizing the rapid hot-swap. Note that while the above described voltage difference satisfies the condition for realizing the rapid hot-swap, the module control unit 1040 may control the switching unit 230 such that the switching unit 230 electrically connects the wire 106 and the electric storage unit 210.

In another embodiment, if the above described current has been detected, the module control unit 1040 may transmit to the protecting unit 250 a signal for resetting the function of protection against over discharge. Then, upon receiving the signal for resetting the function of protection against over discharge, the protecting unit 250 may control the switching unit 230 and electrically connect the wire 106 and the electric storage unit 210.

If the charge of the electric storage system 100 further proceeds after the wire 106 and the electric storage unit 210 are electrically connected, the voltage or SOC of the electric storage unit 210 becomes greater than the threshold for the protection against over discharge. If the voltage or SOC of the electric storage unit 210 has become greater than the threshold for the protection against over discharge, the protecting unit 250 may transmit to the module control unit 1040 a signal for resetting the function of protection against over discharge. Upon receiving the signal for resetting the function of protection against over discharge, the module control unit 1040 may control the switching unit 230 such that the switching unit 230 electrically connects the electric storage unit 210 and the wire 106.

Note that, as described above, if it has been decided that the function of protection against over discharge is to be enabled, the module control unit 1040, for example, (i) electrically disconnects the wire 106 and the electric storage unit 210 or (ii) reduces the magnitude of the current that may flow between the wire 106 and the electric storage unit 210 in the discharge direction. If the function of protection against over discharge is enabled, the magnitude of the current that may flow in the discharge direction thereby becomes less than in a case in which the function of protection against over discharge is disabled. On the other hand, if it has been decided that the interlock of the protection against over discharge is to be released (may be referred to as disabling the function of protection against over discharge), the module control unit 1040, for example, (i) electrically connects the wire 106 and the electric storage unit 210 or (ii) increases the magnitude of the current that may flow between the wire 106 and the electric storage unit 210 in the discharge direction.

The module control unit 1040 adjusts or controls the magnitude of the current flowing between the wire 106 and the electric storage unit 210 in the discharge direction by adjusting the resistance value or the conduction ratio (may be referred to as duty ratio) of the switching unit 230. In an embodiment, if the switching unit 230 includes the transistor 520, and the transistor 520 is a field effect transistor, the module control unit 1040 can adjust or control the magnitude of the current flowing between the wire 106 and the electric storage unit 210 in the discharge direction by adjusting the gate voltage of the transistor 520 (may be referred to as input voltage). The module control unit 1040 may adjust or control the magnitude of the current flowing between the wire 106 and the electric storage unit 210 in the discharge direction by controlling the operation of the element(s) arranged in a circuit for adjusting the input voltage of the transistor 520.

In another embodiment, if the switching unit 230 includes the transistor 520, and the transistor 520 is a bipolar transistor, the module control unit 1040 can adjust or control the magnitude of the current flowing between the wire 106 and the electric storage unit 210 in the discharge direction by adjusting the base current of the transistor 520 (may be referred to as input current). The module control unit 1040 may adjust or control the magnitude of the current flowing between the wire 106 and the electric storage unit 210 in the discharge direction by controlling the operation of the element(s) arranged in the circuit for adjusting the input current of the transistor 520.

The resistance value or conduction ratio of the switching unit 230 in a case in which the function of protection against over discharge is enabled and the resistance value or conduction ratio of the switching unit 230 in a case in which the function of protection against over discharge is disabled may be the same or different. If the switching unit 230 has a switching element, the ON-resistance of the switching element in a case in which the function of protection against overcharge is enabled and the ON-resistance of the switching element in a case in which the function of protection against overcharge is disabled may be the same or different. If the switching unit 230 has a variable resistor, the resistance value of the variable resistor in the case in which the function of protection against overcharge is enabled and the resistance value of the variable resistor in the case in which the function of protection against overcharge is disabled may be the same or different. If the function of protection against over discharge is enabled, the module control unit 1040 may control the switching unit 230 such that the resistance value of the switching unit 230 becomes greater than in the case in which the function of protection against over discharge is disabled. If the function of protection against over discharge is enabled, the module control unit 1040 may control the switching unit 230 such that the conduction ratio of the switching unit 230 becomes less than in the case in which the function of protection against over discharge is disabled.

The above in the present embodiment has described, in order to simplify the description, a procedure in which the module control unit 1040 releases the interlock of the protection against over discharge, illustrating as an example the embodiment in which (i) if it has been decided that the function of protection against over discharge is to be enabled, the module control unit 1040 electrically disconnects the wire 106 and the electric storage unit 210 and (ii) if it has been decided that the function of protection against over discharge is to be disabled, the module control unit 1040 electrically connects the wire 106 and the electric storage unit 210. However, it should be understood by the person skilled in the art who has accessed the description of the present specification, that the module control unit 1040 may release the interlock of the protection against over discharge in a procedure similar to that of the present embodiment also in another embodiment in which (i) if it has been decided that the function of protection against over discharge is to be enabled, the module control unit 1040 reduces the magnitude of the current that may flow between the wire 106 and the electric storage unit 210 in the discharge direction and (ii) if it has been decided that the function of protection against over discharge is to be disabled, the module control unit 1040 increases the magnitude of the current that may flow between the wire 106 and the electric storage unit 210 in the discharge direction.

Specifically, if the function of protection against over discharge is to be enabled, in the present embodiment, a series of operations of the module control unit 1040 for electrically disconnecting the wire 106 and the electric storage unit 210 corresponds to a series of operations of the module control unit 1040 for reducing the current that may flow between the electric storage unit 210 and the wire 106 in the above described another embodiment. Similarly, if the function of protection against over discharge is to be disabled, in the present embodiment, a series of operations of the module control unit 1040 for electrically connecting the wire 106 and the electric storage unit 210 corresponds to a series of operations of the module control unit 1040 for increasing the current that may flow between the electric storage unit 210 and the wire 106 in the above described another embodiment.

Specific Examples of the Procedure for Releasing the Interlock of the Protection Against Overcharge

If the voltage or SOC of the electric storage unit 210, for example, becomes greater than the threshold for the protection against overcharge when the electric storage system 100 is charged, with the electric storage unit 210 of the electric storage module 1010 electrically connected to the wire 106 of the electric storage system 100, the protecting unit 250 transmits to the module control unit 1040 a signal for enabling the function of protection against overcharge. At this time, the current flows between the wire 106 and the electric storage unit 210 in the charge direction. In this case, the charge direction may be an example of the first direction. Also, the discharge direction may be an example of the second direction. Note that, in the present embodiment, the discharge direction and the charge direction are opposite to each other.

The case in which the voltage or SOC of the electric storage unit 210 is greater than the threshold for the protection against overcharge may be an example of the case in which the condition for protecting the electric storage unit 210 is not satisfied. In another embodiment, the protecting unit 250 may transmit to the module control unit 1040 the signal for enabling the function of protection against overcharge if the voltage or SOC of the electric storage unit 210 is equal to or greater than the threshold for the protection against over discharge.

Upon receiving the above described signal, the module control unit 1040 controls the switching unit 230 and electrically disconnects the wire 106 and the electric storage unit 210. If the electric storage system 100 continues being charged also after the wire 106 and the electric storage unit 210 are electrically disconnected, a voltage difference will be caused between the wire 106 and the electric storage unit 210.

After the charge of the electric storage system 100 ends, and then when the discharge of the electric storage system 100 is started, a voltage difference is caused between the wire 106 and the electric storage unit 210. In this case, when an absolute value of the above described voltage difference is greater than the threshold for realizing the rapid hot-swap, the module control unit 1040 judges that the inter-terminal voltage of the switching unit 230 does not satisfy the condition for realizing the rapid hot-swap. As a result, the discharge of the electric storage system 100 proceeds, with the electric storage unit 210 of the electric storage module 1010 and the wire 106 of the electric storage system 100 electrically disconnected.

On the other hand, (i) when the absolute value of the above described voltage difference at the time of starting the discharge of the electric storage system 100 is less than the threshold for realizing the rapid hot-swap or equal to or less than the threshold, or (ii) when the charge of the electric storage system 100 proceeds, and the absolute value of the above described voltage difference has become less than the threshold for realizing the rapid hot-swap or becomes equal to or less than the threshold, the module control unit 1040 controls the switching unit 230 in an attempt to electrically connect the wire 106 and the electric storage unit 210. However, at this stage, the voltage or SOC of the electric storage unit 210 is greater than the threshold for the protection against overcharge. Because of this, the interlock mechanism of the module control unit 1040 is actuated. As a result, the module control unit 1040 is unable to control the switching unit 230 and to electrically connect the wire 106 and the electric storage unit 210.

In order for the module control unit 1040 to control the switching unit 230 and electrically connect the wire 106 and the electric storage unit 210, the above described interlock needs to be released by some logic. Although the method for releasing the above described interlock is not particularly limited, in the present embodiment, the module control unit 1040 decides whether or not to release the above described interlock, based on the current flowing between the wire 106 and the electric storage unit 210 or based on the information related to the current, and controls the operation of the switching unit 230.

Here, as described in association with FIG. 5, the switching unit 230 includes the transistor 510 that adjusts or controls the magnitude of the current flowing between the wire 106 and the electric storage unit 210 in the charge direction. Examples of the transistor 510 may include a Si-MOSFET, an insulated gate bipolar transistor (IGBT), a SiC-MOSFET, and a GaN-MOSFET.

If the rated voltage of the electric storage unit 210 is relatively high, the transistor 510 is preferably a SiC-MOSFET. For example, if the maximum value of the rated voltage of the electric storage unit 210 is equal to or greater than 100 V, preferably equal to or greater than 200 V, more preferably equal to or greater than 300 V, further more preferably equal to or greater than 500 V, still further more preferably equal to or greater than 800 V, and is even further more preferably 1000 V, a SiC-MOSFET is used as the transistor 510. The advantage of the SiC-MOSFET, namely having the superior breakdown voltage characteristics but allowing little loss, can thereby be sufficiently demonstrated. If the maximum value of the rated voltage of the electric storage unit 210 is equal to or greater than 300 V or equal to or greater than 500 V, the effect of using the SiC-MOSFET as the transistor 510 may become significant.

Also, a parasitic diode is formed between the source and drain of the transistor 510. The above described parasitic diode allows the passage of the current flowing between the wire 106 and the electric storage unit 210 in the discharge direction. On the other hand, the above described parasitic diode suppresses the flow of the current between the wire 106 and the electric storage unit 210 in the charge direction via the parasitic diode.

The transistor 510 may be an example of the first current adjusting unit or the second current adjusting unit. The parasitic diode of the transistor 510 may be an example of the first bypass unit or the second bypass unit. Note that, apart from the parasitic diode of the transistor 510, the switching unit 230 may include a rectifier that has a function similar to that of the parasitic diode and is connected in parallel with the transistor 510 between the wire 106 and the electric storage unit 210. Examples of the above described rectifier may include (i) a rectifying element such as a diode and (ii) a rectifying circuit configured with a plurality of elements.

As described above, according to the present embodiment, the switching unit 230 includes (i) the transistor 510 that adjusts the current in the charge direction and (ii) the parasitic diode that is arranged in parallel with the transistor 510 and that allows the passage of the current in the discharge direction but does not allow the passage of the current in the charge direction. Because of this, when the discharge of the electric storage system 100 further proceeds, and the voltage of the wire 106 becomes less than the voltage of the positive terminal 212 of the electric storage unit 210, the current starts flowing between the wire 106 and the electric storage unit 210 in the discharge direction via the parasitic diode of transistor 510.

If the deterioration or damage of the electric storage unit 210 due to the overcharge is to be prevented, the module control unit 1040 needs to prevent the flow of the current in the charge direction but may not need to prevent the flow of the current in the discharge direction. Here, according to the present embodiment, the module control unit 1040 monitors the current flowing between the wire 106 and the electric storage unit 210.

In an embodiment, the module control unit 1040 detects the current flowing between the wire 106 and the electric storage unit 210 in the discharge direction. In another embodiment, the module control unit 1040 may detect the current flowing between the wire 106 and the electric storage unit 210 when the switching unit 230 electrically disconnects the wire 106 and the electric storage unit 210 in the charge direction.

After the discharge of the electric storage system 100 is started and until the above described current has been detected, the module control unit 1040 maintains the interlock for the protection against overcharge. On the other hand, if the above described current has been detected, the module control unit 1040 releases the interlock for the protection against overcharge.

In an embodiment, the module control unit 1040 controls the switching unit 230 and electrically connects the wire 106 and the electric storage unit 210. In general, because the value of the ON-resistance of the transistor 510 is less than the resistance value of the parasitic diode, according to the present embodiment, the charge and discharge efficiency of the electric storage unit 210 is improved.

If the above described current has been detected in the state that the above described voltage difference does not satisfy the condition for realizing the rapid hot-swap, the module control unit 1040 may control the switching unit 230 such that the switching unit 230 electrically connects the wire 106 and the electric storage unit 210 at least until the above described voltage difference satisfies the condition for realizing the rapid hot-swap. Note that, while the above described voltage difference satisfies the condition for realizing the rapid hot-swap, the module control unit 1040 may control the switching unit 230 such that the switching unit 230 electrically connects the wire 106 and the electric storage unit 210.

In another embodiment, if the above described current has been detected, the module control unit 1040 may transmit to the protecting unit 250 a signal for resetting the function of protection against overcharge. Then, upon receiving the signal for resetting the function of protection against overcharge, the protecting unit 250 may control the switching unit 230 and electrically connect the wire 106 and the electric storage unit 210.

If the discharge of the electric storage system 100 further proceeds after the wire 106 and the electric storage unit 210 have been electrically connected, the voltage or SOC of the electric storage unit 210 becomes less than the threshold for the protection against overcharge. If the voltage or SOC of the electric storage unit 210 has become less than the threshold for the protection against overcharge, the protecting unit 250 may transmit to the module control unit 1040 a signal for resetting the function of protection against overcharge. Upon receiving the signal for resetting the function of protection against overcharge, the module control unit 1040 may control the switching unit 230 such that the switching unit 230 electrically connects the electric storage unit 210 and the wire 106.

Note that, as described above, if it has been decided that the function of protection against overcharge is to be enabled, the module control unit 1040, for example, (i) electrically disconnects the wire 106 and the electric storage unit 210 or (ii) reduces the magnitude of the current that may flow between the wire 106 and the electric storage unit 210 in the charge direction. If the function of protection against overcharge is enabled, the magnitude of the current that may flow in the charge direction thereby becomes less than in a case in which the function of protection against overcharge is disabled. On the other hand, if it has been decided that the interlock of the protection against overcharge is to be released (may be referred to as disabling the function of protection against overcharge), the module control unit 1040, for example, (i) electrically connects the wire 106 and the electric storage unit 210 or (ii) increases the magnitude of the current that may flow between the wire 106 and the electric storage unit 210 in the charge direction.

The module control unit 1040 adjusts or controls the magnitude of the current flowing between the wire 106 and the electric storage unit 210 in the charge direction by adjusting the resistance value or the conduction ratio of the switching unit 230 (may be referred to as duty ratio). In an embodiment, if the switching unit 230 includes the transistor 510, and the transistor 510 is a field effect transistor, the module control unit 1040 can adjust or control the magnitude of the current flowing between the wire 106 and the electric storage unit 210 in the charge direction by adjusting the gate voltage of the transistor 510 (may be referred to as input voltage). The module control unit 1040 may adjust or control the magnitude of the current flowing between the wire 106 and the electric storage unit 210 in the charge direction by controlling the operation of the element(s) arranged in a circuit for adjusting the input voltage of the transistor 510.

In another embodiment, if the switching unit 230 includes the transistor 510, and the transistor 510 is a bipolar transistor, the module control unit 1040 can adjust or control the magnitude of the current flowing between the wire 106 and the electric storage unit 210 in the charge direction by adjusting the base current of the transistor 510 (may be referred to as input current). The module control unit 1040 may adjust or control the magnitude of the current flowing between the wire 106 and the electric storage unit 210 in the charge direction by controlling the operation of the element(s) arranged in a circuit for adjusting the input current of the transistor 510.

The resistance value or conduction ratio of the switching unit 230 in a case in which the function of protection against overcharge is enabled and the resistance value or conduction ratio of the switching unit 230 in a case in which the function of protection against overcharge is disabled may be the same or different. If the switching unit 230 has a switching element, the ON-resistance of the switching element in the case in which the function of protection against overcharge is enabled and the ON-resistance of the switching element in the case in which the function of protection against overcharge is disabled may be the same or different. If the switching unit 230 has a variable resistor, the resistance value of the variable resistor in the case in which the function of protection against overcharge is enabled and the resistance value of the variable resistor in the case in which the function of protection against overcharge is disabled may be the same or different. If the function of protection against overcharge is enabled, the module control unit 1040 may control the switching unit 230 such that the resistance value of the switching unit 230 becomes greater than in the case in which the function of protection against overcharge is disabled. If the function of protection against overcharge is enabled, the module control unit 1040 may control the switching unit 230 such that the conduction ratio of the switching unit 230 becomes less than in the case in which the function of protection against overcharge is disabled.

The above in the present embodiment has described, in order to simplify the description, a procedure in which the module control unit 1040 releases the interlock of the protection against overcharge, illustrating as an example the embodiment in which (i) if it has been decided that the function of protection against overcharge is to be enabled, the module control unit 1040 electrically disconnects the wire 106 and the electric storage unit 210 and (ii) if it has been decided that the function of protection against overcharge is to be disabled, the module control unit 1040 electrically connects the wire 106 and the electric storage unit 210. However, it should be understood by the person skilled in the art who has accessed the description of the present specification, that the module control unit 1040 may release the interlock of the protection against overcharge in a procedure similar to that of the present embodiment also in another embodiment in which (i) if it has been decided that the function of protection against overcharge is to be enabled, the module control unit 1040 reduces the magnitude of the current that may flow between the wire 106 and the electric storage unit 210 in the charge direction and (ii) if it has been decided that the function of protection against overcharge is to be disabled, the module control unit 1040 increases the magnitude of the current that may flow between the wire 106 and the electric storage unit 210 in the charge direction.

Specifically, if the function of protection against overcharge is to be enabled, in the present embodiment, a series of operations of the module control unit 1040 for electrically disconnecting the wire 106 and the electric storage unit 210 corresponds to a series of operations of the module control unit 1040 for reducing the current that may flow between the electric storage unit 210 and the wire 106 in the above described another embodiment. Similarly, if the function of protection against overcharge is to be disabled, in the present embodiment, a series of operations of the module control unit 1040 for electrically connecting the wire 106 and the electric storage unit 210 corresponds to a series of operations of the module control unit 1040 for increasing the current that may flow between the electric storage unit 210 and the wire 106 in the above described another embodiment.

As described above, according to the present embodiment, the module control unit 1040 can establish, for example, both the hot-swap function and the protection function of the electric storage unit 210 without significantly decreasing the charge and discharge efficiency of the electric storage module 1010.

As described above, in the present embodiment, the current detecting element 1020 and the switching unit 230 are arranged between the positive terminal 202 of the electric storage module 1010 and the positive terminal 212 of the electric storage unit 210, and the positive terminal 212 of the electric storage unit 210 is electrically connected to the wiring 106 via the switching unit 230. However, the arrangement of the current detecting element 1020 and the switching unit 230 is not limited to the present embodiment. In another embodiment, the current detecting element 1020 and the switching unit 230 are arranged between the negative terminal 204 of the electric storage module 1010 and the negative terminal 214 of the electric storage unit 210, and the negative terminal 214 of the electric storage unit 210 is electrically connected to the wiring 106 via the switching unit 230.

The electric storage module 1010 may be an example of the second electric storage device. The switching unit 230 of the electric storage module 1010 may be an example of the second switching unit.

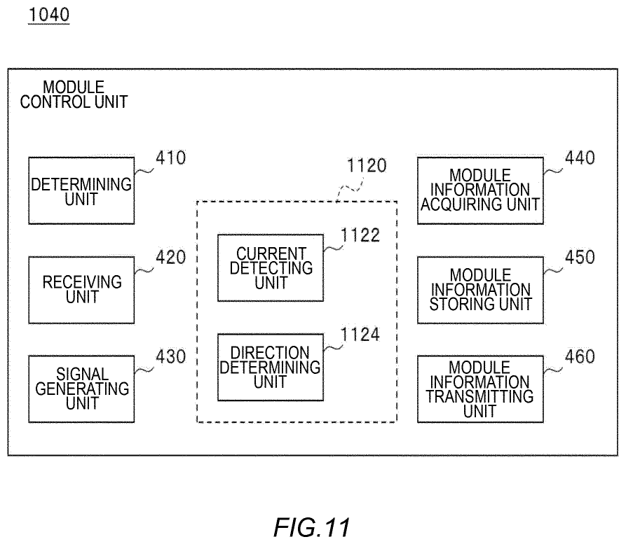

FIG. 11 schematically shows an example of a system configuration of the module control unit 1040. In the present embodiment, the module control unit 1040 includes a determining unit 410, a receiving unit 420, and a signal generating unit 430. The module control unit 1040 may include a module information acquiring unit 440, a module information storing unit 450, and a module information transmitting unit 460. In the present embodiment, the module control unit 1040 includes a current monitoring unit 1120. In the present embodiment, the current monitoring unit 1120 includes a current detecting unit 1122 and a direction determining unit 1124. The signal generating unit 430 may be an example of an operation control unit.

In the present embodiment, the module control unit 1040 differs from the module control unit 240 in that the module control unit 1040 includes the current monitoring unit 1120. With respect to the configuration other than the above described difference, the module control unit 1040 may have the features similar to those of the corresponding configuration of the module control unit 240.

In the present embodiment, the current monitoring unit 1120 monitors the current flowing between the wiring 106 of the electric storage system 100 and the electric storage unit 210 of the electric storage module 1010. For example, the current monitoring unit 1120 monitors the current flowing between the positive terminal 202 and the positive terminal 212 of the electric storage module 1010.

In the present embodiment, the current detecting unit 1122 detects the current flowing between the wire 106 of the electric storage system 100 and the electric storage unit 210 of the electric storage module 1010. The current detecting unit 1122 may decide the magnitude of the above described current. The current detecting unit 1122 may be configured by an optional analog circuit or configured by an optional digital circuit.

In the present embodiment, the direction deciding unit 1124 decides the direction of the current flowing between the wire 106 of the electric storage system 100 and the electric storage unit 210 of the electric storage module 1010. The direction deciding unit 1124 may be configured by an optional analog circuit or configured by an optional digital circuit.

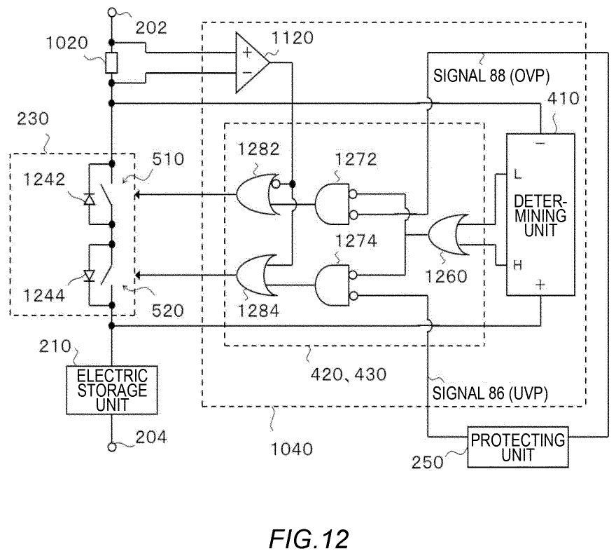

FIG. 12 schematically shows an example of a circuit configuration of the module control unit 1040. FIG. 12 schematically shows an example of a circuit configuration of the switching unit 230. FIG. 12 shows an example of the switching unit 230 and an example of the module control unit 1040, together with the positive terminal 202, the negative terminal 204, the electric storage unit 210, the protecting unit 250, and the current detecting element 1020.

(Specific Example of Circuit of the Switching Unit 230)

In the present embodiment, one end of the transistor 510 is electrically connected to the wiring 106, and the other end thereof is electrically connected to the electric storage unit 210. The transistor 510 is connected in series with the transistor 520 and the parasitic diode 1244 between the wiring 106 and the electric storage unit 210. In the present embodiment, the transistor 510 adjusts the magnitude of the current flowing between the wiring 106 and the electric storage unit 210 in the charge direction.

In the present embodiment, one end of the transistor 520 is electrically connected to the wiring 106, and the other end thereof is electrically connected to the electric storage unit 210. The transistor 520 is connected in series with the transistor 510 and the parasitic diode 1242 between the wiring 106 and the electric storage unit 210. In the present embodiment, the transistor 520 adjusts the magnitude of the current flowing between the wiring 106 and the electric storage unit 210 in the discharge direction.

One end of the parasitic diode 1242 is electrically connected to the wiring 106, and the other end thereof is electrically connected to the electric storage unit 210. The parasitic diode 1242 is connected in parallel with the transistor 510 between the wiring 106 and the electric storage unit 210. The parasitic diode 1242 is connected in series with the transistor 520 and the parasitic diode 1244 between the wiring 106 and the electric storage unit 210.

The parasitic diode 1242 allows the passage of the current flowing between the wiring 106 and the electric storage unit 210 in the discharge direction. On the other hand, the parasitic diode 1242 suppresses the flow of the current between the wiring 106 and the electric storage unit 210 in the charge direction via the parasitic diode 1242.

One end of the parasitic diode 1244 is electrically connected to the wiring 106, and the other end thereof is electrically connected to the electric storage unit 210. Between the wiring 106 and the electric storage unit 210, the parasitic diode 1244 is connected in parallel with the transistor 520. Between the wiring 106 and the electric storage unit 210, the parasitic diode 1244 is connected in series with the transistor 510 and the parasitic diode 1242.

The parasitic diode 1242 allows the passage of the current flowing between the wiring 106 and the electric storage unit 210 in the charge direction. On the other hand, the parasitic diode 1244 suppresses the flow of the current between the wiring 106 and the electric storage unit 210 in the discharge direction via the parasitic diode 1244.

The transistor 510 may be an example of one of the first current adjusting unit and the second current adjusting unit. The transistor 520 may be an example of the other one of the first current adjusting unit and the second current adjusting unit. The parasitic diode 1242 may be an example of one of the first bypass unit and the second bypass unit. The parasitic diode 1244 may be one example of the other of the first bypass unit and the second bypass unit. The discharge direction may be an example of one of the first direction and the second direction. The charge direction may be an example of the other one of the first direction and the second direction.

(Specific Example of Circuit of Module Control Unit 1040)

In the present embodiment, the module control unit 1040 includes a determining unit 410, a signal generating unit 430, and a current monitoring unit 1120. The determining unit 410 may be an example of a first determining unit, a second determining unit, and a third determining unit.

In the present embodiment, the signal generating unit 430 includes an OR circuit 1260, an AND circuit 1272, an AND circuit 1274, an OR circuit 1282, and an OR circuit 1284. In addition, in the present embodiment, between the positive terminal 202 and the switching unit 230, a resistor having an appropriate resistance value is arranged as the current detecting element 1020. The resistance value of the current detecting element 1020 is determined, for example, such that the current monitoring unit 1120 can certainly determine the direction of the current flowing between the wiring 106 and the electric storage unit 210.

In the present embodiment, the determining unit 410 determines whether the inter-terminal voltage of the switching unit 230 is within a predetermined range. The determining unit 410 transmits a signal indicating the determination result to the signal generating unit 430. The determining unit 410 may be configured by an optional analog circuit or configured by an optional digital circuit. The determining unit 410 may include a window comparator. The window comparator can be realized, for example, by using two comparators.

In the present embodiment, the determining unit 410 has two input terminals. To one of the input terminals of the determining unit 410 (shown as a −terminal in the drawing), the voltage of one end of the switching unit 230 (for example, the end on the positive terminal 202 side) is input. To the other input terminal of the determining unit 410 (shown as a +terminal in the drawing), the voltage of the other end of the switching unit 230 (for example, the end on the electric storage unit 210 side) is input.

In the present embodiment, the determining unit 410 has two output terminals. As a signal indicating the determination result, the determining unit 410 outputs from one of the output terminals (shown as L terminal in the drawing) a signal indicating that the inter-terminal voltage of the switching unit 230 is less than a first threshold. For example, if the inter-terminal voltage of the switching unit 230 is less than the first threshold, the determining unit 410 outputs H logic from the L terminal. On the other hand, if the inter-terminal voltage of the switching unit 230 is equal to or greater than the first threshold, the determining unit 410 outputs L logic from the L terminal.

In addition, as a signal indicating the determination result, the determining unit 410 outputs from the other output terminal (shown as H terminal in the drawing) a signal indicating that the inter-terminal voltage of the switching unit 230 is greater than a second threshold. In the present embodiment, as the absolute value of the second threshold, a value greater than the absolute value of the first threshold is set. For example, if the inter-terminal voltage of the switching unit 230 is greater than the second threshold, the determining unit 410 outputs H logic from the H terminal. On the other hand, if the inter-terminal voltage of the switching unit 230 is equal to or less than the second threshold, the determining unit 410 outputs L logic from the H terminal.

In an embodiment, the determining unit 410 can determine for example, whether or not the voltage or SOC of the electric storage unit 210 matches a first condition. Examples of the first condition may include (i) a condition indicating that the voltage or SOC of the electric storage unit is outside a predetermined first numerical range, (ii) a condition indicating that the voltage or SOC of the electric storage unit is greater than a predetermined first threshold, and (iii) a condition indicating that the voltage or SOC of the electric storage unit is equal to or greater than the first threshold. The first condition may be a condition indicating that the electric storage unit 210 is overcharged, for example.

In another embodiment, the determining unit 410 can determine for example, whether or not the voltage or SOC of the electric storage unit 210 matches a second condition. Examples of the second condition may include (i) a condition indicating that the voltage or SOC of the electric storage unit is outside a predetermined second numerical range, (ii) a condition indicating that the voltage or SOC of the electric storage unit is less than a predetermined second threshold, and (iii) a condition indicating that the voltage or SOC of the electric storage unit is equal to or less than the second threshold. Note that the second condition may be a condition different from the first condition. The second condition is a condition indicating that the electric storage unit 210 is over discharged, for example.

In still another embodiment, the determining unit 410 can determine for example, whether or not the inter-terminal voltage of the switching unit 230 matches a third condition. Examples of the third condition may include (i) a condition indicating that the inter-terminal voltage of the switching unit 230 is within a predetermined third numerical range, (ii) a condition indicating that the inter-terminal voltage of the switching unit 230 is less than a predetermined third threshold, and (iii) a condition indicating that the inter-terminal voltage of the switching unit 230 is equal to or less than the third threshold.

In still another embodiment, the determining unit 410 can determine for example, whether or not the inter-terminal voltage of the switching unit 230 matches a fourth condition. Examples of the fourth condition may include (i) a condition indicating that the inter-terminal voltage of the switching unit 230 is outside a predetermined fourth numerical range, (ii) a condition indicating that the inter-terminal voltage of the switching unit 230 is greater than a predetermined fourth threshold, and (iii) a condition indicating that the inter-terminal voltage of the switching unit 230 is equal to or greater than the fourth threshold. The fourth numerical range may be the same as the third numerical range. The upper limit value in the fourth numerical range may be greater than the upper limit value in the third numerical range. The fourth threshold may be the same as the third threshold. The fourth threshold may be greater than the third threshold.

In the present embodiment, the current monitoring unit 1120 may include a comparator. The current monitoring unit 1120 has, for example, two input terminals and one output terminal. To one of the input terminals of the current monitoring unit 1120 (shown as a +terminal in the drawing), the voltage of one end of the current detecting element 1020 (for example, the end on the positive terminal 202 side) is input. To the other input terminal of the current monitoring unit 1120 (shown as a −terminal in the drawing), the voltage of the other end of the current detecting element 1020 (for example, the end on the switching unit 230 side) is input.

For example, if the voltage input to the +terminal is greater than the voltage input to the −terminal, the current monitoring unit 1120 outputs H logic from the output terminal. On the other hand, if the voltage input to the +terminal is less than the voltage input to the −terminal, the current monitoring unit 1120 outputs L logic from the output terminal. Also, if the voltage input to the +terminal and the voltage input to the −terminal are equal, or if both of the voltages can be regarded as equal, the current monitoring unit 1120 does not output a signal from the output terminal.

In the present embodiment, when at least one of the transistor 510 and the transistor 520 electrically disconnects the wire 106 and the electric storage unit 210, the current monitoring unit 1120 detects the current flowing between the wire 106 and the electric storage unit 210. In an embodiment, when the function of protection against overcharge is enabled, the current monitoring unit 1120 detects the current flowing between the wire 106 and the electric storage unit 210 in the discharge direction. In another embodiment, when the function of protection against over discharge is enabled, the current monitoring unit 1120 detects the current flowing between the wire 106 and the electric storage unit 210 in the charge direction.

In the present embodiment, the signal generating unit 430 may also have the function of the receiving unit 420. For example, the signal generating unit 430 receives, from the protecting unit 250, the signal 86 for enabling the function of protection against over discharge. In addition, the signal generating unit 430 receives, from the protecting unit 250, the signal 88 for enabling the function of protection against overcharge. The signal generating unit 430 receives, from the determining unit 410, information related to the inter-terminal voltage of the switching unit 230. The signal generating unit 430 receives, from the current monitoring unit 1120, information related to the current between the wiring 106 and the electric storage unit 210.

In the present embodiment, the signal generating unit 430 can control the operation of at least one of the transistor 510 and the transistor 520 based on (i) voltage or SOC of the electric storage unit 210 and (ii) the detection result of the current monitoring unit 1120. The signal generating unit 430 can control the operation of at least one of the transistor 510 and the transistor 520 based on (i) the voltage or SOC of the electric storage unit 210, (ii) the detection result of the current monitoring unit 1120, and (iii) the determination result of the determining unit 410. The signal generating unit 430 may control at least one of the transistor 510 and the transistor 520 by outputting a signal for controlling the operation of at least one of the transistor 510 and the transistor 520 to the transistor targeted for the control by the signal.

In the present embodiment, if the determining unit 410 has determined that the inter-terminal voltage of the switching unit 230 matches the fourth condition, the signal generating unit 430 may output, to at least one of the transistor 510 and the transistor 520, a signal for executing the operation for electrically disconnecting the wiring 106 and the electric storage unit 210 or the operation for reducing the current flowing between the wiring 106 and the electric storage unit 210. The determining unit 410 may thereby be used also as the overcurrent protection function of the electric storage unit 210.

In the present embodiment, the OR circuit 1260 has two input terminals and one output terminal. To one of the input terminals of the OR circuit 1260, the output from the H terminal of the determining unit 410 is input. To the other input terminal of the OR circuit 1260, the output from the L terminal of the determining unit 410 is input.

The OR circuit 1260 outputs a logical sum (OR) of the two inputs. For example, if the inter-terminal voltage of the switching unit 230 stays in a particular numerical range, the OR circuit 1260 outputs L logic. On the other hand, if the inter-terminal voltage of the switching unit 230 is outside the particular numerical range, the OR circuit 1260 outputs the H logic. For example, if the inter-terminal voltage of the switching unit 230 is greater than a particular value, which is as an example in which the switching unit 230 matches the above described fourth condition, the H logic is output from the H terminal of the determining unit 410. In this case, the OR circuit 1260 outputs the H logic.

In the present embodiment, the AND circuit 1272 has two input terminals and one output terminal. To one of the input terminals of the AND circuit 1272, a signal produced by inverting the output of the OR circuit 1260 is input. To the other input terminal of the AND circuit 1272, a signal produced by inverting the signal 88 for enabling the function of protection against overcharge is input.

The AND circuit 1272 outputs a logical product (AND) of the two inputs. For example, if the inter-terminal voltage of the switching unit 230 stays in a particular numerical range (specifically, if the absolute value of the difference between the voltage of the wire 106 and the voltage of the electric storage unit 210 is less than a particular threshold or equal to or less than the threshold), and if the voltage or SOC of the electric storage unit 210 is less than the threshold for the protection against overcharge, the AND circuit 1272 outputs the H logic. On the other hand, in the case other than the above, the AND circuit 1272 outputs L logic.

In the present embodiment, the AND circuit 1274 has two input terminals and one output terminal. T one of the input terminals of the AND circuit 1274, a signal produced by inverting the output of the OR circuit 1260 is input. To the other input terminal of the AND circuit 1274, a signal produced by inverting the signal 86 for enabling the function of protection against over discharge is input.

The AND circuit 1274 outputs a logical product (AND) of the two inputs. For example, if the inter-terminal voltage of the switching unit 230 stays in a particular numerical range (specifically, if the absolute value of the difference between the voltage of the wire 106 and the voltage of the electric storage unit 210 is less than a particular threshold or equal to or less than the particular threshold), and if the voltage or SOC of the electric storage unit 210 is greater than the threshold for the protection against over discharge, the AND circuit 1274 outputs the H logic. On the other hand, in the case other than the above, the AND circuit 1274 outputs L logic.

In the present embodiment, the OR circuit 1282 has two input terminals and one output terminal. To one of the input terminals of the OR circuit 1282, a signal produced by inverting the output of the current monitoring unit 1120 is input. To the other input terminal of the OR circuit 1282, the output of the AND circuit 1272 is input.

The OR circuit 1282 outputs a logical sum (OR) of the two inputs. For example, if the output of the OR circuit 1282 is H logic, the transistor 510 is turned on, and if the output of the OR circuit 1282 is L logic, the transistor 510 is turned off. In an embodiment, if the current flows between the wire 106 and the electric storage unit 210 in the discharge direction, the OR circuit 1282 outputs H logic. In another embodiment, if the inter-terminal voltage of the switching unit 230 stays in a particular numerical range, and if the voltage or SOC of the electric storage unit 210 is less than the threshold for the protection against overcharge, the OR circuit 1282 outputs H logic.

In the present embodiment, the OR circuit 1284 has two input terminals and one output terminal. To one of the input terminals of the OR circuit 1284, the output of the current monitoring unit 1120 is input. To the other input terminal of the OR circuit 1284, the output of the AND circuit 1274 is input.

The OR circuit 1284 outputs a logical sum (OR) of the two inputs. For example, if the output of the OR circuit 1284 is H logic, the transistor 520 is turned on, and if the output of the OR circuit 1284 is L logic, the transistor 520 is turned off. In an embodiment, if the current flows between the wire 106 and the electric storage unit 210 in the charge direction, the OR circuit 1284 outputs H logic. In another embodiment, if the inter-terminal voltage of the switching unit 230 stays in a particular numerical range, and if the voltage or SOC of the electric storage unit 210 is less than the threshold for the protection against overcharge, the OR circuit 1284 outputs H logic.

(Specific Example of Operation of Signal Generating Unit 430)

In an embodiment, if the determining unit 410 has determined that the voltage or SOC of the electric storage unit 210 matches the first condition, the signal generating unit 430, for example, outputs, to the transistor 510, a signal for executing the operation for electrically disconnecting the wiring 106 and the electric storage unit 210 or the operation for reducing the current flowing between the wiring 106 and the electric storage unit 210 in the charge direction. Note that the signal generating unit 430 may output a signal to the transistor 520, depending on the content of the first condition.

In another embodiment, if the determining unit 410 has determined that the voltage or SOC of the electric storage unit 210 matches the second condition, the signal generating unit 430 outputs, for example, to the transistor 520, a signal for executing the operation for electrically disconnecting the wiring 106 and the electric storage unit 210 or the operation for reducing the current flowing between the wiring 106 and the electric storage unit 210 in the discharge direction. Note that the signal generating unit 430 may output a signal to the transistor 510, depending on the content of the second condition.

In still another embodiment, if the determining unit 410 has determined that the inter-terminal voltage of the switching unit 230 matches the third condition, the signal generating unit 430 outputs, to the transistor 510 and the transistor 520, a signal for executing the operation for electrically connecting the wiring 106 and the electric storage unit 210 or the operation for increasing the current flowing between the wiring 106 and the electric storage unit 210, regardless of whether or not the voltage or SOC of the electric storage unit 210 matches the first condition and the second condition. On the other hand, if the determining unit 410 has determined that the inter-terminal voltage of the switching unit 230 does not match the third condition, the signal generating unit 430 may output a signal corresponding to the detection result of the current monitoring unit 1120. For example, the signal generating unit 430 outputs a signal as follows.

(In the case in which (a) the determining unit 410 has determined that the inter-terminal voltage of the switching unit 230 does not match the third condition, and (b) the current monitoring unit 1120 has detected (i) the current flowing between the wiring 106 and the electric storage unit 210 in the discharge direction when the function of protection against overcharge is enabled or (ii) the current flowing between the wiring 106 and the electric storage unit 210 when the transistor 510 electrically disconnects the wiring 106 and the electric storage unit)

In this case, the signal generating unit 430 outputs, to the transistor 510, a signal for executing the operation for electrically connecting the wiring 106 and the electric storage unit 210 or the operation for increasing the current flowing between the wiring 106 and the electric storage unit 210, regardless of whether or not the voltage or SOC of the electric storage unit 210 matches the first condition.

(In the case in which (a) the determining unit 410 has determined that the inter-terminal voltage of the switching unit 230 does not match the third condition, and (c) the current monitoring unit 1120 has detected (i) the current flowing between the wiring 106 and the electric storage unit 210 in the charge direction when the function of protection against over discharge is enabled or (ii) the current flowing between the wiring 106 and the electric storage unit 210 when the transistor 520 electrically disconnects the wiring 106 and the electric storage unit)

In this case, the signal generating unit 430 outputs, to the transistor 520, a signal for executing the operation for electrically connecting the wiring 106 and the electric storage unit 210 or the operation for increasing the current flowing between the wiring 106 and the electric storage unit 210, regardless of whether or not the voltage or SOC of the electric storage unit 210 matches the second condition.

In still another embodiment, the module control unit 1040 can suppress deterioration or damage of the electric storage unit 210 due to the overcurrent. As described above, if the inter-terminal voltage of the switching unit 230 is greater than the particular value, which is as an example in which the switching unit 230 matches the above described fourth condition, the OR circuit 1260 outputs H logic.

Because of this, if the current flows between the wire 106 and the electric storage unit 210 in the discharge direction and if the inter-terminal voltage of the switching unit 230 is greater than the particular value, the L logic is output from the OR circuit 1282. As a result, the transistor 510 is turned off. Similarly, if the current flows between the wire 106 and the electric storage unit 210 in the charge direction, and if the inter-terminal voltage of the switching unit 230 is greater than the particular value, L logic is output from the OR circuit 1284. As a result, the transistor 520 is turned off.

According to the present embodiment, the constant flow of the current into the parasitic diode 1242 and the parasitic diode 1244 can be suppressed. As a result, the inter-terminal voltage of the switching unit 230 and the current flowing via the transistor 510 and the transistor 520 can be regarded as proportional to each other. Here, the determining unit 410 and the signal generating unit 430 can be used as the overcurrent protection circuit by appropriately setting the resistance value of the current detecting element 1020 and by connecting in series with the current detecting element 1020 the resistor having an appropriate resistance value between the wiring 106 and the electric storage unit 210.

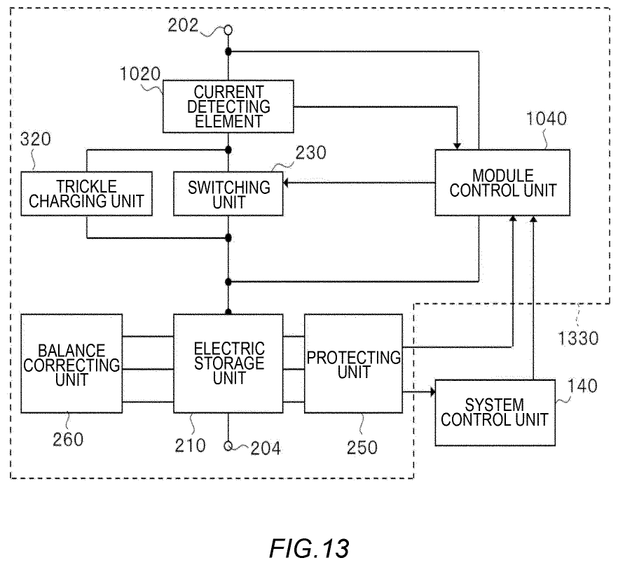

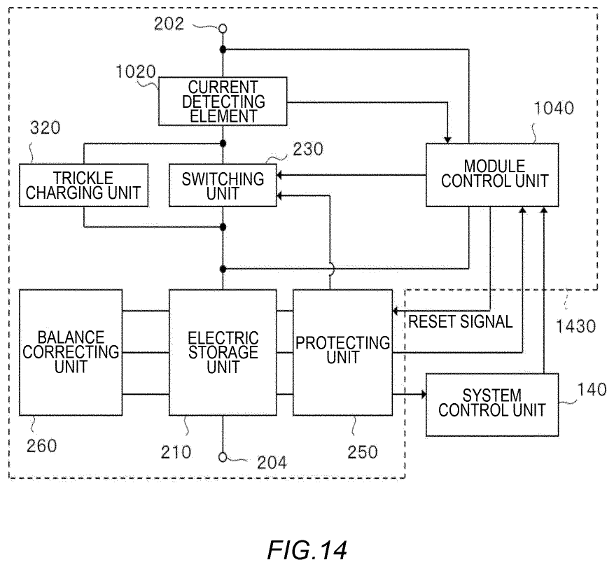

Next, another example of the electric storage module 130 will be described with reference to FIGS. 13 and 14. The matters described for the electric storage module 130 and each unit thereof may be applied to other examples of the electric storage module 130 and each unit thereof unless a technical contradiction occurs. In addition, the matters described for other examples of the electric storage module 130 and each unit thereof may be applied to the electric storage module 130 and each unit thereof. In the description of FIGS. 13 to 14, the description of the matters described for each unit of the electric storage module 130 may be omitted.

As shown in FIG. 13, the electric storage module 1330 is different from the electric storage module 1010 in that the electric storage module 1330 includes the trickle charging unit 320. Regarding features other than the above difference, the electric storage module 1330 may have the same configuration as the electric storage module 1010.

As shown in FIG. 14, the electric storage module 1430 is different from the electric storage module 1330 in that the module control unit 1040 transmits, to the protecting unit 250, at least one of a reset signal of the protection against over discharge and a reset signal of the protection against overcharge upon determining to release at least one of the interlock of the protection against over discharge and the interlock of the protection against overcharge. Further, the electric storage module 1430 is different from the electric storage module 1330 in that the protecting unit 250 releases at least one of the interlock of the protection against over discharge and the interlock of the protection against overcharge by controlling the switching unit 230 upon receiving the reset signal. With respect to the configuration other than the above described differences, the electric storage module 1430 may have the features similar to those of the corresponding configuration of the electric storage module 1330 and the like.

The electric storage module 1330 may be an example of the first electric storage device. The electric storage module 1430 may be an example of the first electric storage device.

In each of the above embodiments, the details of the electric storage system 100 have been described by exemplifying the case where the switching unit is disposed inside the electric storage module. However, the electric storage system 100 is not limited to the above embodiments. In another embodiment, the switching unit may be disposed outside the electric storage module. For example, the switching unit is disposed between the connection terminal 102 of the electric storage system 100 and the positive terminal 202 of each electric storage module. The switching unit may be disposed between the connection terminal 104 of the electric storage system 100 and the negative terminal 204 of each electric storage module. The switching unit disposed inside or outside each electric storage module may be referred to as a switching unit of each electric storage module regardless of an installation place of the switching unit.

(Another Example of the Power Supply System)

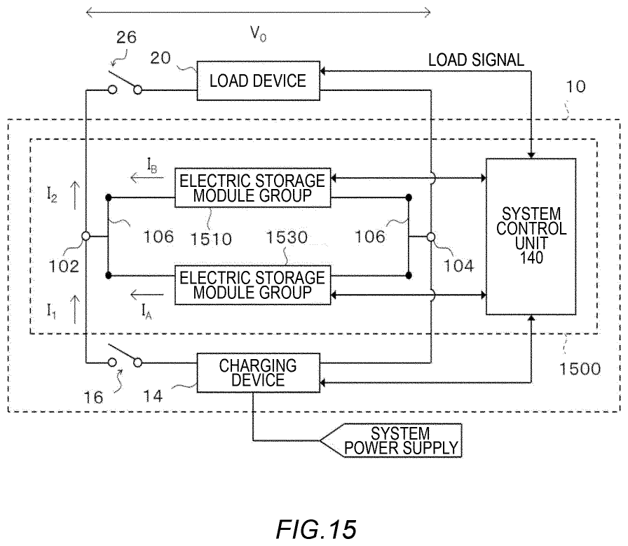

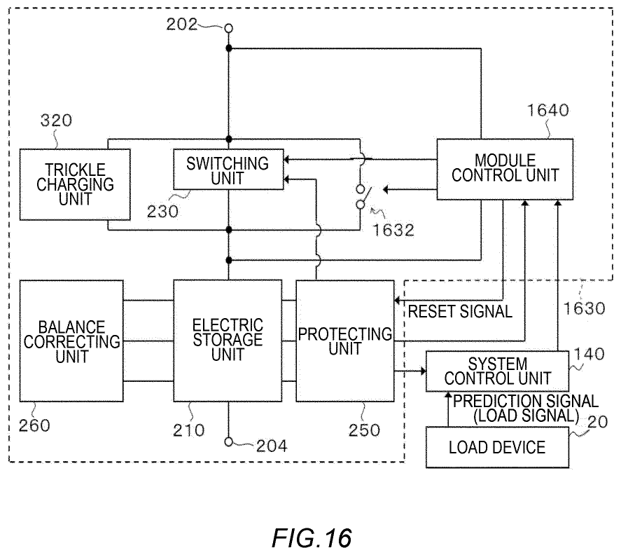

Another example of the power supply system 10 will be described with reference to FIGS. 15 and 16. FIG. 15 schematically shows an example of a system configuration of the power supply system 10. FIG. 16 schematically shows an example of a system configuration of an electric storage module 1630.

The power supply system 10 according to FIG. 15 is different from the power supply system 10 described with reference to FIG. 1 in that it includes an electric storage system 1500 instead of the electric storage system 100. Regarding features other than the above difference, the power supply system 10 according to FIG. 15 may have the same configuration as the power supply system 10 described with reference to FIG. 1.

The matters described for the electric storage system 100 and each unit thereof may be applied to the electric storage system 1500 and each unit thereof unless a technical contradiction occurs. In addition, the matters described for the electric storage system 1500 and each unit thereof may be applied to the electric storage system 100 and each unit thereof. In the description of FIGS. 15 and 16, description of matters described for each unit of the electric storage system 100 may be omitted.

As shown in FIG. 15, the electric storage system 1500 is different from the electric storage system 100 in that it includes an electric storage module group 1510 instead of the electric storage module 110 and in that it includes an electric storage module group 1530 instead of the electric storage module 130.

In the present embodiment, the electric storage module group 1510 includes one or a plurality of electric storage modules 110 connected in parallel. In the present embodiment, the electric storage module group 1530 includes one or a plurality of electric storage modules 130 connected in parallel. At least one of the plurality of electric storage modules 130 constituting the electric storage module group 1530 may be the electric storage module 1630 shown in FIG. 16. At least two of the plurality of electric storage modules 130 constituting the electric storage module group 1530 may be the electric storage modules 1630 shown in FIG. 16. Among the plurality of electric storage modules 130 constituting the electric storage module group 1530, the electric storage module having the largest set value of the charge end voltage may be the electric storage module 1630.

As shown in FIG. 16, the electric storage module 1630 is different from the electric storage module 1430 in that it includes a short-circuiting switch 1632 and that it includes a module control unit 1640 instead of the module control unit 1040. Regarding features other than the above difference, the electric storage module 1630 may have the same configuration as the electric storage module 1430.

In the present embodiment, the short-circuiting switch 1632 is disposed between the wiring 106 and the electric storage unit 210. The short-circuiting switch 1632 is connected in parallel with the switching unit 230 between the wiring 106 and the electric storage unit 210. In the present embodiment, the short-circuiting switch 1632 short-circuits the switching unit 230. For example, the ON operation of the short-circuiting switch 1632 shifts the short-circuiting switch 1632 to a state in which the short-circuiting switch 1632 short-circuits the switching unit 230.

In the present embodiment, the short-circuiting switch 1632 switches between a state in which the short-circuiting switch 1632 short-circuits the switching unit 230 and a state in which the short-circuiting switch 1632 does not short-circuit the switching unit 230. The short-circuiting switch 1632 may switch between a state in which the short-circuiting switch 1632 short-circuits the switching unit 230 and a state in which the short-circuiting switch 1632 does not short-circuit the switching unit 230 based on an instruction from the module control unit 1640. Thus, the short-circuiting switch 1632 can short-circuit the switching unit 230 as necessary. The short-circuiting switch 1632 may switch the state of the short-circuiting switch 1632 based on a signal from an element or a circuit other than the module control unit 1640.

In one embodiment, when it is detected that the output current of the electric storage system 100 is greater than the charging current of the electric storage system 100, or when the output current of the electric storage system 100 is expected to be greater than the charging current of the electric storage system 100, the short-circuiting switch 1632 receives an instruction to short-circuit the switching unit 230. For example, when the system control unit 140 acquires information (may be referred to as a notice signal) indicating that the load device 20 starts to use power from the load device 20, the short-circuiting switch 1632 receives an instruction to turn on the short-circuiting switch 1632. The instruction to turn on the short-circuiting switch 1632 may be an example of an instruction to short-circuit the switching unit 230.

In another embodiment, the short-circuiting switch 1632 receives an instruction to turn off the short-circuiting switch 1632 in at least one of (i) a case where a predetermined period has elapsed since the short-circuiting switch 1632 short-circuits the switching unit 230 and (ii) a case where it is detected that the output current of the power supply system 10 is less than the charging current of the power supply system 10 or it is expected that the output current of the power supply system 10 is less than the charging current of the power supply system 10. The instruction to turn off the short-circuiting switch 1632 may be an example of an instruction to switch the state of the short-circuiting switch 1632 from the state in which the short-circuiting switch 1632 short-circuits the switching unit 230 to the state in which the short-circuiting switch 1632 does not short-circuit the switching unit 230.

In the present embodiment, the module control unit 1640 is different from the module control unit 1040 in that it controls the operation of the short-circuiting switch 1632. Regarding features other than the above difference, the module control unit 1640 may have the same configuration as the module control unit 1040.

In one embodiment, the module control unit 1640 determines to short-circuit the switching unit 230 if it is detected that the output current of the power supply system 10 is greater than the charging current of the power supply system 10, or that the output current of the power supply system 10 is greater than the charging current of the power supply system 10. For example, the module control unit 1640 determines to short-circuit the switching unit 230 when the system control unit 140 acquires information (may be referred to as a notice signal) indicating that the load device 20 starts to use power from the load device 20. When the module control unit 1640 determines to short-circuit the switching unit 230, the module control unit 1640 generates an instruction to turn on the short-circuiting switch 1632 and transmits the instruction to the short-circuiting switch 1632.

In another embodiment, the module control unit 1640 determines not to short-circuit the switching unit 230 in at least one of (i) a case where a predetermined period has elapsed since the short-circuiting switch 1632 short-circuits the switching unit 230 and (ii) a case where it is detected that the output current of the power supply system 10 is less than the charging current of the power supply system 10 or the output current of the power supply system 10 is less than the charging current of the power supply system 10. The module control unit 1640 also generates an instruction to turn off the short-circuiting switch 1632, and transmits the instruction to the short-circuiting switch 1632.

The electric storage system 1500 may be an example of the electric storage system. The electric storage module group 1510 may be an example of the second electric storage device. The electric storage module group 1530 may be an example of the first electric storage device. The electric storage module 1630 may be an example of the first electric storage device. The short-circuiting switch 1632 may be an example of a short-circuiting unit and a short-circuiting state switching unit.

In the present embodiment, the details of the electric storage module 1430 have been described by exemplifying the case where the electric storage module 1630 and the electric storage module 1630 are partially different from each other. However, the electric storage module 1630 is not limited to the present embodiment. In another embodiment, the electric storage module 1430 can be manufactured by modifying a part of the electric storage module 1630 such that the electric storage module 1330 has a feature related to a difference between the electric storage module 1330 and the electric storage module 1630.

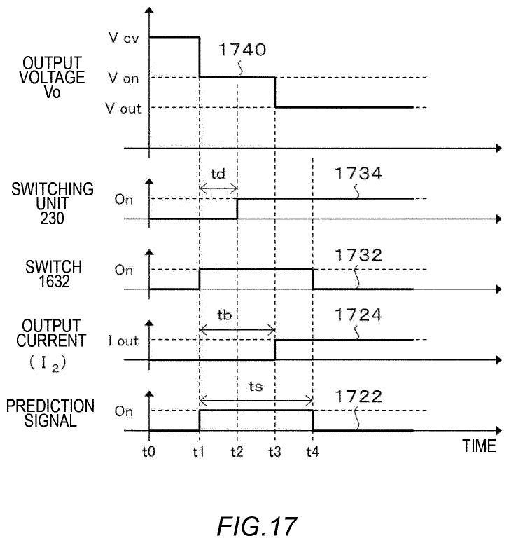

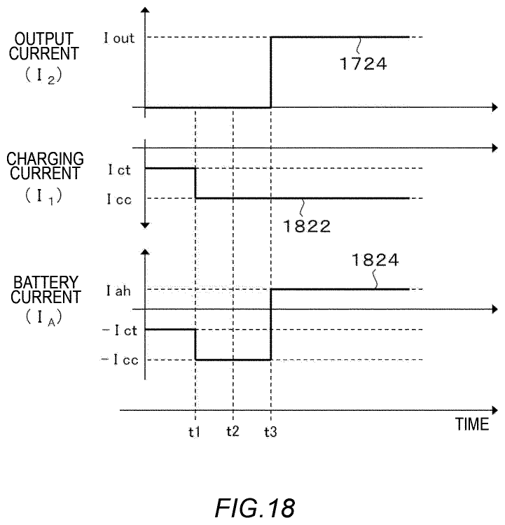

Next, an example of the operation of the power supply system 10 including the electric storage module group 1530 having at least one electric storage module 1630 will be described with reference to FIGS. 17 and 18. In the description related to FIGS. 17 and 18, for the purpose of simplifying the description, an example of the operation of the power supply system 10 will be described by taking, as an example, a case where the electric storage module 130 having the largest set value of the charge end voltage among the plurality of electric storage modules constituting the electric storage module group 1530 is the electric storage module 1630.

FIG. 17 schematically shows an example of control by the module control unit 1640. FIG. 17 schematically shows an example of fluctuation 1722 in the ON/OFF state of the notice signal, an example of fluctuation 1724 in the output current of the power supply system 10, an example of fluctuation 1732 in the ON/OFF state of the short-circuiting switch 1632, an example of fluctuation 1734 in the state of the switching unit 230, and an example of fluctuation 1740 in the output voltage of the power supply system 10.

FIG. 18 schematically shows an example of current fluctuation in each unit of the power supply system 10. FIG. 18 schematically shows an example of fluctuation 1822 of the charge current of the electric storage system 1500 and an example of fluctuation 1824 of the current of the electric storage module having the highest voltage in the electric storage module group 1530. In the present embodiment, the electric storage module is the electric storage module 1630.

As shown in FIGS. 17 and 18, according to the present embodiment, trickle charging of the electric storage module group 1530 is performed in a period before time t1. At this time, a voltage of Vcv [V] is applied to the electric storage module 1630, and a current of Ict [A] flows. In the present embodiment, at this time, the switching units 230 of all the electric storage modules mounted on the electric storage system 150 electrically disconnect the wiring 106 of each electric storage module from the electric storage unit 210. The current supplied from the charging device 14 to each electric storage module flows into the electric storage unit 210 via the trickle charging unit 320.

At time t1, the module control unit 1640 detects that the notice signal is turned on. When the notice signal is turned on, the module control unit 1640 turns on the short-circuiting switch 1632 of the electric storage module 1630. When the short-circuiting switch 1632 is turned on, the inter-terminal voltage of the power supply system 10 becomes substantially equal to the inter-terminal voltage Von [V] of the electric storage module 1630. After the notice signal is turned on or after the short-circuiting switch 1632 is turned on, the charging device 14 may increase the amount of power or current to be provided to the electric storage system 1500 to Icc.

Subsequently, at time t2, the switching unit 230 is turned on. According to one embodiment, when the inter-terminal voltage of the power supply system 10 becomes substantially equal to the inter-terminal voltage Von [V] of the electric storage module 1630, the module control unit 1640 turns on the switching unit 230 at time t2. According to another embodiment, the module control unit 1640 transmits a reset signal to the protecting unit 250. As a result, the overcharge protection function of the protecting unit 250 is disabled, and the switching unit 230 is turned on at time t2.

With the above operation, preparation for the power supply system 10 to stably supply power is completed. Subsequently, at time t3, the load device 20 starts to consume power. At this time, the magnitude of the output current of the power supply system 1910 is Tout [A]. Tout may be a value greater than a predetermined value.

In general, a delay time occurs between when the notice signal is turned on and when the switching unit 230 is turned on. Therefore, for example, when the load device 20 consumes a large amount of power in a state where all the electric storage modules mounted on the electric storage system 150 are electrically disconnected from the wiring 106, there is a possibility that the inter-terminal voltage of the power supply system 10 rapidly decreases, and the ON operation of the switching unit 230 cannot be performed in time.

In contrast, according to the present embodiment, the connection between at least one electric storage module 1630 and the wiring 106 of the electric storage system 1500 is completed before the load device 20 starts to consume power. As a result, the power supply system 10 can stably supply power. In the present embodiment, the length of ON time is of the notice signal may be set to a value greater than the length of period tb between the time when the notice signal is turned on and the start time of the power consumption of the load device 20. Furthermore, the length of the period tb may be set to a value greater than the length of the delay time td of the switching unit 230.

(Another Example of the Power Supply System)

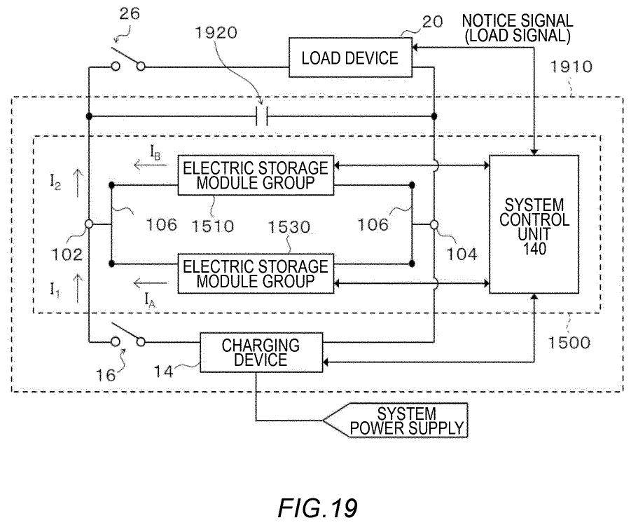

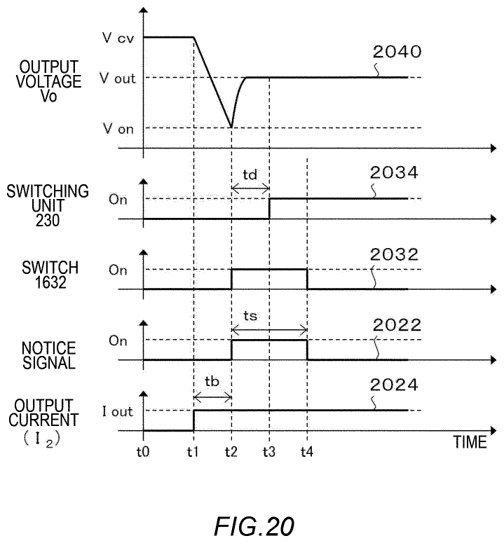

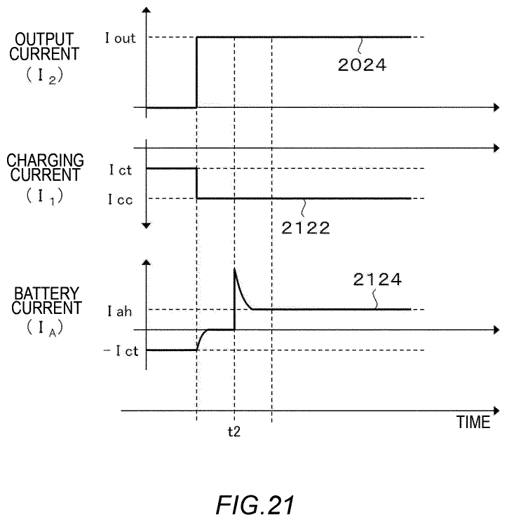

Another example of the power supply system will be described with reference to FIGS. 19, 20, and 21. FIG. 19 schematically shows an example of a system configuration of the power supply system 1910. FIG. 20 schematically shows an example of control by the module control unit 1640. FIG. 21 schematically shows an example of current fluctuation in each unit of the power supply system 1910.

As shown in FIG. 19, the power supply system 1910 differs from the power supply system 10 described in conjunction with FIGS. 15 and 16 in that it further includes a capacitor 1920 and that the switching unit 230 does not necessarily have to be short-circuited before the power supply system 1910 outputs current.

According to the control method of the power supply system 10 described with reference to FIGS. 17 and 18, the short-circuiting switch 1632 short-circuits the switching unit 230 before the power supply system 10 outputs the current, whereby the power supply from the power supply system 10 to the load device 20 is stabilized. On the other hand, according to the present embodiment, since the capacitor 1920 is connected in parallel with the load device 20, rapid fluctuation of the output voltage of the power supply system 1910 is suppressed. As a result, the power supply from the power supply system 10 to the load device 20 can be stabilized.

For example, since the rapid fluctuation of the output voltage of the power supply system 1910 is suppressed, the switching unit 230 can easily cope with the decrease in the output voltage of the power supply system 1910. Even if the switching unit 230 cannot cope with the decrease in the output voltage of the power supply system 1910, the short-circuiting switch 1632 can short-circuit the switching unit 230 in response to the system control unit 140 receiving the notice signal indicating that the load device 20 has started to consume power. As a result, the power supply from the power supply system 10 to the load device 20 can be stabilized. In the present embodiment, the short-circuiting switch 1632 may short-circuit the switching unit 230 before the power supply system 10 outputs the current, or may short-circuit the switching unit 230 after the power supply system 10 outputs the current.

According to the present embodiment, for example, one end of the capacitor 1920 is electrically connected to the connection terminal 102, and the other end of the capacitor 1920 is electrically connected to the connection terminal 104. As a result, when the load device 20 is electrically connected to the power supply system 1910, the capacitor 1920 and the load device 20 are connected in parallel. As a result, fluctuation of the output voltage of the power supply system 1910 is suppressed. Therefore, for example, even when the load device 20 consumes large power in a state where all the electric storage modules mounted on the electric storage system 150 are electrically disconnected from the wiring 106, the ON operation of the switching unit 230 can cope with the decrease in the voltage of the wiring 106.

The power supply system 1910 may be an example of an electric storage system. The capacitor 1920 may be an example of the fluctuation suppressing unit.

FIG. 20 schematically shows fluctuation 2022 of the ON/OFF state of the notice signal, an example of fluctuation 2024 of the output current of the power supply system 10, an example of fluctuation 2032 of the ON/OFF state of the short-circuiting switch 1632, an example of fluctuation 2034 of the state of the switching unit 230, and an example of fluctuation 2040 of the output voltage of the power supply system 10.

The notice signal may be a signal indicating that the load device 20 has started consuming the current or that the load device 20 is consuming the current. The notice signal may be a signal indicating that the current value of the current consumption of the load device 20 is greater than or equal to a predetermined value or greater than the predetermined value. The notice signal is transmitted from the load device 20 to the system control unit 140, for example.

FIG. 21 schematically shows an example of fluctuation 2122 of the charging current of the electric storage system 1500 and an example of fluctuation 2124 of the current of the electric storage module having the highest voltage in the electric storage module group 1530. As described above, the electric storage module group 1530 includes one or more electric storage modules 1630. In the present embodiment, the electric storage module having the highest voltage may be the electric storage module 1630.

As shown in FIGS. 20 and 21, according to the present embodiment, trickle charging of the electric storage module group 1530 is performed in a period before time t1. At this time, a voltage of Vcv [V] is applied to the electric storage module 1630, and a current of Ict [A] flows. In the present embodiment, at this time, the switching units 230 of all the electric storage modules mounted on the electric storage system 150 electrically disconnect the wiring 106 of each electric storage module from the electric storage unit 210. The current supplied from the charging device 14 to each electric storage module flows into the electric storage unit 210 via the trickle charging unit 320.

Here, at time t1, the load device 20 starts to consume power. At this time, the magnitude of the output current of the power supply system 1910 is Tout [A]. Tout may be a value greater than a predetermined value. When the load device 20 starts to consume power, the output voltage of the power supply system 1910 decreases. After the load device 20 starts to consume power, the charging device 14 may increase the amount of power or the amount of current to be provided to the electric storage system 1500 to Icc. At this time, assuming that the capacity of the capacitor 1920 is C and the magnitude of the output current of the power supply system 1910 is I₂, the decrease rate of the output voltage is expressed by a slope of (I₂−Icc)/C in FIG. 20.

Next, at time t2, the module control unit 1640 detects that the notice signal is turned on. When the notice signal is turned on, the module control unit 1640 turns on the short-circuiting switch 1632 of the electric storage module 1630. As described above, among the electric storage modules included in the electric storage module group 1530 of the electric storage module 1630, the inter-terminal voltage is the largest. Therefore, when the short-circuiting switch 1632 is turned on, the inter-terminal voltage of the power supply system 10 becomes substantially equal to the inter-terminal voltage Von [V] of the electric storage module 1630.

At this time, a large battery current I_{A} momentarily flows through the electric storage module 1630. As a result, the capacitor 1920 is charged. As a result, the inter-terminal voltage of the power supply system 10 increases.

Subsequently, when the delay time td elapses from time t2 to time t3, the switching unit 230 of the electric storage module 1630 is turned on. At this time, the output voltage of the power supply system 1910 becomes Vout [V]. The size of Vout [V] is determined by, for example, the electric storage module group 1530.

In the present embodiment, the length of the ON time is of the notice signal may be set to a value greater than the length of the delay time td of the switching unit 230. The length of the period tb between the start time of the power consumption of the load device 20 and the time when the notice signal is turned on may be determined based on the capacity of the capacitor 1920.

(Another Example of the Power Supply System)

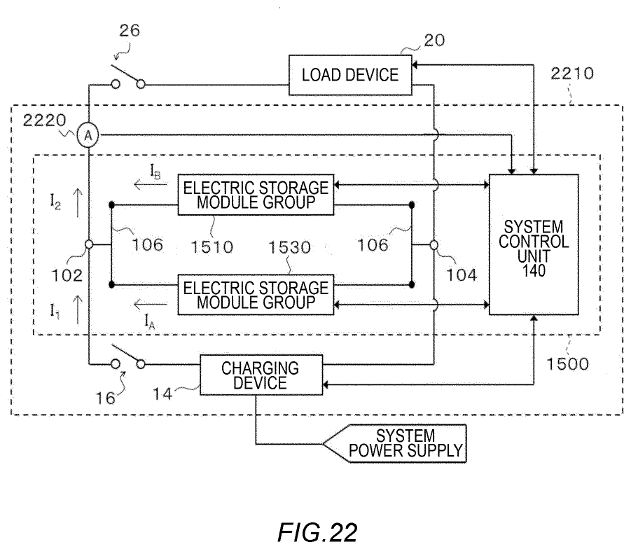

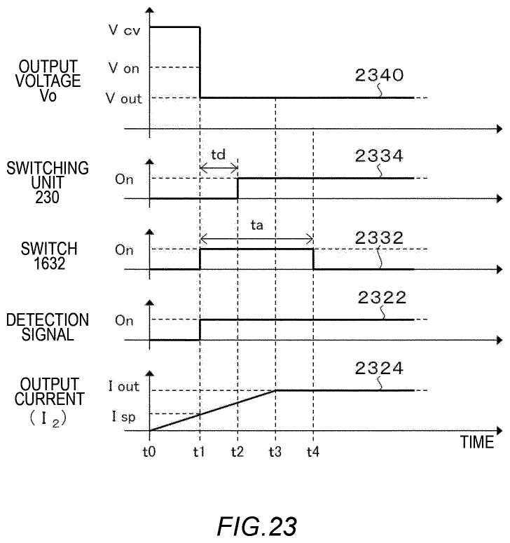

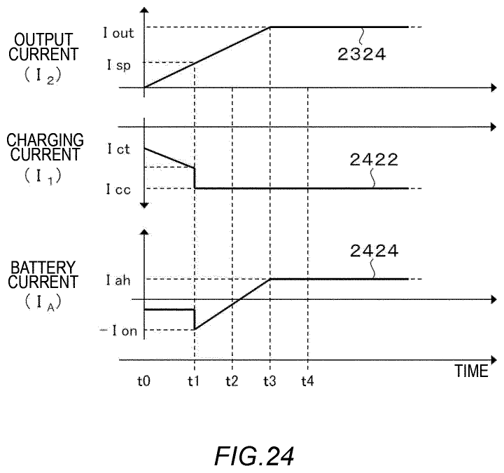

Another example of the power supply system will be described with reference to FIGS. 22, 23, and 24. FIG. 22 schematically shows an example of a system configuration of the power supply system 2210. FIG. 23 schematically shows an example of control by the module control unit 1640. FIG. 24 schematically shows an example of current fluctuation in each unit of the power supply system 2210.

As shown in FIG. 22, the power supply system 2210 is different from the power supply system 10 described with reference to FIGS. 15 and 16 in that it further includes the current detecting element 2220 and in that the short-circuiting switch 1632 short-circuits the switching unit 230 based on the detection result of the current detecting element 2220. Regarding other features, the power supply system 2210 may have the same configuration as the power supply system 10 described in connection with FIGS. 15 and 16.

In the present embodiment, the current detecting element 2220 detects that the power supply system 2210 has supplied power to the load device 20. In addition, the current detecting element 2220 transmits information indicating the detection result to the system control unit 140.

In one embodiment, the current detecting element 2220 detects whether the output current of the power supply system 2210 is greater than a predetermined value. When it is detected that the output current of the power supply system 2210 is greater than the predetermined value, the current detecting element 2220 transmits information indicating the detection result to the system control unit 140. In another embodiment, the current detecting element 2220 measures a current value of an output current of the power supply system 2210. The current detecting element 2220 transmits information indicating the measurement result to the system control unit 140.

In the present embodiment, when it is detected that the power supply system 2210 has supplied power to the load device 20, the system control unit 140 transmits, to the module control unit 1640, (i) a signal (sometimes referred to as a detection signal) indicating that it is detected that the power supply system 2210 has supplied power to the load device 20, or (ii) a signal for turning on the short-circuiting switch 1632.

In the present embodiment, when receiving the detection signal or the signal for turning on the short-circuiting switch 1632, the module control unit 1640 transmits a signal for turning on the short-circuiting switch 1632 to the short-circuiting switch 1632. As a result, the switching unit 230 is short-circuited. When current detecting element 2220 detects that power supply system 2210 has supplied power to load device 20, switching unit 230 is short-circuited.

FIG. 23 schematically shows the fluctuation 2322 of the ON/OFF state of the detection signal, an example of the fluctuation 2324 of the output current of the power supply system 10, an example of the fluctuation 2332 of the ON/OFF state of the short-circuiting switch 1632, an example of the fluctuation 2334 of the state of the switching unit 230, and an example of the fluctuation 2340 of the output voltage of the power supply system 10.

FIG. 24 schematically shows an example of fluctuation 2422 of the charging current of the electric storage system 1500 and an example of fluctuation 2424 of the current of the electric storage module having the highest voltage in the electric storage module group 1530. As described above, the electric storage module group 1530 includes one or more electric storage modules 1630. In the present embodiment, the electric storage module having the highest voltage may be the electric storage module 1630.

As shown in FIGS. 23 and 24, according to the present embodiment, trickle charging of the electric storage module group 1530 is performed in a period before time t1. At this time, a voltage of Vcv [V] is applied to the electric storage module 1630, and a current of Ict [A] flows. In the present embodiment, at this time, the switching units 230 of all the electric storage modules mounted on the electric storage system 150 electrically disconnect the wiring 106 of each electric storage module from the electric storage unit 210. The current supplied from the charging device 14 to each electric storage module flows into the electric storage unit 210 via the trickle charging unit 320.

On the other hand, at time to, the load device 20 starts to consume power. In the present embodiment, after the power supply system 2210 supplies power to the load device 20, the current consumption of the load device 20 increases continuously or stepwise. According to the present embodiment, the value of the output current of the power supply system 2210 continuously increases over time.

Then, at time t1, the current value of the power supply system 2210 reaches Isp [A]. Isp may be a predetermined value. When the current value of the power supply system 2210 reaches Isp [A] the current detecting element 2220 causes the power supply system 2210 to detect the output current. As a result, it is detected that the power supply system 2210 has supplied power to the load device 20.

When the detection signal is turned on, the module control unit 1640 turns on the short-circuiting switch 1632 of the electric storage module 1630. When the short-circuiting switch 1632 is turned on, the inter-terminal voltage of the power supply system 10 becomes substantially equal to the inter-terminal voltage Von [V] of the electric storage module 1630. After the short-circuiting switch 1632 is turned on, the charging device 14 may increase the amount of power or the amount of current to be provided to the electric storage system 1500 to Icc.

Subsequently, when the delay time td elapses from time t1 to time t2, the switching unit 230 is turned on. In the present embodiment, when time ta elapses after the short-circuiting switch 1632 is turned on, the module control unit 1640 turns off the short-circuiting switch 1632 of the electric storage module 1630. The length of the time ta may be set to a value greater than the length of the delay time td of the switching unit 230.

The power supply system 2210 may be an example of an electric storage system. The current detecting element 2220 may be an example of a detecting unit.

While the embodiments of the present invention have been described, the technical scope of the invention is not limited to the above described embodiments. It is apparent to persons skilled in the art that various alterations and improvements can be added to the above-described embodiments. In addition, unless a technical contradiction occurs, the matters described in a particular embodiment can be applied to another embodiment. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to”, “before”, or the like and as long as the output from a previous process is not used in a later process. Even if the process flow is described using phrases such as “first” or “next” in the claims, embodiments, or diagrams, it does not necessarily mean that the process must be performed in this order.

### REFERENCE SIGNS LIST

10 Power supply system
14 Charging device
16 Charge switching unit
20 Load device
26 Load switching unit
52 Signal
54 Signal
86 Signal
88 Signal
100 Electric storage system
102 Connection terminal
104 Connection terminal
106 Wiring
110 Electric storage module
130 Electric storage module
140 System control unit
150 Electric storage system
202 Positive terminal
204 Negative terminal
210 Electric storage unit
212 Positive terminal
214 Negative terminal
222 Electric storage cell
224 Electric storage cell
230 Switching unit
240 Module control unit
250 Protective portion
260 Balance correcting unit
320 Trickle charging unit
322 Direction limiting unit
324 Flow limiting unit
410 Determining unit
420 Receiving unit
430 Signal generating unit
440 Module information acquiring unit
450 Module information storing unit
460 Module information transmitting unit
510 Transistor
512 Resistance
514 Resistance
516 Diode
520 Transistor
522 Resistance
524 Resistance
526 Diode
530 Transistor
532 Resistance
540 Transistor
542 Resistance
552 Resistance
554 Resistance
560 Transistor
570 Capacitor
572 Resistance
580 Transistor
592 Switch
594 Switch
622 State managing unit
624 Module selecting unit
626 Signal generating unit
642 Charge control unit
644 Charging unit
662 Load control unit
664 Load unit
710 Fluctuation
730 Fluctuation
740 Fluctuation
814 Fluctuation
914 Output characteristics
1010 Electric storage module
1020 Current detecting element
1040 Module control unit
1120 Current monitoring unit
1122 Current detecting unit
1124 Direction determining unit
1242 Parasitic diode
1244 Parasitic diode
1260 OR circuit
1272 AND circuit
1274 AND circuit
1282 OR circuit
1284 OR circuit
1330 Electric storage module
1430 Electric storage module
1500 Electric storage system
1510 Electric storage module group
1530 Electric storage module group
1630 Electric storage module
1632 Short-circuiting switch
1640 Module control unit
1722 Fluctuation
1724 Fluctuation
1732 Fluctuation
1734 Fluctuation
1740 Fluctuation
1822 Fluctuation
1824 Fluctuation
1910 Power supply system
1920 Capacitor
2022 Fluctuation
2024 Fluctuation
2032 Fluctuation
2034 Fluctuation
2040 Fluctuation
2122 Fluctuation
2124 Fluctuation
2210 Power supply system
2220 Current detecting element
2322 Fluctuation
2324 Fluctuation
2332 Fluctuation
2334 Fluctuation
2340 Fluctuation
2422 Fluctuation
2424 Fluctuation

1. An electric storage system comprising:
a first electric storage device including a first electric storage unit;
a second electric storage device including a second electric storage unit; and
a wiring for connecting the first electric storage device and the second electric storage device in parallel, wherein
the first electric storage device includes
a first switching unit disposed between the wiring and the first electric storage unit and configured to switch an electrical connection relationship between the wiring and the first electric storage unit based on a voltage difference between the wiring and the first electric storage unit,
the second electric storage device includes
a second switching unit disposed between the wiring and the second electric storage unit and configured to switch an electrical connection relationship between the wiring and the second electric storage unit based on a voltage difference between the wiring and the second electric storage unit,
the first electric storage unit includes a first type of secondary battery,
the second electric storage unit includes a second type of secondary battery,
a battery system of the first type of secondary battery is expressed by a reaction formula in which an irreversible change does not occur in the battery system in principle even when an overcharge state continues,
a battery system of the second type of secondary battery is expressed by a reaction formula in which an irreversible change occurs in the battery system in principle when an overcharge state continues, and
a charge end voltage of the first electric storage unit is
equal to or less than a full charging voltage of the first electric storage unit and
is greater than a charge end voltage of the second electric storage unit.

2. An electric storage system comprising a wiring for connecting a first electric storage device having a first electric storage unit and a second electric storage device having a second electric storage unit in parallel, wherein
the first electric storage device includes
a first switching unit disposed between the wiring and the first electric storage unit and configured to switch an electrical connection relationship between the wiring and the first electric storage unit based on a voltage difference between the wiring and the first electric storage unit,
the second electric storage device includes
a second switching unit disposed between the wiring and the second electric storage unit and configured to switch an electrical connection relationship between the wiring and the second electric storage unit based on a voltage difference between the wiring and the second electric storage unit,
the first electric storage unit includes a first type of secondary battery,
the second electric storage unit includes a second type of secondary battery,
a battery system of the first type of secondary battery is expressed by a reaction formula in which an irreversible change does not occur in the battery system in principle even when an overcharge state continues,
a battery system of the second type of secondary battery is expressed by a reaction formula in which an irreversible change occurs in the battery system in principle when an overcharge state continues, and
a charge end voltage of the first electric storage unit is
equal to or less than a full charging voltage of the first electric storage unit and
is greater than a charge end voltage of the second electric storage unit.

3. The electric storage system according to claim 1 or 2, wherein
the full charging voltage of the first electric storage unit is less than a charging voltage of a charging device that charges the first electric storage device and the second electric storage device connected in parallel.

4. The electric storage system according to claim 3, further comprising:
a charging voltage control unit configured to control a set value of the charging voltage of the charging device.

5. The electric storage system according to claim 3, wherein
the charging device charges the first electric storage device and the second electric storage device by a constant current method in at least a part of a charging period of the first electric storage device and the second electric storage device.

6. The electric storage system according to claim 3, wherein
the charging device
charges the first electric storage device by a constant current method when a voltage of the first electric storage unit is equal to or less than a charge end voltage and
charges the first electric storage device by a trickle charging method when the voltage of the first electric storage unit is greater than a charge end voltage.

7. The electric storage system according to claim 1, wherein
the first electric storage device further includes
a limiting unit that is connected in parallel with the first switching unit between the wiring and the first electric storage unit, has a larger resistance than the first switching unit, allows a current to pass in a direction from the wiring toward the first electric storage unit, and suppresses the current from passing in a direction from the first electric storage unit toward the wiring.

8. The electric storage system according to claim 7, wherein
the limiting unit includes:
a current amount limiting unit configured to limit an amount of current flowing through the limiting unit; and
a current direction limiting unit that is connected in series with the current amount limiting unit, allows a current to pass in a direction from the wiring toward the first electric storage unit, and does not allow a current to pass in a direction from the first electric storage unit toward the wiring.

9. The electric storage system according to claim 1, wherein
the first electric storage device further includes
a short-circuiting unit disposed between the wiring and the first electric storage unit, connected in parallel with the first switching unit between the wiring and the first electric storage unit, and configured to short-circuit the first switching unit,
the short-circuiting unit includes
a short-circuiting state switching unit configured to shift the short-circuiting unit to a state in which the short-circuiting unit short-circuits the first switching unit, and
the short-circuiting state switching unit short-circuits the first switching unit when it is detected that an output current of the electric storage system is greater than a charging current of the electric storage system, or when it is predicted that the output current of the electric storage system is greater than the charging current of the electric storage system.

10. The electric storage system according to claim 9, wherein
the short-circuiting state switching unit
switches a state of the short-circuiting unit from a state in which the short-circuiting unit short-circuits the first switching unit to a state in which the short-circuiting unit does not short-circuit the first switching unit
in at least one of (i) a case where a predetermined period has elapsed after the short-circuiting state switching unit short-circuits the first switching unit, and (ii) a case where it is detected that an output current of the electric storage system is less than a charging current of the electric storage system, or a case where it is predicted that the output current of the electric storage system is less than the charging current of the electric storage system.

11. The electric storage system according to claim 9 or 10, wherein
the short-circuiting state switching unit
short-circuits the first switching unit
when the electric storage system acquires information indicating that a load device that uses power supplied from the electric storage system starts using the power.

12. The electric storage system according to claim 9, wherein
the short-circuiting state switching unit short-circuits the first switching unit before the electric storage system outputs a current.

13. The electric storage system according to claim 9, further comprising:
a fluctuation suppressing unit configured to suppress fluctuation of an output voltage of the electric storage system.

14. The electric storage system according to claim 13, wherein
the short-circuiting state switching unit short-circuits the first switching unit after the electric storage system outputs a current.

15. The electric storage system according to claim 14, wherein
the fluctuation suppressing unit is disposed such that the fluctuation suppressing unit and a load device are connected in parallel when the load device that uses power supplied from the electric storage system is electrically connected to the electric storage system.

16. The electric storage system according to claim 9, further comprising:
a detecting unit configured to detect that the electric storage system has supplied power to a load device, wherein
the short-circuiting state switching unit
short-circuits the first switching unit
when the detecting unit detects that the electric storage system has supplied power to the load device.

17. The electric storage system according to claim 16, wherein
a current consumption of the load device increases continuously or stepwise after the electric storage system supplies power to the load device.

18. The electric storage system according to claim 17, wherein
the electric storage system
receives, from the load device, a request signal indicating a magnitude of a current to be supplied to the load device and
outputs a current having a magnitude indicated by the request signal.

19. The electric storage system according to claim 17, wherein
the load device includes a current consumption control unit configured to control an amount of current consumption of the load device.

20. The electric storage system according to claim 9, wherein
the electric storage system includes a plurality of the first electric storage devices connected in parallel, and
at least two of the plurality of first electric storage devices include the short-circuiting unit.
